(19) United States
(12) Patent Application Publication
(10) Pub. No.: US 2025/0367552 A1
(43) Pub. Date: Dec. 4, 2025

(54) NON-TRANSITORY COMPUTER READABLE MEDIUM, INFORMATION PROCESSING METHOD, INFORMATION PROCESSING SYSTEM

(71) Applicant: CYGAMES, INC., Tokyo (JP)

(72) Inventors: Mamoru Takahashi, Tokyo (JP); Choryu Kijoka, Tokyo (JP); Nozomi Kikuchi, Tokyo (JP); Mitsunori Tanaka, Tokyo (JP)

(73) Assignee: CYGAMES, INC., Tokyo (JP)

(21) Appl. No.: 19/306,696

(22) Filed: Aug. 21, 2025

Related U.S. Application Data
(63) Continuation of application No. PCT/JP2024/002419, filed on Jan. 26, 2024.

(30) Foreign Application Priority Data
Feb. 28, 2023 (JP) 2023-029101

(51) Int. Cl. A63F 13/45; A63F 13/44; A63F 13/69

(52) U.S. Cl. CPC A63F 13/45; A63F 13/44; A63F 13/69

(57) ABSTRACT

A non-transitory computer readable medium stores a program causing a computer to execute: processing of progressing a predetermined game; processing of determining a performance pattern to occur during the predetermined game from among a plurality of performance patterns, the plurality of performance patterns being associated with pieces of performance content different from each other and update conditions for a parameter different from each other; processing of performing a performance based on the determined performance pattern; processing of updating the parameter in accordance with the update condition corresponding to the determined performance pattern; processing of enabling a performance corresponding to the performance pattern having occurred during the predetermined game to be performed at a timing desired by a player; and processing of enabling a performance corresponding to the performance pattern having not occurred during the predetermined game to be performed at the desired timing by spending a predetermined item.

### CROSS REFERENCE TO RELATED APPLICATIONS

This application is a continuation application of International Application No. PCT/JP2024/002419, filed on Jan. 26, 2024, which claims priority to Japanese Patent Application No. 2023-029101, filed on Feb. 28, 2023, the entire contents of which are incorporated by reference herein.

### BACKGROUND ART

### Technical Field

The present invention relates to an information processing program, an information processing method, and an information processing system.

In games of various genres, performance images corresponding to events occurring during the games are displayed. For example, Patent Document 1 discloses a game in which a graphic image that appears during the game is registered and the registered graphic image can be viewed later.

### CITATION LIST

### Patent Literature

Patent Document 1: JP 3681738 B

### SUMMARY OF INVENTION

### Technical Problem

For example, in some genres of games, such as a role playing game (RPG) or a nurture game, parameters of a character change as the game progresses. In such a game, a player naturally avoids an event in which the parameter for the character disadvantageously changes. In addition, for example, a performance image corresponding to an option selected by the player may be displayed. At this time, if the options selectable by the player are superior or inferior to each other, the options selected by the player may be substantially fixed.

As described above, in a game in which parameters of a character change, it is difficult for a player to generate a portion of performances. Therefore, the player cannot view some performance images generated during the game, and there is a problem that the interest in the game is reduced.

An object of the present invention is to provide an information processing program, an information processing method, and an information processing system capable of enhancing an interest in a game.

### Solution to Problem

In order to solve the above problems, an information processing program causes a computer to execute: processing of progressing a predetermined game in which a parameter associated with a character is updated; processing of determining a performance pattern to occur during the predetermined game from among a plurality of performance patterns, the plurality of performance patterns being associated with pieces of performance content different from each other and update conditions for the parameter different from each other; processing of performing a performance based on the determined performance pattern; processing of updating the parameter in accordance with the update condition corresponding to the determined performance pattern; processing of enabling a performance corresponding to the performance pattern having occurred during the predetermined game to be performed at a timing desired by a player; and processing of enabling a performance corresponding to the performance pattern having not occurred during the predetermined game to be performed at the desired timing by spending a predetermined item.

The information processing program further may cause the computer to execute processing of causing the player to select any one option among a plurality of options during the predetermined game, the plurality of options being associated with any of the plurality of performance patterns, wherein the processing of determining the performance pattern to occur may include determining the performance pattern corresponding to the option selected by the player.

The plurality of performance patterns may include a first performance pattern and a second performance pattern, the first performance pattern being associated with a first update condition, the second performance pattern being associated with a second update condition being more disadvantageous to the player than the first update condition, and the performance enabled to be performed by spending the predetermined item may include a performance corresponding to the second performance pattern.

The information processing program may further cause the computer to execute processing of spending in-game currency possessed by the player as the predetermined game is started.

In order to solve the above problems, an information processing method executed by one or more computers includes: processing of progressing a predetermined game in which a parameter associated with a character is updated; processing of determining a performance pattern to occur during the predetermined game from among a plurality of performance patterns, the plurality of performance patterns being associated with pieces of performance content different from each other and update conditions for the parameter different from each other; processing of performing a performance based on the determined performance pattern; processing of updating the parameter in accordance with the update condition corresponding to the determined performance pattern; processing of enabling a performance corresponding to the performance pattern having occurred during the predetermined game to be performed at a timing desired by a player; and processing of enabling a performance corresponding to the performance pattern having not occurred during the predetermined game to be performed at the desired timing by spending a predetermined item.

In order to solve the above problems, an information processing system includes one or more computers, wherein the one or more computers execute: processing of progressing a predetermined game in which a parameter associated with a character is updated; processing of determining a performance pattern to occur during the predetermined game from among a plurality of performance patterns, the plurality of performance patterns being associated with pieces of performance content different from each other and update conditions for the parameter different from each other; processing of performing a performance based on the determined performance pattern, processing of updating the parameter in accordance with the update condition corresponding to the determined performance pattern; processing of enabling a performance corresponding to the performance pattern having occurred during the predetermined game to be performed at a timing desired by a player; and processing of enabling a performance corresponding to the performance pattern having not occurred during the predetermined game to be performed at the desired timing by spending a predetermined item.

### Advantageous Effects of Invention

According to the present invention, it is possible to improve a player's interest in the game.

### BRIEF DESCRIPTION OF DRAWINGS

FIG. 1 is an explanatory diagram illustrating a schematic configuration of an information processing system.

FIG. 2A is a diagram for describing a hardware configuration of a player terminal. FIG. 2B is a diagram for describing a hardware configuration of a server.

FIG. 3A is a diagram for describing an example of a home screen. FIG. 3B is a diagram for describing an example of an option setting screen. FIG. 3C is a diagram for describing an example of a profile setting screen.

FIG. 4 is a diagram for describing a rough progression flow of a nurture game.

FIG. 5A is a diagram for describing an example of a scenario initial additional value data. FIG. 5B is a diagram for describing an example of a scenario initial upper limit value data. FIG. 5C is a diagram for describing an example of a scenario event additional value data.

FIG. 6A is a diagram for describing a nurture target character selection screen. FIG. 6B is a first diagram for describing a character detail screen. FIG. 6C is a second diagram for describing the character detail screen.

FIG. 7A is a diagram for describing an ability parameter (initial value) table. FIG. 7B is a diagram for describing an aptitude parameter (initial value) table.

FIG. 7C is a diagram for describing skills. FIG. 7D is a diagram for describing exclusive events.

FIG. 8 is a diagram for describing a character strengthening screen.

FIG. 9A is a first diagram for describing an inheritance character selection screen. FIG. 9B is a first diagram for describing a nurtured character list screen. FIG. 9C is a second diagram for describing the inheritance character selection screen. FIG. 9D is a third diagram for describing the inheritance character selection screen.

FIG. 10 is a diagram for describing an inheritance system.

FIG. 11 is a diagram for describing factor information.

FIG. 12A is a diagram for describing an effectiveness of a basic ability factor. FIG. 12B is a diagram for describing an effectiveness of a character factor.

FIG. 13A is a diagram for describing a determination target for compatibility, and FIG. 13B is a diagram for describing a determination item for compatibility.

FIG. 14A is a first diagram for describing a support card organization screen. FIG. 14B is a diagram for describing a support card selection screen. FIG. 14C is a second diagram for describing the support card organization screen.

FIG. 15A is a diagram for describing a support card table. FIG. 15B is a diagram for describing support effects. FIG. 15C is a diagram for describing base skills. FIG. 15D is a diagram for describing support events.

FIG. 16A is a diagram for describing a final confirmation screen. FIG. 16B is a diagram for describing a preset selection screen.

FIG. 17 is a diagram for describing selection items in each turn.

FIG. 18 is a diagram for describing a top screen.

FIG. 19A is a first diagram for describing a training screen. FIG. 19B is a second diagram for describing the training screen. FIG. 19C is a diagram for describing a training result notification screen. FIG. 19D is a diagram for describing an event screen.

FIG. 20 is a diagram for describing an example of events.

FIG. 21A is a first diagram for describing an inheritance event. FIG. 21B is a second diagram for describing the inheritance event. FIG. 21C is a third diagram for describing the inheritance event. FIG. 21D is a fourth diagram for describing the inheritance event.

FIG. 22A is a first diagram for describing a skill screen. FIG. 22B is a second diagram for describing the skill screen.

FIG. 23A is a first diagram for describing a race selection screen. FIG. 23B is a diagram for describing a race start screen. FIG. 23C is a first diagram for describing a race result screen. FIG. 23D is a second diagram for describing the race result screen.

FIG. 24 is a diagram for describing a rough flow of turn-start processing.

FIG. 25 is a diagram for describing an arrangement ratio to a training item.

FIG. 26A is a diagram for describing a training level. FIG. 26B is a diagram for describing a fixed increase value (speed). FIG. 26C is a diagram for describing a fixed increase value table (power).

FIG. 27A is a diagram for describing a nurture completion screen. FIG. 27B is a second diagram for describing the nurture completion screen. FIG. 27C is a third diagram for describing the nurture completion screen.

FIG. 28 is a diagram for describing a configuration of a memory in a player terminal and a function as a computer.

FIG. 29 is a diagram for describing a configuration of a memory in a server and a function as a computer.

FIG. 30 is a sequence diagram for describing processing of the player terminal and the server related to the nurture game.

FIG. 31 is a flowchart for describing preparation stage processing in the player terminal.

FIG. 32 is a flowchart for describing preparation stage processing in the server.

FIG. 33 is a flowchart for describing nurture stage processing in the server.

FIG. 34 is a flowchart for describing the turn-start processing in the server.

FIG. 35 is a flowchart for describing the nurture stage processing in the player terminal.

FIG. 36 is a flowchart for describing selection command reception processing in the server.

FIG. 37 is a flowchart for describing result information reception processing in the player terminal.

FIG. 38 is a flowchart for describing nurture game end processing in the server.

FIG. 39A is a diagram for describing an example of a gallery screen. FIG. 39B is a diagram for describing a character selection screen for a talk gallery. FIG. 39C is a diagram for describing a talk image selection screen. FIG. 39D is a diagram for describing a talk image.

FIG. 40A is a diagram for describing a character selection screen for event gallery. FIG. 40B is a diagram for describing a support card selection screen for event gallery. FIG. 40C is a diagram for describing a scenario selection screen for event gallery.

FIG. 41A is a first diagram for describing an event selection dialog. FIG. 41B is a second diagram for describing the event selection dialog.

FIG. 42 is a diagram for describing a viewing permission flag for an event set for a character card.

FIG. 43 is a diagram for describing a viewing permission flag for the support event.

FIG. 44 is a sequence diagram for describing processing related to a gallery function of the player terminal and the server.

FIG. 45 is a first flowchart for describing gallery-related processing in the player terminal.

FIG. 46 is a second flowchart for describing the gallery-related processing in the player terminal.

FIG. 47 is a flowchart for describing possession information update processing in the server.

### DESCRIPTION OF EMBODIMENTS

Hereinafter, an aspect of an embodiment of the present invention will be described in detail with reference to the accompanying drawings. Numerical values and the like described in the embodiment are merely examples for facilitating understanding, and do not limit the present invention unless otherwise specified. In this specification and the drawings, elements having substantially the same function and configuration are denoted by the same reference numerals, and redundant description thereof will be omitted, and elements not directly relating to the present invention will not be illustrated.

### Overall Configuration of Information Processing System S

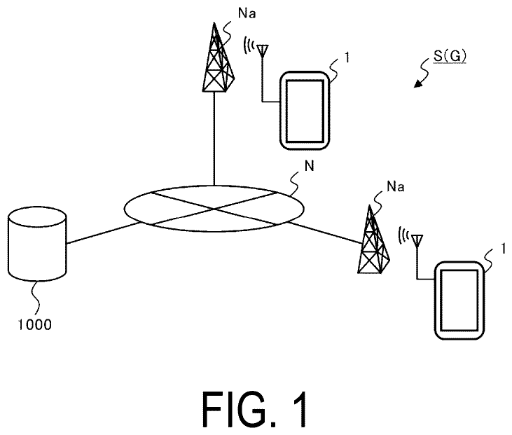

FIG. 1 is an explanatory diagram illustrating a schematic configuration of an information processing system S. The information processing system S is a so-called client-server system including a player terminal 1 functioning as a client, that is, a game terminal; a server 1000; and a communication network N including a communication base station Na.

In the information processing system S of the present embodiment, the player terminal 1 and the server 1000 function as a game apparatus G. Each of the player terminal 1 and the server 1000 has a role of controlling the progress of the game, and the game can progress via cooperation between the player terminal 1 and the server 1000.

The player terminal 1 can establish communication with the server 1000 via the communication network N. The player terminal 1 widely includes an electronic device capable of establishing a wireless or wired communication connection with the server 1000. Examples of the player terminal 1 include a smartphone, a mobile phone, a tablet device, a personal computer, a game console, and the like. In the present embodiment, a case where a smartphone is used as the player terminal 1 will be described.

The server 1000 is communicatively connected to a plurality of player terminals 1. The server 1000 accumulates various types of information for each player who plays the game. In addition, the server 1000 mainly performs processing such as updating the accumulated information and downloading images and various types of information to the player terminal 1 based on an operation input from the player terminal 1.

The communication base station Na is connected to the communication network N and wirelessly exchanges information with the player terminal 1. The communication network N is constituted by a cellular network, an Internet network, a local area network (LAN), a dedicated line, or the like, and establishes a wireless or wired communication connection between the player terminal 1 and the server 1000.

### Hardware Configuration of Player Terminal 1 and Server 1000

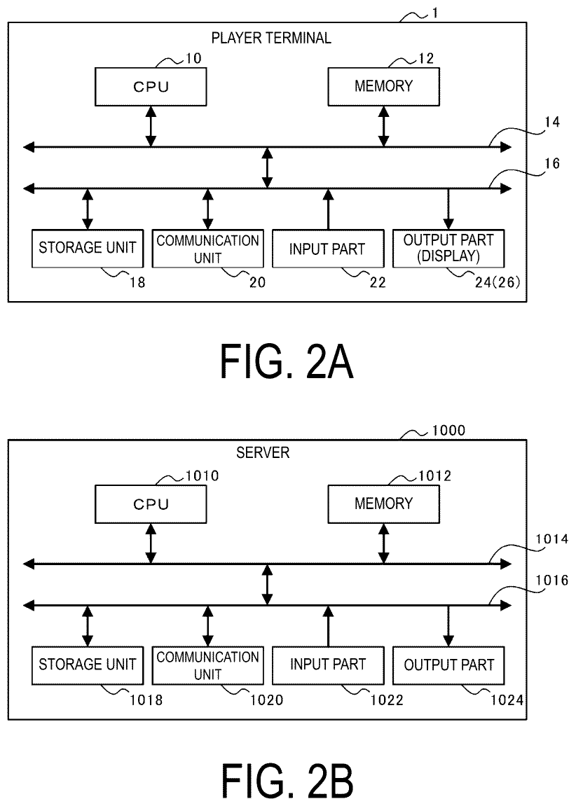

FIG. 2A is a diagram for describing a hardware configuration of the player terminal 1. FIG. 2B is a diagram for describing a hardware configuration of the server 1000. As illustrated in FIG. 2A, the player terminal 1 includes a central processing unit (CPU) 10, a memory 12, a bus 14, an input/output interface 16, a storage unit 18, a communication unit 20, an input part 22, and an output part 24.

As illustrated in FIG. 2B, the server 1000 includes a CPU 1010, a memory 1012, a bus 1014, an input/output interface 1016, a storage unit 1018, a communication unit 1020, an input part 1022, and an output part 1024.

The configurations and functions of the CPU 1010, the memory 1012, the bus 1014, the input/output interface 1016, the storage unit 1018, the communication unit 1020, the input part 1022, and the output part 1024 of the server 1000 are substantially the same as the CPU 10, the memory 12, the bus 14, the input/output interface 16, the storage unit 18, the communication unit 20, the input part 22, and the output part 24 of the player terminal 1, respectively. Thus, the hardware configuration of the player terminal 1 will be described below, and the description of the server 1000 will be omitted.

The CPU 10 operates a program stored in the memory 12 to control the progress of the game. The memory 12 is constituted by a read-only memory (ROM) or a random-access memory (RAM) and stores programs and various kinds of data necessary for controlling the progress of the game. The memory 12 is connected to the CPU 10 via the bus 14.

The input/output interface 16 is connected to the bus 14. The storage unit 18, the communication unit 20, the input part 22, and the output part 24 are connected to the input/output interface 16.

The storage unit 18 is constituted by a semiconductor memory such as a dynamic random access memory (DRAM) and stores various kinds of programs and data. In the player terminal 1, the programs and data stored in the storage unit 18 are loaded into the memory 12 (RAM) by the CPU 10.

The communication unit 20 is wirelessly communicatively connected to the communication base station Na and exchanges information such as various kinds of data and programs with the server 1000 via the communication network N. In the player terminal 1, programs or the like received from the server 1000 are stored in the memory 12 or the storage unit 18.

The input part 22 includes, for example, a touch panel, a button, a keyboard, a mouse, a four-direction key, an analog controller, and the like for inputting player operations (receiving operations). Alternatively, the input part 22 may be a dedicated controller provided in the player terminal 1 or connected (externally attached) to the player terminal 1. Furthermore, the input part 22 may be constituted by an acceleration sensor that detects the inclination or movement of the player terminal 1 or a microphone that detects audio from the player. That is, the input part 22 widely includes apparatuses that allow the player to distinguishably input their intention.

The output part 24 includes a display apparatus and a speaker. Note that the output part 24 may be a device connected (externally attached) to the player terminal 1. In the present embodiment, the player terminal 1 includes a display 26 as the output part 24 and a touch panel layered over the display 26 as the input part 22.

### Details of Game

Next, a game provided by the information processing system S and the game apparatus G of the present embodiment will be described. The player can possess a game medium obtained through a lottery called a gacha or a game medium distributed from the management side. In the present embodiment, the player can possess a character card and a support card as the game media. One character is always associated with each of the character card and the support card. Note that the character associated with the character card is a nurture target in a nurture game. Hereinafter, a character associated with a character card may be referred to simply as a character.

As will be described in detail below, in the game according to the present embodiment, a nurture game is provided. The player can nurture a character in the nurture game to produce a nurtured character in association with various parameters. In addition, the nurture game according to the present embodiment has a game property of nurturing a character associated with the character card while making the character participate in a race simulating horse racing.

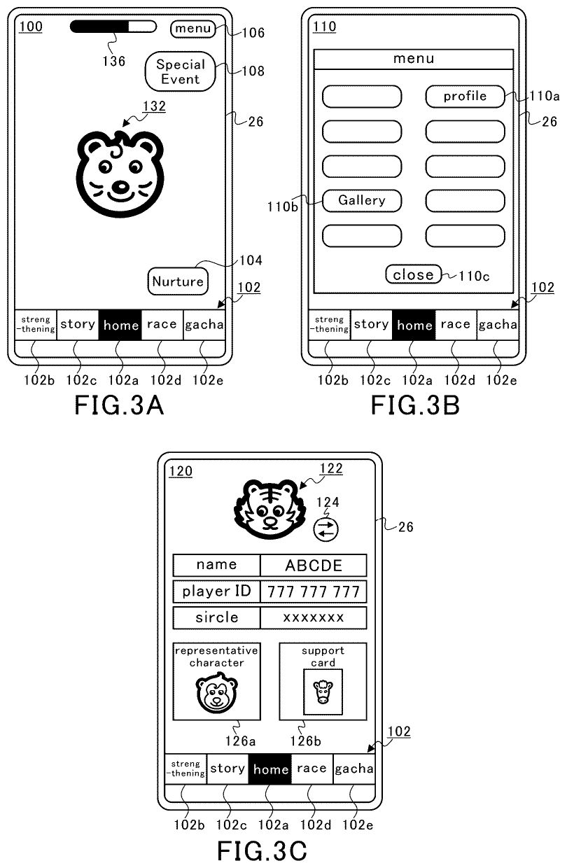

FIG. 3A is a diagram for describing an example of a home screen 100. When the game application is launched on the player terminal 1, the home screen 100 is displayed on the display 26. A menu bar 102 is displayed at a lower portion on the home screen 100. The menu bar 102 is provided with a plurality of operation portions that can be operated (tapped) by the player.

Here, the menu bar 102 is provided with a home screen selection operation portion 102a, a strengthening screen selection operation portion 102b, a story screen selection operation portion 102c, a racing game selection operation portion 102d, and a gacha screen selection operation portion 102e. In the menu bar 102, the operation portion corresponding to the screen being displayed is highlighted so that the screen being displayed on the display 26 can be distinguished.

When the home screen selection operation portion 102a is tapped, the home screen 100 illustrated in FIG. 3A is displayed on the display 26.

When the strengthening screen selection operation portion 102b is tapped, a strengthening screen (not illustrated) is displayed. On the strengthening screen, it is possible to strengthen the character or the support card possessed by the player. The player can increase the level set for the character or the support card by strengthening the character or the support card. Various parameters are set for the character and the support card, and the parameter is increased as the level is increased. The parameters for the character and the support card increasing enables the player to nurture the character having stronger stats in the nurture game.

When the story screen selection operation portion 102c is tapped, a story screen (not illustrated) is displayed. Here, a story image is provided for each character appearing in the game. The player can select and view a character and a story image on the story screen.

When the racing game selection operation portion 102d is tapped, a racing game selection screen (not illustrated) is displayed. In the present embodiment, various racing games are provided which a nurtured character nurtured in the nurture game described below can be made to enter. On the racing game selection screen, the player can select a racing game which the nurtured character is made to enter. An example of a racing game is a team competition game in which a team formed by a plurality of nurtured characters and a team of other players selected by a computer are made to compete with each other. The team competition game has a game property of competing with other players for ranking.

When the gacha screen selection operation portion 102e is tapped, a gacha screen (not illustrated) is displayed. On the gacha screen, the player can play a so-called gacha lottery by spending in-game currency or a ticket. In the gacha lottery, the character card or the support card can be obtained.

In addition, on the home screen 100, a nurture game operation portion 104 is provided above the menu bar 102. When the nurture game operation portion 104 is tapped, a nurture game screen is displayed, and a nurture game described below is started. The nurture game is roughly divided into a preparation stage and a nurture stage. First, in the preparation stage, the player selects and sets one character from among characters possessed by the player as a character to be nurtured (hereinafter referred to as a nurture target character).

Further, in the preparation stage, the player sets a deck to be used when nurturing the nurture target character. The deck is formed of a plurality of inheritance characters, which will be described in detail below, and a plurality of support cards. Thus, in the nurture game, the inheritance characters and the support cards forming the deck are used.

When the settings for the nurture target character and the deck (the inheritance characters and the support cards) are completed, the processing transitions from the preparation stage to the nurture stage, and the game for nurturing the nurture target character is started. In the nurture game, parameters for the nurture target character can be changed. The player can possess the character nurtured in the nurture game as a nurtured character. As described above, the player can form a team of nurtured characters possessed by the player and use the nurtured characters in a team competition game or the like.

As described above, the main goal of the game according to the present embodiment is to produce nurtured characters via the nurture game and to increase the ranking in the team competition game using the nurtured characters.

In addition, in the present embodiment, a function for sharing a nurtured character or a support card among players and a function for sharing information among a plurality of players are provided. The player can set a nurtured character and a support card that can be used by another player in the nurture game. To be specific, as illustrated in FIG. 3A, a settings operation portion 106 is provided in an upper right portion on the home screen 100. When the settings operation portion 106 is tapped, an option setting screen 110 is displayed.

FIG. 3B is a diagram for describing an example of the option setting screen 110. The option setting screen 110 is a screen on which various types of information can be confirmed and set. The option setting screen 110 is provided with a plurality of operation portions, and when an operation portion is tapped, information corresponding to the operation portion can be confirmed and set.

The operation portions of the option setting screen 110 include a profile setting operation portion 110a, a gallery operation portion 110b, and a close operation portion 110c. When the close operation portion 110c is tapped, the option setting screen 110 is closed. When the gallery operation portion 110b is tapped, a gallery screen 400 described later is displayed. When the profile setting operation portion 110a is tapped, a profile setting screen 120 is displayed.

FIG. 3C is a diagram for describing an example of the profile setting screen 120. On the profile setting screen 120, the player can confirm and set their own profile information. The profile information includes a profile character, a player name, a player ID, a circle they belong to, a representative character, and a rental card.

The profile character functions as a character that is displayed when the player's information is viewed by another player. For example, the profile character is displayed when using a circle function, the circle being a place for sharing information with other players. On the profile setting screen 120, a profile character image 122 that is currently set is displayed. Near the profile character image 122, a change button 124 is provided. When the change button 124 is tapped, a profile character change screen (not illustrated) is displayed. The player can change the profile character on the profile character change screen.

The profile setting screen 120 displays the player name set by the player, the player ID given to the player, and the name of the circle the player belongs to. The profile setting screen 120 is provided with a representative character setting operation portion 126a and a rental card setting operation portion 126b.

When the representative character setting operation portion 126a is tapped, a representative character setting screen (not illustrated) is displayed. The player can set any one of the nurtured characters nurtured by the player as a representative character on the representative character setting screen. In the representative character setting operation portion 126a, an icon image indicating the currently set representative character is displayed. As will be described in detail below, the representative character can be used for forming a deck as an inheritance character in the nurture game played by another player.

When the rental card setting operation portion 126b is tapped, a rental card setting screen (not illustrated) is displayed. The player can set any one of the support cards possessed by the player as a rental card on the rental card setting screen. In the rental card setting operation portion 126b, an icon image indicating the currently set rental card is displayed. As described above, a support card set as a rental card can be used for forming a deck by another player and is used in the nurture game played by another player.

Although not described in detail, when the setting of the profile information is changed on the profile setting screen 120, setting change information is transmitted to the server 1000. In the server 1000, profile information is saved for each player.

In addition, in the present embodiment, various limited-time events are held irregularly. A special event icon 108 is displayed on the home screen 100 during the active period of the special event which is a limited-time event. When the special event icon 108 is tapped, a special event screen is displayed. On the special event screen, for example, the player can exchange special event points provided only in the special event with various rewards.

When the nurture game operation portion 104 is tapped on the home screen 100, a nurture game screen is displayed and the nurture game is started. The player can play the nurture game by spending game points. The game points are given to the player at a rate of a predetermined value (for example, +1) every predetermined period of time (for example, 10 minutes). An upper limit value (for example, 100) is defined for the game points that can be possessed by the player, and the player can possess game points within the range of the upper limit value. A game point display bar 136 is provided in an upper portion on the home screen 100, and a ratio of the currently possessed game points to the upper limit value is visually displayed.

The game points are subtracted by a predetermined value (for example, −30) at a time when the nurture game is started. Thus, when the player does not possess the required game points, the player cannot start the nurture game. However, the player can possess an item for recovering game points and can recover game points using the item. For example, this item can be given as a reward in the nurture game or the team competition game or can be obtained by spending in-game currency. Hereinafter, the nurture game will be described in detail.

### Nurture Game

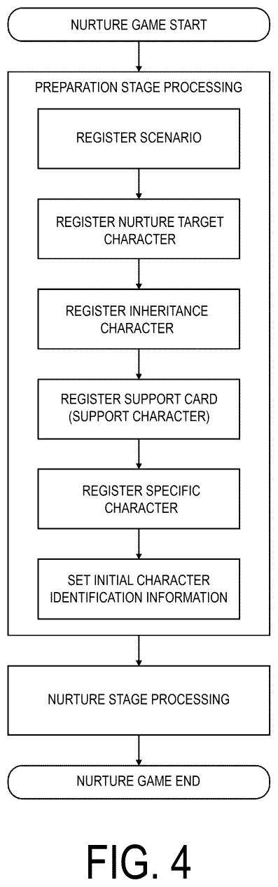

FIG. 4 is a diagram for describing a rough flow of the nurture game. The nurture game is roughly divided into a setting game and a nurture main game. As will be described in detail below, the nurture main game is a game in which one character selected from among the characters possessed by the player is nurtured as a character to be nurtured (hereinafter, referred to as a nurture target character).

In addition, the setting game is a game in which the player registers the nurture target character and a deck (inheritance characters and support cards), with this corresponding to the preparation stage of the nurture game. Hereinafter, the processing executed in the setting game is referred to as preparation stage processing, and the processing executed in the nurture main game is referred to as nurture stage processing. Here, in order to facilitate understanding, a rough flow of the preparation stage processing and the nurture stage processing will be described first.

As illustrated in FIG. 4, in the preparation stage processing, registration of a scenario, registration of a nurture target character, registration of an inheritance character, registration of a support card, and registration of a specific character are sequentially performed. Note that the orders of the registrations and setting processes described above are merely examples. Therefore, the orders of the registrations and setting processes described above can be changed as appropriate.

### Preparation Stage Processing

In the preparation stage processing, registration of a scenario, registration of a nurture target character, and registration of a deck (inheritance characters and support cards) are mainly performed. Note that the support cards are for assisting the nurturing of the nurture target character. One character is always associated with each support card, and the character associated with the support card registered in the preparation stage processing assists the nurturing of the nurture target character. Hereinafter, a character associated with a support card is referred to as a support character.

### Registration of Scenario

When the player taps the nurture game operation portion 104 on the home screen 100, a scenario selection screen (not illustrated) is displayed. In the present embodiment, a plurality of scenarios of the nurture main game are provided. In each scenario of the nurture main game, a final goal, a goal for during the game, and the like are set. The player needs to sequentially clear the goals set in the respective scenarios. The goal, a time period until the goal is achieved, a difficulty of a game, and the like are different for each scenario.

The nurture main game is story-like narrative, and the game progresses along a story. In addition, during the nurture main game, events occur at various timings. Events occurring during the nurture main game include a scenario-specific event. Therefore, the plurality of scenarios are different from each other in at least some of the events occurring during the nurture main game. The player can select any one of the plurality of scenarios on the scenario selection screen.

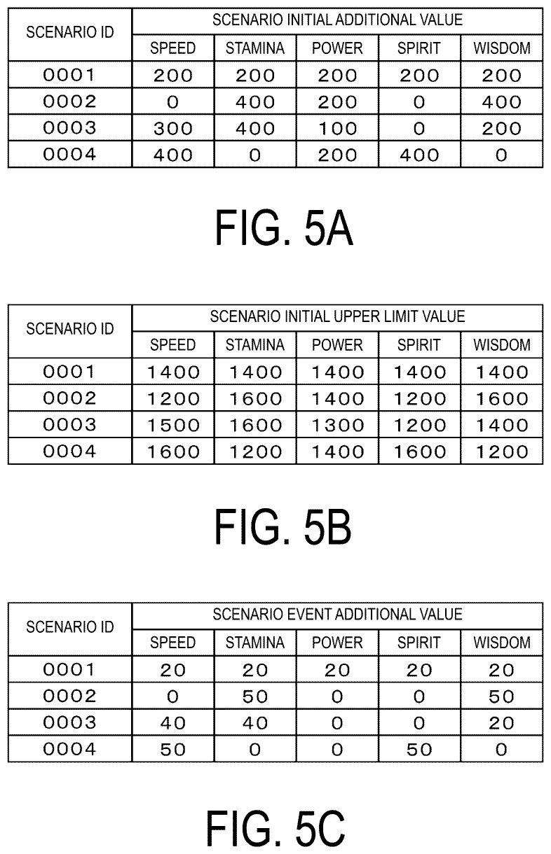

FIG. 5A is a diagram for describing an example of a scenario initial additional value data. FIG. 5B is a diagram for describing an example of a scenario initial upper limit value data. FIG. 5C is a diagram for describing an example of a scenario event additional value data. As illustrated in FIG. 5A, each scenario is associated with a unique scenario ID. When the player selects a scenario on the scenario selection screen, a scenario ID associated with the selected scenario is registered. Here, four scenario IDs of 0001 to 0004 are provided.

As will be described in detail below, the goals of the nurture game include increasing an ability parameter for the nurture target character. Here, five ability parameters are provided, namely speed, stamina, power, spirit, and wisdom. The greater values of these five ability parameters, the more advantageous a race development of the nurture target character.

However, an upper limit value is set for each ability parameter, and in the nurture main game, the value of each ability parameter is updated only within a range up to the upper limit value, and update of the ability parameter is restricted not to exceed the upper limit value. Upon starting of the nurture main game, an initial upper limit value of each ability parameter is set. The initial upper limit value is different for each scenario. Note that the upper limit value of each ability parameter may be increased from the initial upper limit value during the game.

The scenario initial additional value data is stored in the player terminal 1 and the server 1000. The scenario initial additional value data is data in which an initial additional value of each of five ability parameters is associated with the scenario ID. In the present embodiment, upon starting of the nurture main game, the initial upper limit value of each ability parameter is set based on the scenario initial additional value data.

Specifically, a common base value is set in advance for each ability parameter. In the present embodiment, the common base value is set to “1200”. This common base value is common for all scenarios and all ability parameters. However, the common base value may be different for each scenario or may be different for each ability parameter. Then, upon starting of the nurture main game, the scenario initial additional value corresponding to the scenario selected by the player is added to the common base value, and the initial upper limit value of each ability parameter is set.

For example, as illustrated in FIG. 5A, according to the scenario initial additional value data, the scenario initial additional values of five ability parameters associated with the scenario ID of “0001” are all set to “200”. Therefore, in a case where the scenario ID “0001” is selected and the nurture main game is started, the initial upper limit values of five ability parameters are all “1400”.

Further, for example, in a case where the scenario ID “0002” is selected and the nurture main game is started, the initial upper limit values of the ability parameters of speed and spirit are “1200” which is the common base value, the initial upper limit values of the ability parameters of stamina and wisdom are “1600”, and the initial upper limit value of the ability parameter of power is “1400”.

Note that here, the initial upper limit value is derived by adding the initial additional value of the ability parameter to the common base value. However, as illustrated in FIG. 5B, the scenario initial upper limit value data may be provided, and the initial upper limit value of each ability parameter may be derived based on the scenario initial upper limit value data. According to the scenario initial upper limit value data, the initial upper limit value of each of five ability parameters is associated with the scenario ID. In the scenario initial upper limit value data, the value of the initial upper limit value associated with each scenario ID is a value obtained by adding the initial additional value of the scenario initial additional value data to the common base value.

In this way, the scenario initial upper limit value associated with the scenario ID may be set as the initial upper limit value of each ability parameter. Alternatively, a value obtained by adding the scenario initial additional value to the common base value may be set as the initial upper limit value of each ability parameter.

In the nurture main game, a scenario event in which the upper limit value of each ability parameter is increased may occur at a predetermined timing. When the scenario event occurs, a scenario event additional value associated with the scenario event is added to the upper limit value at that time. For example, in the nurture main game of the scenario ID “0001”, when a predetermined scenario event occurs, the respective upper limit values of five ability parameters are increased by “20”.

As illustrated in FIG. 5C, the upper limit value of the ability parameter increased due to the scenario event differs for each scenario. Note that a plurality of scenario events in which the upper limit value of the ability parameter is increased may be provided for one scenario, or no scenario event may be provided. The timing of occurrence of a scenario event may be common to all scenarios or may be different from one scenario to another.

In this manner, the upper limit value of the ability parameter differs depending on the scenario selected by the player. As a result, the characters can be nurtured that have different abilities and characteristics for each scenario. This increases the motivation of the player to play the game in various scenarios.

### Registration of Nurture Target Character

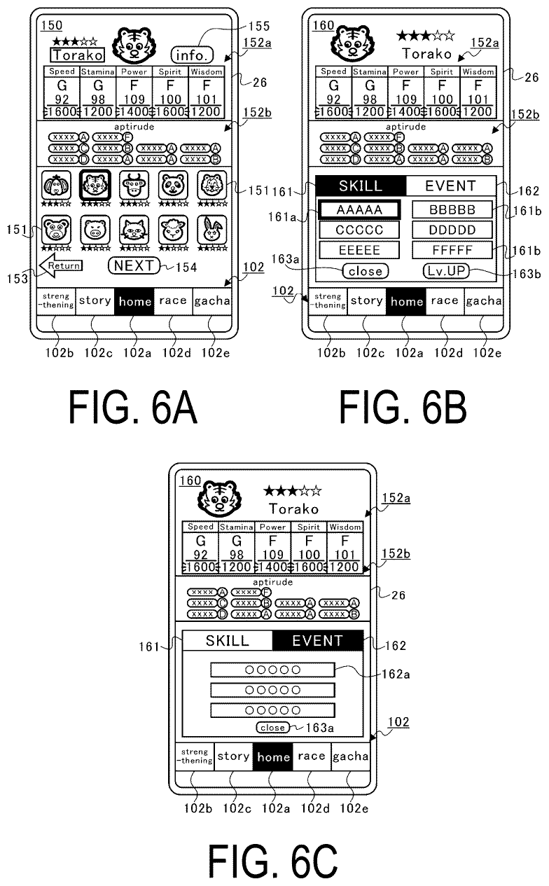

FIG. 6A is a diagram for describing a nurture target character selection screen 150. When the player selects a scenario on the scenario selection screen, the nurture target character selection screen 150 illustrated in FIG. 6A is displayed. At a central portion on the nurture target character selection screen 150, a plurality of character icons 151 are displayed and a list of characters possessed by the player is displayed.

In addition, an ability parameter display portion 152a and an aptitude parameter display portion 152b are displayed in an upper portion on the nurture target character selection screen 150. In addition, a return operation portion 153 and a next operation portion 154 are displayed in a lower portion on the nurture target character selection screen 150.

In the present embodiment, initial values of the ability parameters are set for each character. The initial values of the ability parameters for the character corresponding to the character icon 151 selected by the player are displayed in numerical values in the ability parameter display portion 152a. In the present embodiment, the larger the numerical value of the ability parameter is, the higher the ability is.

In the ability parameter display portion 152a, the initial upper limit values of the respective ability parameters are also displayed. In other words, the upper limit values of the respective ability parameters set upon starting of the nurture main game are displayed in the ability parameter display portion 152a in a state where the player can select a scenario or after the player selects a scenario. In the ability parameter display portion 152a, each of the initial upper limit values corresponding to the scenario selected by the player is displayed in the denominator, and each of the initial values of the ability parameters for the character selected by the player is displayed in the numerator.

Here, in the ability parameter display portion 152a, the initial upper limit values exceeding the common base value are displayed to be distinguished. For example, in the example illustrated in FIG. 6A, the initial upper limit values of the speed, the power, and the spirit exceed “1200” which is the common base value. Therefore, in the ability parameter display portion 152a, the initial upper limit values of the speed, the power, and the spirit are displayed to be distinguished relative to the initial upper limit values of the stamina and the wisdom. Here, in the displaying to be distinguished, the initial upper limit value exceeding the common base value is displayed in a blinking manner or displayed in a different color.

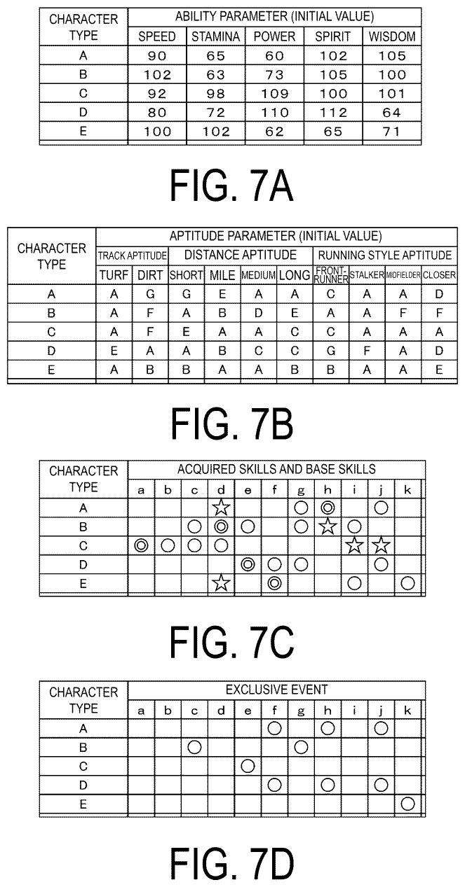

FIG. 7A is a diagram for describing an ability parameter (initial value) table. In the present embodiment, as illustrated in FIG. 7A, the initial values of ability parameters for each character are stored in the ability parameter (initial value) table. Then, based on the initial values of the ability parameters stored in the ability parameter (initial value) table, the initial values of the ability parameters are displayed in the ability parameter display portion 152a.

In the present embodiment, an initial value of an ability parameter is set for each one of a plurality of types of abilities for each character. To be more specific, an ability parameter of speed denoted by “Speed” in the ability parameter display portion 152a, an ability parameter of stamina denoted by “Stamina” in the ability parameter display portion 152a, an ability parameter of power denoted by “Power” in the ability parameter display portion 152a, an ability parameter of spirit denoted by “Spirit” in the ability parameter display portion 152a, and an ability parameter of wisdom denoted by “Wisdom” in the ability parameter display portion 152a are provided as the ability parameters.

Note that the initial value of the ability parameter for each character is increased by strengthening the character (character card). For example, each character is provided with five stages of stats levels, and the player can increase the stats level of the character by spending in-game currency and predetermined items. As the stats level of the character increases, the initial value of the ability parameter for the character increases.

In FIG. 7A, the initial values when the character is at a predetermined level is illustrated. Note that the player can increase the value of the ability parameters in the nurture main game. That is, the goal of the nurture main game is to nurture a character to have higher numerical values for the ability parameters.

In the present embodiment, an aptitude parameter (initial value) is set for each character. As illustrated in FIG. 6A, the initial values of the aptitude parameters for the character corresponding to the character icon 151 selected by the player are displayed in alphabetical letters in the aptitude parameter display portion 152b.

FIG. 7B is a diagram for describing an aptitude parameter (initial value) table. In the present embodiment, as illustrated in FIG. 7B, the initial values of the aptitude parameters for each character are stored in the aptitude parameter (initial value) table. The initial values of the aptitude parameters are set to any one of seven stages of alphabetical letters A to G. For the initial values of the aptitude parameters, A indicates the highest aptitude and G indicates the lowest aptitude. Based on the initial values of the aptitude parameters stored in the aptitude parameter (initial value) table, the initial values of the aptitude parameters are displayed in the aptitude parameter display portion 152b.

In the present embodiment, an initial value of the aptitude parameter is set for each one of a plurality of types of aptitude for each character. Specifically, the aptitude parameters include aptitude parameters related to track aptitude for turf and dirt; aptitude parameters related to distance aptitude for short distance, mile, medium distance, and long distance; and aptitude parameters related to running style aptitude for front-runner, stalker, midfielder, and closer.

In the nurture game, the player can make the nurture target character enter various races. At this time, if the aptitude of the nurture target character that matches the race content is high, the nurture target character will be more advantageous in the developments of the race.

The initial values of the aptitude parameters for each character may be increased by spending in-game currency. Further, the values of the aptitude parameters may change in the nurture main game. Further, in the nurture main game, the aptitude parameter may be set to S, which is a higher aptitude than A.

FIG. 6B is a first diagram for describing a character detail screen 160. FIG. 6C is a second diagram for describing the character detail screen 160. When the character icon 151 on the nurture target character selection screen 150 is taped and held, the character detail screen 160 is displayed on the display 26. On the character detail screen 160, the details of the abilities of the character corresponding to the character icon 151 which was tapped and held on the nurture target character selection screen 150 are displayed.

A skill operation portion 161 and an event operation portion 162 are displayed at a central portion on the character detail screen 160. As illustrated in FIG. 6B, when the character detail screen 160 is first displayed, the skill operation portion 161 is highlighted, and the skills provided for each character are displayed. A skill is an ability that may be activated when a predetermined condition is met while executing a race and a team race as described below. Activating the skills gives each character an advantage in the development of the race.

FIG. 7C is a diagram for describing the skills. As illustrated in FIG. 7C, each character has a plurality of skills. As illustrated in FIG. 6B, the skills possessed by the character (hereinafter referred to as base skills) are displayed on the character detail screen 160. In the nurture main game, the base skill for the nurture target character can be acquired by satisfying a predetermined condition. Note that a skill just only being possessed is not activated during the race, but first becomes possible to be activated by acquiring the base skill. Hereinafter, a skill in a state in which the character can activate the skill, that is, the skill acquired by the character, is referred to as an acquired skill.

One acquired skill is set for the character from the beginning of the nurture main game. In addition to the acquired skill, a plurality of base skills are set for the character. The base skill can be acquired by spending skill points described below after starting of the nurture main game. That is, a base skill can become an acquired skill in exchange for skill points.

In the present embodiment, a skill corresponding to “⊚” illustrated in FIG. 7C is displayed as an acquired skill on the character detail screen 160 in FIG. 6B. Further, a skill corresponding to “circle” illustrated in FIG. 7C is displayed as a base skill on the character detail screen 160 in FIG. 6B. In the present embodiment, as illustrated in the character detail screen 160 in FIG. 6B, the acquired skill is highlighted so that the acquired skill and the base skill can be easily distinguished from each other.

Specifically, on the character detail screen 160 in FIG. 6B, one acquired skill is displayed in an acquired skill display field 161a and seven base skills are displayed in a base skill display field 161b. Note that the number of acquired skills and the number of base skills may be different for each character. Further, for example, the number of acquired skills or base skills for each character may be increased as the level of the character is increased, in-game currency or items are spent, and the like.

Here, the base skill includes an awakening skill. The awakening skill is a skill that is associated with the character as a base skill from starting of the nurture game when an unlock condition is met. That is, the awakening skill for which the unlock condition is not met is not a base skill upon starting of the nurture game. However, even the awakening skill for which the unlock condition is not met may become a base skill during the nurture main game.

In FIG. 7C, the awakening skill is indicated by a star mark. Here, four awakening skills are set for the characters. However, the number of awakening skills may be different for each character. Note that the awakening skill is different for each character. For example, a skill “d” in the figure is set as an awakening skill for a character “A”, as an acquired skill for a character “B”, and as a normal base skill for a character “C”. In this way, the skills include those set differently depending on the character, such as an acquired skill, a base skill, and an awakening skill.

In the present embodiment, an awakening level of the character is set as the unlock condition for the awakening skill. The character (character card) is associated with the stats level and the awakening level described above. The player can individually increase the stats level and the awakening level. As illustrated in FIG. 6B, a close operation portion 163a and a strengthening operation portion 163b are provided on the character detail screen 160. When the strengthening operation portion 163b is tapped, a character strengthening screen 165 is displayed on the display 26

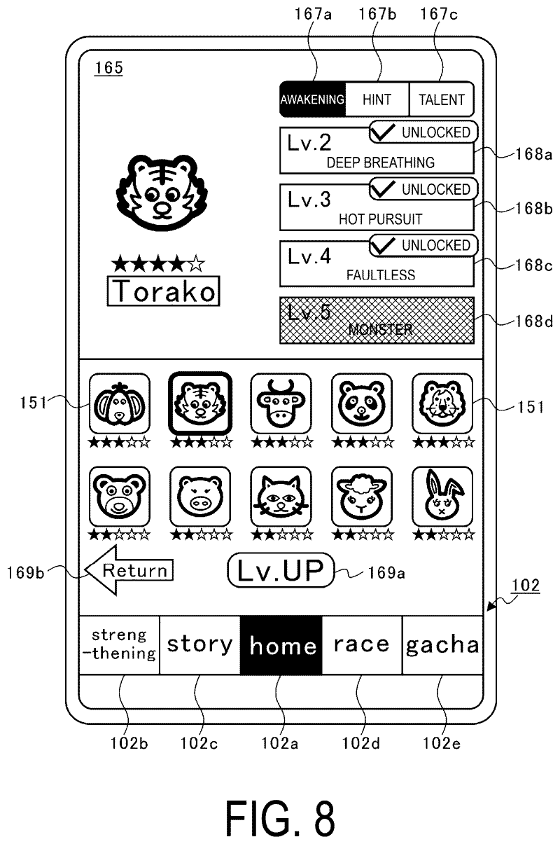

FIG. 8 is a diagram for describing the character strengthening screen 165. The character strengthening screen 165 is displayed when the strengthening operation portion 163b on the character detail screen 160 is tapped and when the strengthening screen selection operation portion 102b is tapped. Character icons 151 corresponding to the base characters are displayed at a center portion to a lower portion on the character strengthening screen 165. When any of the character icons 151 is tapped by the player, the character corresponding to the tapped character icon 151 is put in a selected state.

Note that when the strengthening operation portion 163b on the character detail screen 160 is tapped and the character strengthening screen 165 is displayed, the character in the selected state on the character detail screen 160 is also in the selected state at the time when the character strengthening screen 165 starts to be displayed. Information relating to the character in the selected state is displayed in an upper portion on the character strengthening screen 165.

To be more specific, the character strengthening screen 165 is provided with an awakening tab 167a, a hint tab 167b, and a stats tab 167c. When the awakening tab 167a is tapped, awakening skill display fields 168a, 168b, 168c, and 168d are displayed. Note that when the character strengthening screen 165 starts to be displayed, the awakening tab 167a is selected, and the awakening skill display fields 168a, 168b, 168c, and 168d are displayed. The awakening skill display fields 168a, 168b, 168c, and 168d are denoted by names corresponding to their respective awakening skills.

An awakening level strengthening button 169a is provided in a lower portion on the character strengthening screen 165. When the awakening level strengthening button 169a is tapped, a confirmation screen (not illustrated) is displayed. The confirmation screen displays an item required to increase the awakening level and a notification that spending the item increases the awakening level. When a predetermined operation is input on the confirmation screen, the awakening level of the character in the selected state increases.

In the present embodiment, the awakening level is set to level 1 in an initial state of each character. The player can increase the awakening level of the character up to level 5 by spending the item. Each awakening level is associated with one awakening skill. Increasing the awakening level unlocks the awakening skill corresponding to the increased awakening level. Specifically, when the awakening level becomes level 2, the awakening skill corresponding to level 2 is unlocked. Similarly, when the awakening level becomes level 5, the awakening skill corresponding to level 5 is unlocked.

In this way, four awakening skills are set for each character. Then, by increasing the awakening level, the player can unlock the same number of awakening skills as the number of awakening levels increased. The awakening skill once unlocked functions as a base skill that can be acquired.

The awakening skills unlocked when the awakening levels are 2, 3, 4, and 5 are displayed in the awakening skill display fields 168a, 168b, 168c, and 168d, respectively. At this time, the unlocked awakening skill is denoted by “unlocked” in the awakening skill display field 168a, 168b, 168c, or 168d. On the other hand, for an awakening skill not yet unlocked, the awakening skill display fields 168a, 168b, 168c, and 168d are grayed out. FIG. 8 illustrates a state in which three awakening skills with the awakening levels being level 4 are unlocked.

Note that when the awakening skill display fields 168a, 168b, 168c, and 168d are tapped and held, detailed information such as the content of each awakening skill is displayed although a detailed description is omitted. When the hint tab 167b is tapped, a hint level strengthening screen (not illustrated) is displayed. In the hint level strengthening screen, the hint level of the base skill described later can be increased by spending the item.

When the stats tab 167c is tapped, a stats level strengthening screen (not illustrated) is displayed. In the stats level strengthening screen, the stats level of the character can be increased by spending the item. The character strengthening screen 165 is provided with a return operation portion 169b. When the return operation portion 169b is tapped, the character strengthening screen 165 is closed, and the character detail screen 160 is displayed.

When the player taps the event operation portion 162 on the character detail screen 160, the content of the character detail screen 160 is switched as illustrated in FIG. 6C, and an exclusive event display field 162a indicating an exclusive event provided for each character is displayed. The exclusive event is generated when a predetermined condition is met in the nurture main game. When the exclusive event is generated, the story image related to the character appearing in the nurture game is displayed or the value of the ability parameter is changed.

FIG. 7D is a diagram for describing the exclusive events. As illustrated in FIG. 7D, each character is associated with a plurality of exclusive events. As illustrated in FIG. 6C, the exclusive events associated with the character are displayed on the character detail screen 160. Note that the exclusive events may include a hint event to enable a skill to be possessed or acquired, an ability event to increase or decrease a numerical value of an ability parameter for a character, and the like.

All of the exclusive events displayed in the character detail screen 160 illustrated in FIG. 6C may be executed during running the nurture main game, at least some thereof may be executed during running the nurture main game, or none thereof may be executed during running the nurture main game when a predetermined condition is not met. Also, for example, the number of exclusive events provided for each character may be increased due to an increase in the level of the character, spending of in-game currency or items, and the like. In addition, when a predetermined condition is met, an exclusive event that is not being displayed as the exclusive event may be executed during the nurture main game.

As illustrated in FIGS. 6B and 6C, a close operation portion 163a denoted by “close” is displayed in a lower portion on the character detail screen 160. When the close operation portion 163a on the character detail screen 160 is tapped, the display of the character detail screen 160 ends, and the nurture target character selection screen 150 is displayed on the display 26.

When the return operation portion 153 is tapped on the nurture target character selection screen 150 illustrated in FIG. 6A, the home screen 100 illustrated in FIG. 3A is displayed on the display 26. The nurture target character selection screen 150 is provided with a nurture information display button 155. When the nurture information display button 155 is tapped, a nurture information display screen (not illustrated) is displayed. The player can confirm the information related to the character selected on the nurture target character selection screen 150 on the nurture information display screen.

The goal of the nurture game is to produce a stronger nurtured character by nurturing a character selected as the nurture target character that is a character to be nurtured from among characters possessed by the player. As will be described in detail below, the nurture main game includes a plurality of turns, and the player needs to make the nurture target character train or participate in a race for each turn.

A plurality of clear goals are set for each character. The clear goals set for the selected character can be confirmed on the nurture information display screen. A race which the nurture target character can be made to enter is predefined for each turn. The clear goal includes making the nurture target character enter a predetermined race in a predetermined turn and acquire a predetermined order of arrival.

Further, making the nurture target character that is a character to be nurtured enter the race allows the nurture target character to obtain fans. In each race, a base obtaining number of fans is defined for each placing, and the higher the placing, the larger number of fans to be obtained. In addition, a difficulty is set for each race, and the higher the difficulty, the larger number of fans can be obtained.

Here, the number of fans that can be obtained by entering the race is calculated by adding a bonus obtaining number to the base obtaining number defined for each placing. Specifically, a correction value is determined based on a race result, and the bonus obtaining number is calculated by multiplying the base obtaining number by the correction value. The total number of the bonus obtaining number and the base obtaining number is the number of fans obtained by the nurture target character. For example, when the race result is the first place, the correction value increases as a difference between the nurture target character and the second place character increases. In addition, when the race result is from the second to fifth place, the correction value increases as the difference between the nurture target character and the first place character decreases.

The nurture target character activates a skill (acquired skill) at a predetermined probability during the race. At this time, as the number of activated skills increases, the correction value increases. As described above, for each race, the condition for adding the number of fans is defined, and the number of fans to be obtained increases depending on various race results other than the placing and the progress of the race. However, the number of fans obtained by the nurture target character is at least equal to or greater than the base obtaining number corresponding to the placing.

For some races, the number of fans may be defined as a race entry condition. When the number of fans obtained by the nurture target character is less than the number of fans defined as the race entry condition, the player cannot make enter the nurture target character enter the race. The higher the difficulty of a race, the greater the number of fans required to enter the race. Therefore, when a race for which the number of fans is defined as the race entry condition is set as a race that the clear goal to be achieved (hereinafter referred to as a goal target race), the nurture target character needs to have acquired the number of fans defined for the goal target race by the turn in which the goal target race is performed.

The clear goal includes acquiring a predetermined number or more of fans by a predetermined turn. The clear goal includes, for example, getting the first place in a race with the high difficulty (for example, GI) within a predetermined turn range a predetermined number of times or more. In this way, a plurality of clear goals are set for each character. By achieving the clear goal, the player can continue the nurture main game until the final turn. On the other hand, when the clear goal cannot be achieved, the nurture main game ends in the relevant turn.

Therefore, when the number of fans defined for the goal target race is not acquired by the turn in which the goal target race is performed, the nurture target character cannot enter the goal target race. In this case, the clear goal is not achieved, and the nurture game ends.

In the nurture main game, since the various parameters for the nurture target character are increased in each turn, the larger the number of turns, the stronger nurtured character can be produced. Therefore, when the nurture main game is played, the parameters for the nurture target character need to be increased so that all the clear goals can be cleared.

Note that basically, the clear goal set for each character is fixed, and the same clear goal is set as a task each time the nurture game is played. However, a character may be included for which a clear goal that varies according to a progress status of the nurture main game is set or for which the player can select a clear goal.

When the nurture game ends, the nurtured character is produced. At the time of completion of the nurture game, an evaluation score is calculated for the nurtured character and a nurture rank is derived based on the evaluation score. The evaluation score is calculated based on a calculation formula set in advance, such as a score calculated by various parameters for the nurture target character at nurture completion, a score calculated by the acquired skill, or the like. The nurture information display screen displays information indicating the rank, evaluation score, name, and registration date of each of the top three nurtured characters having high evaluation scores among the nurtured characters nurtured based on the selected character.

Note that a plurality of scenarios are provided in the nurture game although detailed description is omitted. The basic game specifications are common to the respective scenarios, but some functions are different for each scenario. The nurture information display screen displays a scenario selected when each nurtured character is nurtured.

As described above, the player can select a nurture target character while checking various types of information of each character on the nurture target character selection screen 150 illustrated in FIG. 6A. When the next operation portion 154 is tapped on the nurture target character selection screen 150, the selected character is set as the nurture target character, and an inheritance character selection screen 170 is displayed on the display 26.

### Registration of Inheritance Character

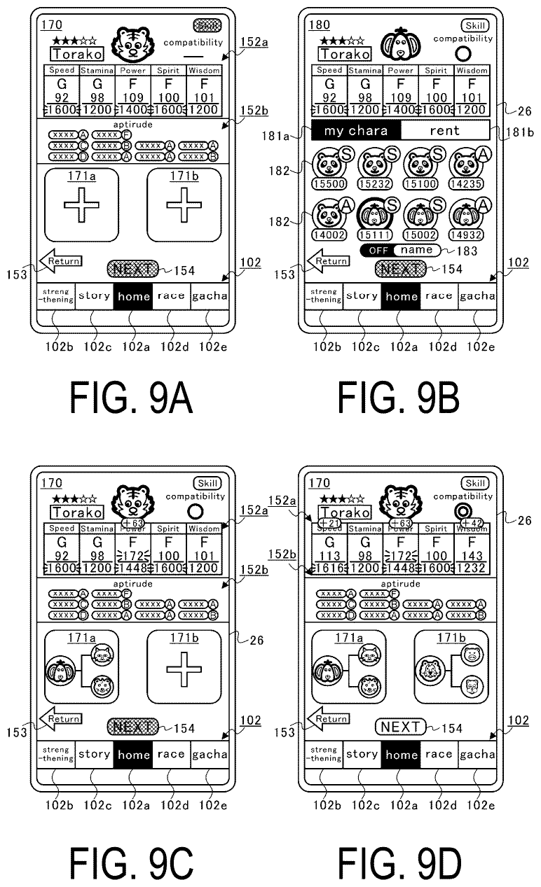

FIG. 9A is a first diagram for describing the inheritance character selection screen 170. FIG. 9B is a first diagram for describing a nurtured character list screen 180. FIG. 9C is a second diagram for describing the inheritance character selection screen 170. FIG. 9D is a third diagram for describing the inheritance character selection screen 170. The inheritance character selection screen 170 is a screen for the player to register an inheritance character.

An inheritance character is a character that causes the nurture target character to inherit an ability value, a skill, or the like. The player can select two inheritance characters from the nurtured characters possessed by the player and representative characters of other players extracted in accordance with a predetermined extraction condition, such as the representative characters of friends such as followers, and use the representative characters to form a deck and register the representative characters. Note that only one representative character of another player can be used as an inheritance character to form a deck in one nurture game.

The inheritance character selection screen 170 is provided with the ability parameter display portion 152a, the aptitude parameter display portion 152b, a first inheritance character selection region 171a, and a second inheritance character selection region 171b. When the screen transitions from the nurture target character selection screen 150 to the inheritance character selection screen 170, the first inheritance character selection region 171a and the second inheritance character selection region 171b are displayed as blank fields as illustrated in FIG. 9A.

When the first inheritance character selection region 171a or the second inheritance character selection region 171b is tapped, the nurtured character list screen 180 illustrated in FIG. 9B is displayed. The nurtured character list screen 180 is provided with a my character tab 181a and a rental tab 181b. Below the my character tab 181a and the rental tab 181b, a nurtured character list display region is provided. A nurtured character icon 182 is displayed in the nurtured character list display region.

In a state where the my character tab 181a is selected, the nurtured character icons 182 corresponding to the nurtured characters possessed by the player are displayed as illustrated in FIG. 9B. Although not illustrated, in a state where the rental tab 181b is selected, the representative character of a friend, that is, the nurtured character icon 182 corresponding to the nurtured character nurtured by a friend is displayed.

Further, when the nurtured character icon 182 is tapped, the nurtured character corresponding to the nurtured character icon 182 is put in a provisionally selected state. When the nurtured character icon 182 is tapped, the inheritance character selection screen 170 is displayed as illustrated in FIG. 9C. At this time, for example, when the first inheritance character selection region 171a is tapped to display the nurtured character list screen 180 and the nurtured character icon 182 is tapped on the nurtured character list screen 180, an image indicating the nurtured character in the provisionally selected state is displayed in the first inheritance character selection region 171a.

In this state, for example, when the second inheritance character selection region 171b is tapped to display the nurtured character list screen 180 and the nurtured character icon 182 is tapped on the nurtured character list screen 180, an image indicating the nurtured character in the provisionally selected state is displayed in the second inheritance character selection region 171b as illustrated in FIG. 9D.

In addition, the nurtured character is stored in association with information related to the inheritance character used in the nurturing. In the first inheritance character selection region 171a, information related to the inheritance character used when nurturing the nurtured character is displayed.

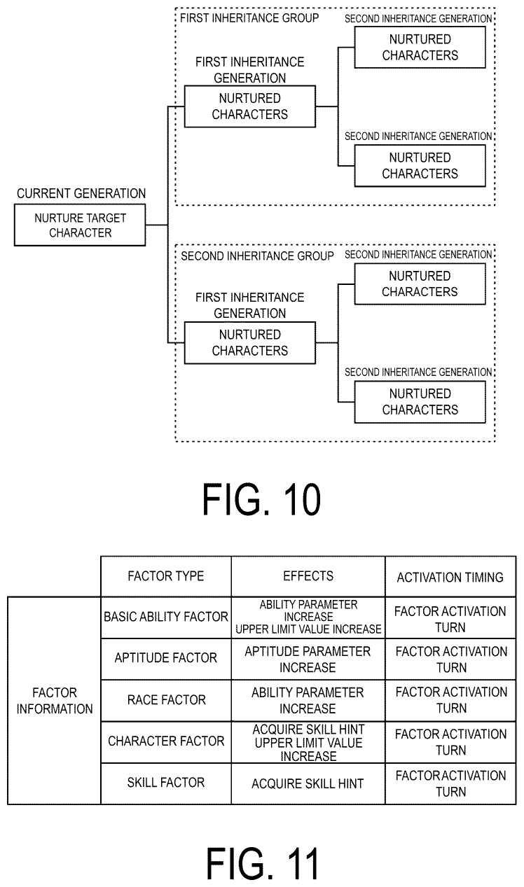

FIG. 10 is a diagram for describing an inheritance system. In the nurture game, various effects such as an increase in the values of an ability parameter and an aptitude parameter for the nurture target character are achieved based on the factor information of the inheritance character. Here, two inheritance characters are set for one nurture target character, and these inheritance characters are the previously produced nurtured characters. Thus, when a nurtured character set as an inheritance character is produced, two inheritance characters are set for the nurtured character.

As illustrated in FIG. 10, the nurture target character that is a character to be nurtured in the nurture main game to be started is set as a current generation. Further, for the nurture target character, two nurtured characters set as inheritance characters are of a first inheritance generation. Further, for each of the nurtured characters of the first inheritance generation, upon starting of the nurturing thereof, two nurtured characters are set as inheritance characters. The two nurtured characters set as inheritance characters when the nurtured character of the first inheritance generation is produced are of a second inheritance generation.

In this case, as illustrated in FIG. 10, the nurtured characters of the first inheritance generation and the second inheritance generation have an effectiveness on the nurture target character of the current generation. As described above, since two inheritance characters (of the first inheritance generation) are set for one nurture target character, a total of six nurtured characters have the effectiveness on one nurture target character.

For example, one of the two nurtured characters of the first inheritance generation and the two nurtured characters of the second inheritance generation that are the inheritance characters of the former nurtured character are included in a first inheritance group. In a similar manner, the other of the two nurtured characters of the first inheritance generation and the two nurtured characters of the second inheritance generation that are inheritance characters of the former nurtured character are included in a second inheritance group.

As illustrated in FIG. 9D, in the first inheritance character selection region 171a, icons are displayed which correspond to one nurtured character of the first inheritance generation and two nurtured characters of the second inheritance generation included in the first inheritance group. In a similar manner, in the second inheritance character selection region 171b, icons is displayed which correspond to one nurtured character of the first inheritance generation and two nurtured characters of the second inheritance generation included in the second inheritance group.

FIG. 11 is a diagram for describing factor information. As will be described in detail below, when the nurture game is completed, the nurture target character is registered as a nurtured character, and at this time, factor information is stored in association with the nurtured character. Specifically, when the nurturing of the nurtured character is completed, a factor to be obtained by the nurtured character is determined through a lottery or the like. Then, factor information indicating the determined factor is associated with the nurtured character. In other words, at the completion of the nurture game, the nurtured character can obtain the factor gained through the successful lottery.

However, the factor obtained by the nurtured character does not affect the abilities of the nurtured character themselves. For example, the nurtured character can be made to enter a racing game such as a team competition game. At this time, in the race, a simulation, that is, computational processing of determining the placing and the race developments is performed based on the ability parameters, the aptitude parameters, the acquired skills, and the like of all the nurtured characters running. Since the factor of the nurtured character is not used in the computational processing, even if the nurtured character has a large number of factors, the nurtured character is not given an advantage in the race.

When the nurtured character is set as the inheritance character, the factor of the nurtured character affects only the nurture target character. Factors that can be obtained by the nurtured character are classified into a plurality of types. Basic ability factor, aptitude factor, race factor, character factor, and skill factor as factor types in FIG. 11. Each factor is set to one of a plurality of stages. Here, three stages of factor levels, level 1, level 2, and level 3, are provided as stages for the factor.

The factor level is determined through a lottery. At this time, after the factors to be obtained by the nurtured character are determined, the factor level may be determined through the lottery for each of the obtained factors. Alternatively, a success ratio may be set for each combination pattern of a factor and a factor level, and any combination pattern may be determined based on the set success ratio. In this case, the factor to be obtained and the factor level are determined at the same time.

For factor levels, level 3 has the largest effect and level 1 has the least effect. In the lottery for determining the factor level, the success probability of level 3 is set to be the lowest and the success probability of level 1 is set to be the highest. However, the success probability of the factor to be obtained or the success probability of the factor level may be changed depending on the result of the nurture game. In this case, for example, a higher factor level may be determined for a nurtured character that has a higher ability parameter or evaluation score.

The basic ability factor increases the value of the ability parameter for the nurture target character and the upper limit value of the ability parameter. Five basic ability factors are provided including a speed factor, a stamina factor, a power factor, a spirit factor, and a wisdom factor. The nurtured character always obtains one basic ability factor from among five basic ability factors. The five basic ability factors correspond to five ability parameters of speed, stamina, power, spirit, and wisdom. For example, when the nurtured character of the first inheritance generation or the second inheritance generation has a speed factor, the value and upper limit value of the ability parameter of speed for the nurture target character increase.

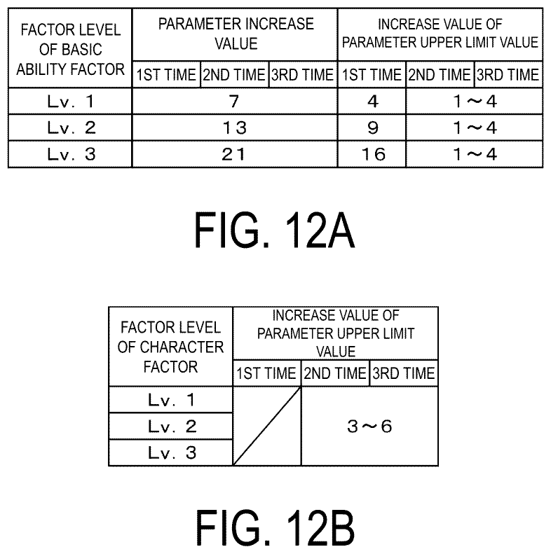

FIG. 12A is a diagram for describing the effectiveness of the basic ability factor. An increase value of each ability parameter and an increase value of the upper limit value vary depending on the factor level of the basic ability factor. For example, when the factor level of the speed factor is level 1, the ability parameter of speed for the nurture target character increases by “7”; when the factor level is level 2, the ability parameter increases by “13”; and when the factor level is level 3, the ability parameter increases by “21”.

Thus, if a total of six nurtured characters including two nurtured characters of the first inheritance generation and four nurtured characters of the second inheritance generation all have the speed factor of level 3, the ability parameter of speed for the nurture target character increases by up to 126 (increase value of 21×6 (characters)).

However, an activation timing and an activation condition are set for each factor. Thus, even if the inheritance character has a factor, if the activation condition is not met at the activation timing, there is no effectiveness on the nurture target character.

As described above, the nurture main game includes a plurality of turns, and of these, a predetermined turn is set as a factor activation turn. For example, assume that three turns, namely the first turn, the 31st turn, and the 55th turn of the nurture main game are set as factor activation turns. In this case, the first turn is the first activation timing, the 31st turn is the second activation timing, and the 55th turn is the third activation timing. In each of the factor activation turns, whether to activate each factor (inheritance character) is determined, and in a case where the factor is determined to be activated, the activation condition of the factor is met, and an effectiveness corresponding to the factor is achieved.

Whether to activate the basic ability factor is determined through a lottery. At this time, a probability of being successful at a lottery as to whether to activate the basic ability factor, that is, a probability of activating the basic ability factor (hereinafter referred to as an activation probability) may be different in the three factor activation turns. Here, in the first turn, the activation probability of the basic ability factor is set to 100% regardless of the factor level. Also, in the 31st turn and the 55th turn, the activation probability of the basic ability factor varies depending on the factor level. As an example, in the 31st turn and the 55th turn, the activation probability of the basic ability factor of level 3 is set to 100%, the activation probability of the basic ability factor of level 2 is set to 90%, and the activation probability of the basic ability factor of level 1 is set to 80%.

On the inheritance character selection screen 170, an increase value that increases in the first turn is displayed for the ability parameter. For example, in FIG. 9C, one inheritance character included in the first inheritance group is provisionally selected. In this case, displayed are the type of the ability parameter to be increased by the one provisionally selected inheritance character in the first turn and the increase value thereof. Here, “+63” is displayed over the ability parameter of power, which indicates that the ability parameter of power increases by 63 points in the first turn. Further, in the ability parameter display portion 152a, the value to which the increase value increased in the first turn is added is displayed.

Further, in FIG. 9D, two inheritance characters included in the first inheritance group and the second inheritance group are provisionally selected. In this case, displayed are the types of the ability parameters to be increased by the two provisionally selected inheritance characters in the first turn and the increase values thereof. Here, “+21”, “+63”, and “+42” are displayed over the ability parameters of speed, power, and wisdom, respectively, which indicate that the ability parameters of speed, power, and wisdom increase by 21 points, 63 points, and 42 points, respectively, in the first turn.

Note that in the inheritance character selection screen 170, the increase value of the ability parameter to be increased by the inheritance character included in the first inheritance group and the increase value of the ability parameter to be increased by the inheritance character included in the second inheritance group are distinguishably displayed. For example, in FIG. 9D, the indication of “+63” displayed over the ability parameter of power is different in color from the indications of “+21” and “+42” displayed over the ability parameters of speed and wisdom are displayed.

When the basic ability factor is activated, the upper limit value of the corresponding ability parameter increases. At this time, the increase value of the upper limit value of the ability parameter varies depending on the factor level of the basic ability factor. The increase value of the upper limit value of the ability parameter also varies depending on the activation timing. For example, when the factor level of the speed factor is level 1, the upper limit value of the ability parameter of speed for the nurture target character is increased by “4” at the first activation timing, and the upper limit value of the ability parameter of speed is increased in a range of “1” to “4” at the second and third activation timings.

Further, when the factor level of the speed factor is level 2, the upper limit value of the ability parameter of speed for the nurture target character is increased by “9” at the first activation timing, and the upper limit value of the ability parameter of speed is increased in a range of “1” to “4” at the second and third activation timings. Further, when the factor level of the speed factor is level 3, the upper limit value of the ability parameter of speed for the nurture target character is increased by “16” at the first activation timing, and the upper limit value of the ability parameter of speed is increased in a range of “1” to “4” at the second and third activation timings.

Note that here, at the first activation timing, the upper limit value of the ability parameter is always increased by the increase value corresponding to the factor level. On the other hand, at the second and third activation timings, a lottery is performed to determine whether to activate the factor. Then, when the activation is determined, a lottery for determining the increase value of the upper limit value is performed. At this time, the higher the factor level, the higher the probability may be set that the activation is determined. Further, the higher the factor level, the higher the increase value of the upper limit value may be configured to be.

Whether to activate the basic ability factor may be determined per factor or may be determined for each effectiveness separately. For example, assume that in a case where whether to activate one basic ability factor is determined per factor, this basic ability factor is determined to be activated. In this case, the value of the corresponding ability parameter is increased and the upper limit value of the same ability parameter is increase depending on the factor level.

On the other hand, in a case where whether to activate one basic ability factor is determined for each effectiveness, the determination on whether to increase the value of the ability parameter and the determination on whether to increase the upper limit value are made by separate lotteries. Therefore, in this case, for example, only one of the value of the ability parameter and the upper limit value of the ability parameter may be increased. In any case, in the present embodiment, the basic ability factor is always activated at the first activation timing. Thus, the value of the ability parameter and the upper limit value are increased depending on the factor level as the nurture main game is started.

As illustrated in the FIGS. 9C and 9D, the initial upper limit value of the ability parameter displayed in the ability parameter display portion 152a on the inheritance character selection screen 170 is updated to a value to which an additional value of the upper limit value increased depending on the basic ability factor has been added. In this way, the initial upper limit value to which the scenario initial additional value and the additional value depending on the basic ability factor have been added is displayed, thereby improving convenience when selecting the inheritance character.

The aptitude factor illustrated in FIG. 11 increases the aptitude parameter for the nurture target character. The aptitude factors include six factors: a turf factor, a dirt factor, a short distance factor, a mile factor, a medium distance factor, and a long distance factor. The nurtured character always obtains one aptitude factor from among the six aptitude factors. The six aptitude factors respectively correspond to the turf aptitude, the dirt aptitude, the short distance aptitude, the mile aptitude, the medium distance aptitude, and the long distance aptitude. For example, when the nurtured character of the first inheritance generation or the second inheritance generation includes a nurtured character having a turf factor, the aptitude parameter of the turf aptitude for the nurture target character increases.

The activation timing and the activation condition are also set for the aptitude factor, and whether to activate is determined for each aptitude factor in the same factor activation turn as that of the basic ability factor. If activation of the aptitude factor is determined, the corresponding aptitude parameter increase by one stage. In this example, in the first turn, the activation probability of the aptitude factor is set to 100% regardless of the factor level.

For example, assume that the aptitude factors of three nurtured characters belonging to the first inheritance group are the turf factor, the short distance factor, and the mile factor; and the aptitude factors of three nurtured characters belonging to the second inheritance group are the turf factor, the short distance factor, and the medium distance factor. In this case, the turf aptitude and the short distance aptitude of the nurture target character are each increased by two stages, and the mile aptitude and the medium distance aptitude are each increased by one stage.

Further, for example, assume that the aptitude factors of the three nurtured characters belonging to the first inheritance group are all the turf factor, and the aptitude factors of the three nurtured characters belonging to the second inheritance group are all the short distance factors. In this case, the turf aptitude and the short distance aptitude of the nurture target character each increase by three stages. In another example, assume that the aptitude factors of the three nurtured characters belonging to the first inheritance group are all the turf factor, and the aptitude factors of the three nurtured characters belonging to the second inheritance group are the turf factor, the short distance factor, and the mile factor. In this case, the turf aptitude of the nurture target character increases by four stages, and the short distance aptitude and the mile aptitude each increase by one stage.

However, for the first turn, a limit is placed on the increase value of the aptitude parameter. Specifically, in the first turn, the upper limits of all the aptitude parameters are set to A. Thus, if the initial value of the turf aptitude of the nurture target character is A, the turf aptitude does not increase in the first turn even if the inheritance character has the turf factor.

On the other hand, in the 31st turn and the 55th turn, a lottery is performed to determine whether to activate each aptitude factor based on the factor level thereof. As an example, in the 31st turn and the 55th turn, the activation probability of the aptitude factor of level 3 is set to 5%, the activation probability of the aptitude factor of level 2 is set to 3%, and the activation probability of the aptitude factor of level 1 is set to 1%. In the 31st turn or the 55th turn, when the activation of the aptitude factor is determined through a lottery, the aptitude parameter corresponding to the aptitude factor increases. In the 31st turn and the 55th turn, the upper limit of each aptitude is raised from A to S. Thus, in the 31st turn and the 55th turn, the value of the aptitude parameter can be increased to S by activation of the aptitude factor.

The value of the aptitude parameter increased in the first turn is displayed in the aptitude parameter display portion 152b on the inheritance character selection screen 170.

The race factor increases the ability parameter for the nurture target character. The race factor is provided for each race with a high difficulty (hereinafter referred to as a factor target race), such as GI races, from among the races that can be entered in the nurture main game. When the nurture game is completed, a lottery to determine whether a race factor is obtained is performed for each factor target race in which the nurture target character comes in first place. The nurtured character can obtain a race factor via a successful lottery.

Note that the race factor is provided with factor levels, and the factor level is determined through a lottery for each race factor determined to be obtained. Here, there is no upper limit to the number of race factors that can be obtained by one nurtured character, and the nurtured character can obtain a plurality of race factors.

For each race factor, an ability parameter to be increased by activation and an increase value thereof are set in advance. For example, the race factors may include a factor to increase the ability parameter of speed and a factor to increase the ability parameter of power. At this time, the higher the factor level, the higher the increase value of the ability parameter.

In addition, the activation timing and the activation condition are also set for the race factor, and whether to activate each race factor is determined in the factor activation turn. If activation of a race factor is determined, the ability parameter corresponding to the race factor increases. The factor activation turns of the race factor are limited to the 31st turn and the 55th turn. In addition, the activation probability of the race factor in the factor activation turn varies depending on the factor level, and the higher the factor level, the higher the activation probability.

The character factor is a factor specific to the character, and for example, only when a character strengthened to a predetermined level is nurtured as a nurture target character, the character factor set for the character is always given to the nurtured character at the completion of the nurture game. Since only one character factor is set for one character, the maximum number of character factors that one nurtured character can obtain is one. When a nurtured character based on a character that is not strengthened to a predetermined level is produced, a character factor cannot be obtained.

The character factor can be activated in a factor activation turn set in advance and is activated by a successful lottery executed in the factor activation turn. When a character factor is activated, a hint event set for each character factor occurs, and a skill hint can be obtained as described above. When the character factor is activated, the upper limit value of the predetermined ability parameter increases.

FIG. 12B is a diagram for describing an effectiveness of a character factor. The increase in the upper limit value of the ability parameter by the character factor is limited to at the second and third activation timings. However, the character factor may be activated at the first activation timing. When the character factor is activated at the first activation timing, the nurture target character acquires a hint of the skill as described above, but the upper limit value of the ability parameter does not increase.

When the character factor is activated at the second or third activation timing, the upper limit value of the ability parameter increases in addition to the hint of the skill being acquired. Here, the upper limit value of the ability parameter increases within a range of “3” to “6” regardless of the factor level. Note that the increase value of the upper limit value is determined by, for example, through a lottery. At this time, the higher the factor level, the higher the increase value may be configured to be.

In the present embodiment, the ability parameter of which the upper limit value is increased by the activation of the character factor is set in advance for each character factor. For example, for a character factor A, the upper limit value of stamina is increased in a range of “3” to “6”, and for a character factor B, the upper limit value of speed is increased by “1” and the upper limit value of spirit is increased by “2”, or the upper limit value of speed is increased by “2” and the upper limit value of spirit is increased by “2”. Note that whether to activate the character factor may be determined per factor or may be determined for each effectiveness separately similar to the basic ability factor.

The skill factor illustrated inf FIG. 11 is given based on the acquired skill acquired by the nurtured character. Specifically, at the completion of the nurture game, a lottery is performed for whether to acquire a skill factor for each acquired skill acquired by the nurtured character. By being successful in the lottery, a skill factor is given to the nurtured character. In other words, the nurtured character can obtain some or all of the skill factors corresponding to acquired skills that have been already acquired. When it is determined to obtain a skill factor, the factor level of the skill factor is determined through a lottery.

The skill factor can be activated in a factor activation turn set in advance and is activated by a successful lottery executed in the factor activation turn. At this time, the higher the factor level, the higher the success probability. When a skill factor is activated, a hint event set for each skill factor occurs, and a skill hint can be obtained. Thus, the nurture target character can acquire a skill the same as the acquired skill having acquired by the inheritance character or the like.

As described above, whether to acquire the skill factor is determined within a range of the acquired skill acquired by the nurtured character. Thus, the nurtured character having more acquired skills obtains the skill factor with the higher possibility. However, since whether to obtain the skill factor is determined through a lottery, the nurtured character even having many acquired skills may not obtain the skill factor.

Note that although the nurtured character obtains the skill factor separately from the acquired skill, the skill that can be acquired by the nurture target character may be determined based on the acquired skill of the nurtured character as the inheritance character without providing the skill factor.

As described above, the ability parameter for the nurture target character greatly varies depending on the inheritance character to form the deck. In addition, even if the ability of the nurtured character itself is high, since whether to obtain the factor is determined through a lottery, the nurtured character with higher ability does not necessarily correspond to the inheritance character. On the other hand, even when the ability of the nurtured character itself is not high, the nurtured character may effectively function as an inheritance character by obtaining a large number of factors having a high factor level. In this manner, making it possible to form a deck using the inheritance characters provides the interest in not only simply nurturing a strong nurtured character but also nurturing a nurtured character that is effective as an inheritance character.

Furthermore, in the present embodiment, the compatibility is determined between the nurture target character, the nurtured character of the first inheritance generation, and the nurtured character of the second inheritance generation. Then, in the case of a combination of characters having good compatibility, an advantageous factor activation condition is achieved.

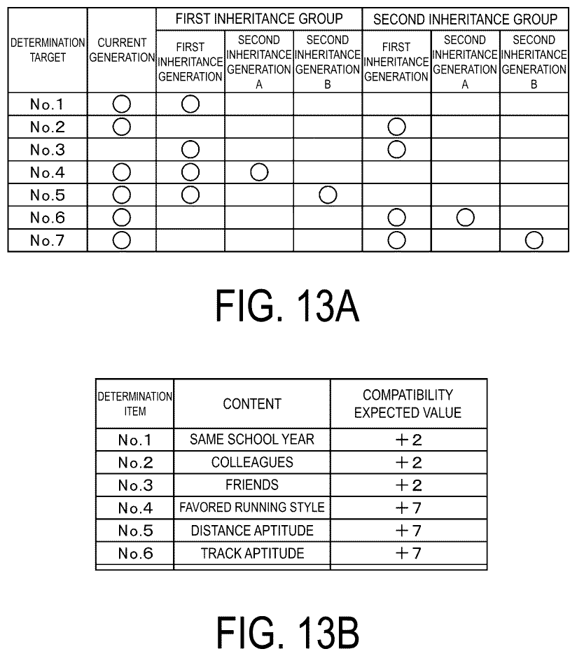

FIG. 13A is a diagram for describing a determination target for compatibility, and FIG. 13B is a diagram for describing a determination item for compatibility. As illustrated in FIG. 13A, in the present embodiment, seven determination targets of No. 1 to No. 7 are provided. A first determination target (No. 1) is the nurture target character of the current generation and the nurtured character of the first inheritance generation in the first inheritance group. A second determination target (No. 2) is the nurture target character of the current generation and the nurtured character of the first inheritance generation in the second inheritance group.

A third determination target (No. 3) is the nurtured character of the first inheritance generation in the first inheritance group and the nurtured character of the first inheritance generation in the second inheritance group. A fourth determination target (No. 4) is the nurture target character of the current generation, the nurtured character of the first inheritance generation in the first inheritance group, and one of the nurtured characters (nurtured character A) of the second inheritance generation in the first inheritance group. A fifth determination target (No. 5) is the nurture target character of the current generation, the nurtured character of the first inheritance generation in the first inheritance group, and the other nurtured character (nurtured character B) of the second inheritance generation in the first inheritance group.

A sixth determination target (No. 6) is the nurture target character of the current generation, the nurtured character of the first inheritance generation in the second inheritance group, and one of the nurtured characters (nurtured character A) of the second inheritance generation in the second inheritance group. A seventh determination target (No. 7) is the nurture target character of the current generation, the nurtured character of the first inheritance generation in the second inheritance group, and the other nurtured character (nurtured character B) of the second inheritance generation in the second inheritance group.

For each determination target, whether the condition is met is determined for each one of a plurality of determination items. Example of the determination items are illustrated in FIG. 13B. In the present embodiment, a world view of the game is set such that characters that can be selected as nurture target characters are students and each character performs training in a school.

As illustrated in FIG. 13B, settings including school years, colleagues, and friends are set in advance for each character. The determination items include, for example, whether the two or three characters as the determination targets are in the same school year, are colleagues, or are friends. In addition, the determination items include whether the running style, the distance aptitude, and the track aptitude that the character as the determination target favors.

Each determination item is associated with a compatibility expected value, and the compatibility expected values of the determination items established between the characters as the determination targets are accumulated. Here, the compatibility expected value varies depending on the determination item, but the compatibility expected value may be common to all the determination items.

For example, in the case of determining the compatibility, first, whether all determination items are established is determined between the nurture target character of the current generation which is the first determination target and the nurtured character of the first inheritance generation of the first inheritance group. At this time, the compatibility expected values associated with the established determination items are accumulated and counted. As described above, the calculation of the compatibility expected value is sequentially performed from the first determination target to the seventh determination target, and the activation probability of the factor is corrected based on the finally calculated compatibility expected value. That is, the higher the compatibility expected value, the higher the activation probability of all the factors, and the lower the compatibility expected value, the lower the activation probability of all the factors.

The activation probability may be calculated by using the calculated compatibility expected value as a correction value. For example, a correction value for correcting the activation probability of the factor may be set for each compatibility level, and the compatibility level may be determined based on the calculated compatibility expected value.

As described above, since the activation probability of the factor varies depending on the compatibility between the nurture target character and the inheritance character or the compatibility between the inheritance characters, the combination of the two inheritance characters greatly affects the nurturing of the nurture target character. In other words, the compatibility between characters is an important criterion for selecting an inheritance character.

As illustrated in FIGS. 9B, 9C, and 9D, in a state in which the inheritance character is selected, a compatibility mark indicating how a compatibility is good is displayed in an upper right portion of each of the inheritance character selection screen 170 and the nurtured character list screen 180. Here, the compatibility level of the selected characters is indicated by three compatibility marks: double circle (very good), circle (good), and triangle (so so). As illustrated in FIG. 9A, the compatibility mark is not displayed in a state in which an inheritance character is not selected.

As illustrated in FIG. 9B, a switch display button 183 is provided on the nurtured character list screen 180. When the switch display button 183 is operated, a display condition setting screen (not illustrated) is displayed. On the display condition setting screen, the player can rearrange or filter the nurtured character icons 182 displayed on the nurtured character list screen 180, that is, the nurtured characters selectable as inheritance characters.

### Registration of Support Card

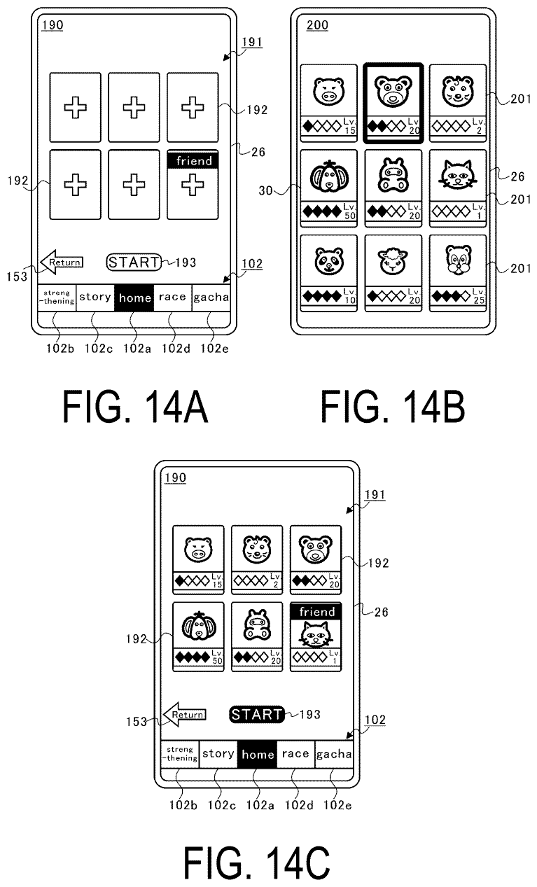

FIG. 14A is a first diagram for describing the support card organization screen 190. When two inheritance characters are registered on the inheritance character selection screen 170, the support card organization screen 190 illustrated in FIG. 14A is displayed. A support card display region 191 is provided at a central portion on the support card organization screen 190. The support card display region 191 includes a plurality of support card display frames 192. In addition, the return operation portion 153 and a start operation portion 193 are displayed in a lower portion on the support card organization screen 190.

In the support card display region 191, a plurality of (here, six) support card display frames 192 are displayed. The number of support card display frames 192 displayed is the same as the number of support cards that can be set by the player. When the support card organization screen 190 is first displayed, the support card display frames 192 are blank.

In the present embodiment, the player can set six types of support cards in the deck. Some (for example, five types) of the six types of support cards that can be set by the player can be selected from among the support cards possessed by the player. In addition, the remaining (for example, one type) of the six types of support cards that can be set by the player can be selected from support cards set as rental cards by other players such as friends.

FIG. 14B is a diagram for describing a support card selection screen 200. When the support card display frame 192 (excluding the support card display frame 192 displayed in a lower right portion) is tapped on the support card organization screen 190 of FIG. 14A, the support card selection screen 200 illustrated in FIG. 14B is displayed on the display 26. The support card selection screen 200 displays a list of card icons 201 corresponding to the support cards possessed by the player. By tapping the card icon 201 displayed on the support card selection screen 200, the player can select a support card.

Although not illustrated, when the support card display frame 192 displayed at the lower right of the support card organization screen 190 is tapped, a support card set as a rental card by a friend or a player extracted based on a predetermined condition such as a lottery is displayed on the support card selection screen 200. At this time, the player can select one support card of a friend by tapping a support card displayed on the support card selection screen 200. In this manner, the player can use a support card possessed by another player in the nurture game.

That is, the support card is always associated with one character ID. The character card is also always associated with one character ID. Note that each character card is associated with a unique character card ID. Each support card is associated with a unique support card ID. The character card ID and the support card ID are identification information provided separately from the character ID, and are for identifying the type of the card. In the preparation stage processing, the player needs to select a character card (character card ID), that is, a nurture target character, and then select a support card (support card ID). In the present embodiment, duplication of the character IDs associated with the character card and the support card is not allowed. Therefore, the player has to select six support cards associated with different character IDs.

In addition, the player has to select a support card associated with a character ID different from the character ID associated with the previously selected character card. Therefore, on the support card selection screen 200, the support card associated with the same character ID as that of the previously selected character card is displayed to be distinguished. Examples of displaying the support card to be distinguished include gray-out display, superimposed display of an icon indicating non-selectability, and the like.

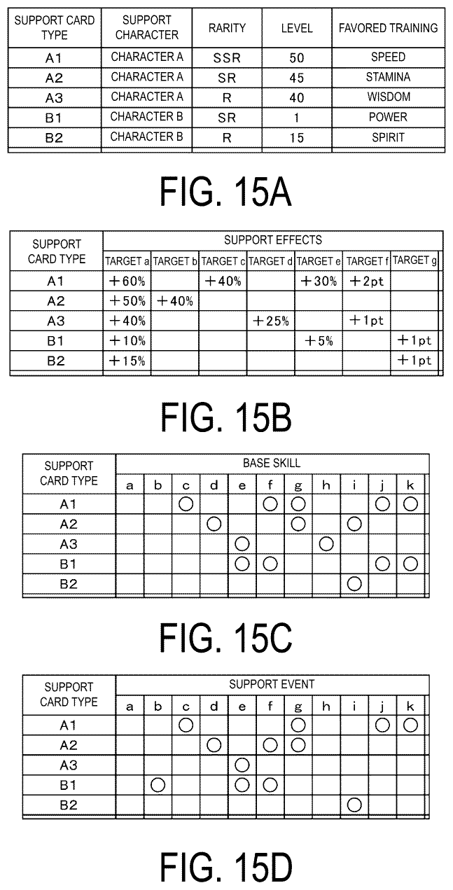

FIG. 15A is a diagram for describing a support card table. As illustrated in FIG. 15A, the support card table stores the type of support character (that is, a character ID), rarity, level, and favored training for each type of support card possessed by the player (that is, support card ID). The support characters are in one to-one correspondence with the types of support cards. That is, one character ID is always associated with a support card ID. In other words, one support card is always associated with one support character.

In the present embodiment, a rarity is set for each support card. The rarity has three stages: R (rare), SR (super rare), and SSR (super special rare). R is set to the lowest rarity and SSR is set to the highest rarity. In the present embodiment, a support card having a higher rarity tends to have a higher support effect to be described below. In the present embodiment, the number of base skills and the number of support events to be described below tend to increase as the rarity of a support card increases.

For the levels of the support card, 50 stages of level 1 to level 50 are provided. The level of the support card can be increased by the player, and the level increased by the player is stored for each support card. The level of the support card can be increased by using in-game currency, an item, or the like. The level of the support card has an upper limit depending on rarity.

For example, level 20 is defined as the upper limit for a support card with a rarity of R, level 25 is defined as the upper limit for a support card with a rarity of SR, and level 30 is defined as the upper limit for a support card with a rarity of SSR.

The upper limit of the level can be raised incrementally when a predetermined condition is met. For example, a support card with a rarity of R may have its upper limit raised to level 40, a support card with a rarity of SR may have its upper limit raised to level 45, and a support card with a rarity of SSR may have its upper limit raised to level 50.

FIG. 15B is a diagram for describing support effects. As illustrated in FIG. 15B, a plurality of support effects are stored in each support card. The support effects increase various stats in the nurture main game. A support card has support effects for a plurality of targets. Examples of the support effect targets include energy, speed, stamina, power, spirit, and wisdom.

FIG. 15C is a diagram for describing the base skills. As illustrated in FIG. 15C, a plurality of base skills are set in each support card. In the present embodiment, the base skills are associated with the support card as each character possesses the base skills. The base skill set for each support card can be obtained by the nurture target character selected by the player when a hint event occurs during the nurture main game.

FIG. 15D is a diagram for describing support events. As illustrated in FIG. 15D, each support card is associated with a plurality of support events. A support event is an event that may occur during the nurture main game. When a support event occurs, the values of various stats in the nurture main game may increase or decrease.

For example, a support event that occurs according to the turn number, or a support event that occurs according to a predetermined lottery may be determined. A plurality of support events to occur may be selected in one turn. In any case, the support event to occur may be determined according to a predetermined determination method set in advance.

Note that the support events may include a hint event and an ability event. The hint event may include a first hint event that may occur upon starting of a turn in the nurture game, a second hint event that may occur after training is performed in the nurture game which will be described below. The ability event may include a first ability event that may occur upon starting of a turn in the nurture game and a second ability event that may occur after training in the nurture game is performed.

The first hint event and the second hint event are events that make it possible to possess or obtain a skill. Further, the first ability event and the second ability event are events for increasing or decreasing the numerical value of an ability parameter for the character. Hereinafter, the first hint event and the first ability event are collectively referred to as a first event, and the second hint event and the second ability event are collectively referred to as a second event.

FIG. 14C is a second diagram for describing the support card organization screen 190. In the present embodiment, when all six support cards are selected, the start operation portion 193 becomes operable as illustrated in FIG. 14C. On the other hand, when all the six support cards are not selected, the start operation portion 193 cannot be operated as illustrated in FIG. 14A.

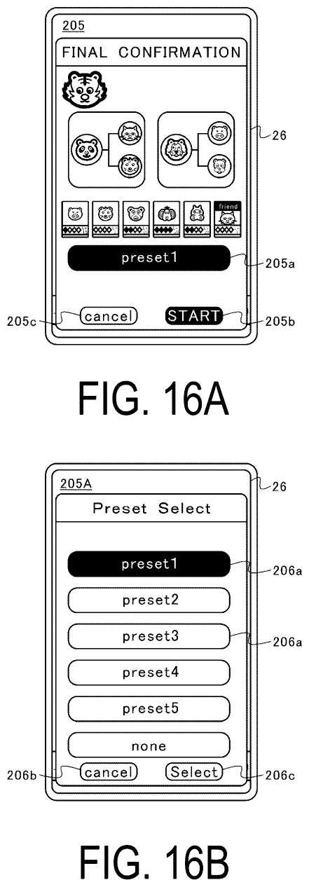

When the return operation portion 153 is operated on the support card organization screen 190, the inheritance character selection screen 170 illustrated in FIG. 9D is displayed on the display 26. Further, as illustrated in FIG. 14C, when the start operation portion 193 is tapped on the support card organization screen 190, the selected support card is provisionally registered, and a final confirmation screen 205 illustrated in FIG. 16A is displayed.

FIG. 16A is a diagram for describing the final confirmation screen 205. FIG. 16B is a diagram for describing a preset selection screen 205A. On the final confirmation screen 205, the nurture target character selected by the player, the nurtured character included in the first inheritance group, the nurtured character included in the second inheritance group, and the support cards are displayed. Further, a preset display portion 205a is displayed on the final confirmation screen 205. In the preset display portion 205a, the number of the preset currently selected is indicated.

Here, the preset is reservation information of a race which the nurture target character is made to enter in the nurture main game. The player can select any race from all the races to create a preset. A plurality of presets can be saved, and one preset can be selected from the saved presets on the final confirmation screen 205. To be more specific, when the preset display portion 205a is tapped, the preset selection screen 205A illustrated in FIG. 16B is displayed.

On the preset selection screen 205A, preset read buttons 206a corresponding to the saved presets are displayed. The player can set a preset by tapping any of the preset read buttons 206a and then tapping a select operation portion 206c. When the select operation portion 206c is tapped, the preset selection screen 205A is closed, and the final confirmation screen 205 is displayed. When a cancel operation portion 206b of the preset selection screen 205A is tapped, the preset selection screen 205A is displayed without changing the preset.

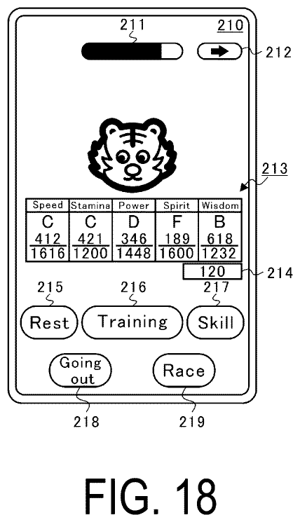

When a cancel operation portion 205c is tapped on the final confirmation screen 205, the support card organization screen 190 is displayed. On the other hand, when a start operation portion 205b is tapped, a top screen 210 (FIG. 18A) is displayed on the display 26.

### Registration of Specific Character

As illustrated in FIG. 4, after the scenario, the nurture target character, the inheritance character, and the support card are registered, the specific character is registered. The specific character is predefined for each scenario, and a character corresponding to a scenario selected by the player is set as the specific character.

As described above, when the nurture target character, the inheritance character, the support character (support card), and the specific character are registered, the preparation stage processing ends.

### Nurture Stage Processing

When the preparation stage processing ends, the nurture stage processing is started. Via the nurture stage processing, the nurture main game in which the nurture target character can be nurtured progresses. Hereinafter, in order to facilitate understanding, first, a basic flow of the nurture main game will be described.

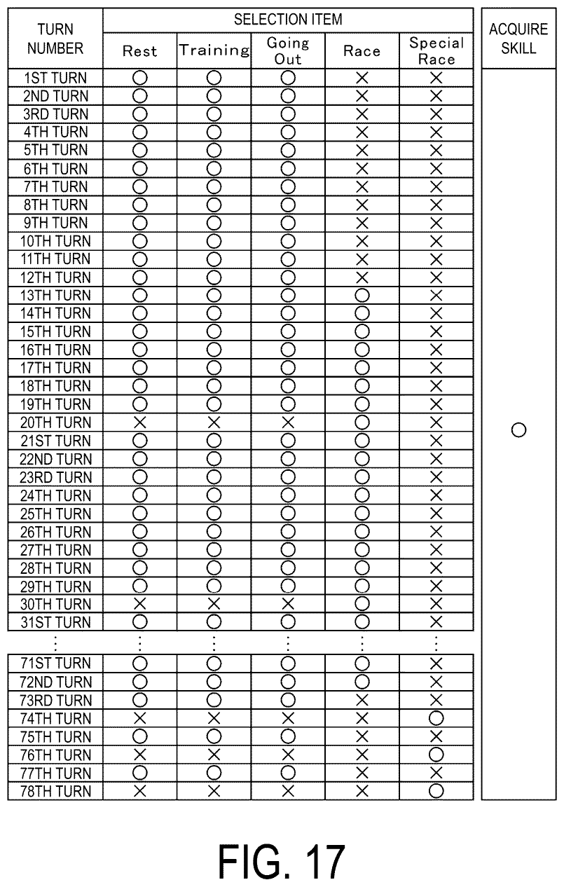

FIG. 17 is a diagram for describing selection items in each turn. Note that here, the selection items that can be selected in each turn vary depending on the type of the nurture target character. However, the selection items that can be selected in each turn may be common regardless of the type of the nurture target character. As illustrated in FIG. 17, the nurture main game includes the first turn to the 78th turn. Various parameters are updated in accordance with the selection item selected by the player in each turn.

FIG. 18 is a diagram for describing the top screen 210. In the nurture stage processing, the top screen 210 illustrated in FIG. 18 is displayed on the display 26. In an upper portion on the top screen 210, an energy display portion 211 and a mood display portion 212 are displayed. The nurture target character is provided with an “energy” parameter. The “energy” parameter is mainly used for calculation of a failure rate which is a probability of failure in training described below. The energy display portion 211 is displayed so that the current remaining amount of the “energy” of the nurture target character can be visually recognized with respect to the upper limit value of the “energy”.

The nurture target character is provided with a “mood” parameter. The mood display portion 212 displays the current “mood” of the nurture target character using a plurality of stages (five stages including very bad, bad, normal, good, and very good) so that the user can visually recognize the mood. With better “mood”, race developments become more advantageous for the nurture target character and the increase value of ability parameters in training are increased.

As illustrated in FIG. 18, an image of the nurture target character, a stats display portion 213, and a skill point display portion 214 are displayed at a central portion on the top screen 210. In the stats display portion 213, current stats of the nurture target character are displayed by a numerical value and an alphabet indicating a rank divided according to the numerical value. Specifically, in the present embodiment, the numerical values and ranks of the ability parameters of speed, stamina, power, spirit, and wisdom are displayed. In the skill point display portion 214, the skill point possessed by the nurture target character is indicated in a numerical value.

As illustrated in FIG. 18, in a lower portion on the top screen 210, a rest operation portion 215, a training operation portion 216, a skill operation portion 217, a going out operation portion 218, and a race operation portion 219 are displayed. The current number of turns is displayed in the upper left portion on the top screen 210.

In each turn, the player can select one of the rest operation portion 215, the training operation portion 216, the going out operation portion 218, and the race operation portion 219.

The player can select a selection item “rest” by operating the rest operation portion 215. When “rest” is selected, the energy of the nurture target character is recovered. Further, the player can select a training to be performed by the nurture target character by operating the training operation portion 216.

The player can select a selection item “going out” by operating the going out operation portion 218. When “going out” is selected, the mood of the nurture target character increases. The player can select a type of a race which the nurture target character is made to enter by operating the race operation portion 219.

When the nurture target character performs any one of the rest, the training, the going out, and the race, the current turn is finished, and the process proceeds to the next turn.

Note that in the present embodiment, a race-only turn in which each item of the rest operation portion 215, the training operation portion 216, and the going out operation portion 218 is not selectable is set for each character. In the race-only turn, the rest operation portion 215, the training operation portion 216, and the going out operation portion 218 are grayed out, and the operation by the player is not accepted.

Therefore, in the race-only turn, the player has to operate the race operation portion 219 to make the nurture target character enter the race. Specifically, the 13th turn to the 72nd turn are provided with the race-only turn set for each character. FIG. 17 illustrates a case where the 20th turn and the 30th turn are race-only turns. Note that as illustrated in FIG. 17, the 74th turn, the 76th turn, and the 78th turn are set as the race-only turns in common to all the characters although detailed description is omitted. In these three turns, the player needs to make the nurture target character enter a particular race.

The skill operation portion 217 is set to be always selectable in all turns. Note that even if the skill is acquired, the turn is not finished although details will be described later.

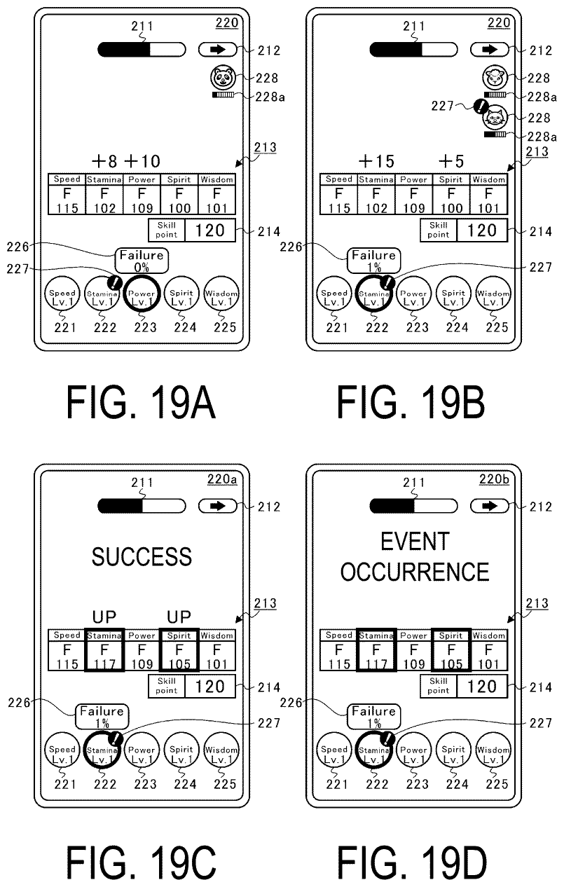

FIG. 19A is a first diagram for describing a training screen 220. FIG. 19B is a second diagram for describing the training screen 220. When the training operation portion 216 on the top screen 210 is operated, the training screen 220 is displayed on the display 26.

As illustrated in FIG. 19A, training items are displayed in a lower portion on the training screen 220. Here, a speed operation portion 221, a stamina operation portion 222, a power operation portion 223, a spirit operation portion 224, and a wisdom operation portion 225 are displayed.

When the player operates one of the operation portions 221 to 225, the training item corresponding to the one of the operation portions 221 to 225 to which that operation input is given is put in a provisionally selected state. At this time, the one of the operation portions 221 to 225 corresponding to the training item in the provisionally selected state is highlighted. FIG. 19A illustrates a state in which the power operation portion 223 is provisionally selected. FIG. 19B illustrates a state in which the stamina operation portion 222 is provisionally selected.

When an operation input is again given to the speed operation portion 221 in the provisionally selected state, training for speed is performed. Similarly, when an operation input is again given to the stamina operation portion 222, the power operation portion 223, the spirit operation portion 224, or the wisdom operation portion 225 in the provisionally selected state, training for stamina, power, spirit, or wisdom is performed, respectively.

In addition, a training level for each training item is also displayed together with each of the operation portions 221 to 225. The training level is a parameter increasing based on the number of times of training, and the higher the training level, the larger the increase value of the ability parameter when the training is performed. The training level is initially set to level 1 and is increased up to level 5.

In addition, a failure rate display portion 226 is displayed at each of the operation portions 221 to 225 in the provisionally selected state. The failure rate displayed using a numerical value in the failure rate display portion 226 is configured to increase in inverse proportion to the remaining energy displayed in the energy display portion 211.

Further, at the stats display portion 213, the increase value of the ability parameter in a case where the training corresponding any of to the operation portions 221 to 225 in the provisionally selected state is successful is displayed. For example, in the example illustrated in FIG. 19A, the power operation portion 223 is provisionally selected, and “+8” is displayed at a field of stamina and “+10” is displayed at a field of power of the stats display portion 213. In the example illustrated in FIG. 19B, the stamina operation portion 222 is provisionally selected, and “+15” is displayed at a field of stamina and “+5” is displayed at a field of spirit of the stats display portion 213.

In addition, when the training is performed and is successful, a predetermined event may occur. In this case, an event notification display 227 is displayed at any of the operation portions 221 to 225 corresponding to the training item for which the predetermined event occurs. Note that the event notification display 227 may have different display modes depending on the type of the event.

In a turn in which training can be performed, a character may be arranged for each training item. The character arranged for the training item is the support character or the specific character described above, or a story character set separately from these characters. In a turn in which training can be performed, whether to arrange a character for a training item and a training item for which the character is arranged are determined through a lottery for each character to be arranged for the training.

As illustrated in FIG. 19B, in an upper right portion on the training screen 220, an arranged character icon 228 is displayed corresponding to the character arranged for the training (hereinafter, referred to as the arranged character) for each of the operation portions 221 to 225 in the provisionally selected state. When the training is successful, a predetermined event associated with the arranged character may occur. In this case, the event notification display 227 is displayed at the corresponding arranged character icon 228.

When that training associated with the arranged character is successful, the increase value of the parameter for the nurture target character is higher compared to when the training not associated with the arranged character is successful. Note that hereinafter, the training for which the character is arranged is referred to as joint training.

In addition, a bond gauge 228a is displayed below the arranged character icon 228. The bond gauge 228a visually displays a bond parameter associated with the arranged character. When the training associated with the arranged character is successful, the bond parameter for the arranged character increases. The higher a value of the bond parameter, the larger the increase value of the ability parameter for the nurture target character when the training is successful.

In addition, when a support character having a bond parameter equal to or greater than a predetermined value is arranged for a predetermined training item, a friendship training occurrence possible state is set for the training item. When a training item for which the friendship training occurrence possible state is set is selected and the training is successful, friendship training occurs. In other words, when training in the friendship training occurrence possible state is successful, the normal joint training is upgraded to a friendship training. In the friendship training, the increase value of the ability parameter for the nurture target character is larger than that in the normal joint training.

Note that the support card (support character) is associated with any one of five training items of speed, stamina, power, spirit, and wisdom as the favored training. Here, the support character being arranged for the favored training and the bond parameter for the support character being equal to or greater than a predetermined value are set as the setting conditions for the friendship training occurrence possible state.

Therefore, when the support character having the bond parameter equal to or greater than a predetermined value is arranged for the favored training of the support character, the friendship training occurrence possible state is set for the training item. Then, the training item for which the friendship training occurrence possible state is set is selected and this training is successful, the ability parameter for the nurture target character is greatly increased compared to the normal joint training.

Note that the support cards (support characters) may include a support card (support character) not associated with the favored training. Then, the friendship training occurrence possible state may be set for the support card (support character) not associated with the favored training on condition that a bond parameter for the support character is equal to or greater than a predetermined value, regardless of the training item to be arranged. Alternatively, the friendship training occurrence possible state may not be set for the support card (support character) not associated with the favored training.

As described above, in the present embodiment, the bond parameter for the support character being equal to or greater than a predetermined value and the support character is arranged for the training item set in advance are set as the setting conditions for the friendship training occurrence possible state.

FIG. 19C is a diagram for describing a training result notification screen 220a. As described above, when an operation input is again given to any one of the operation portions 221 to 225 in the provisionally selected state, the training corresponding to the one of the operation portions 221 to 225 to which that operation input is given is performed. When the training is performed, the training result notification screen 220a is displayed on the display 26. An image for notifying of success or failure of the training is displayed on the training result notification screen 220a.

Although not illustrated, when the normal joint training is performed, an image for the nurture target character to perform the training is displayed on the training result notification screen 220a. The image displayed at this time is provided for each training item. In addition, the image corresponding to each training item is provided with a success pattern displayed in a case where the training is successful and a failure pattern displayed in a case where the training is failed.

When the training for which the friendship training occurrence possible state is set is successful, a friendship training-dedicated performance is performed. The friendship training-dedicated performance includes a performance in which a support character is displayed on the training result notification screen 220a. The support character displayed at this time is a character that satisfies the setting conditions for the friendship training occurrence possible state.

For example, assume that a character A which is a support character is arranged for the training item of speed. Assume that at this time, the bond parameter for the character A is equal to or greater than a predetermined value and the favored training of the character A (support card) is speed. In this case, the training item of speed is put in the friendship training occurrence possible state. Assume that the training item of speed is selected and the training of speed is successful in this state. In this case, an image including the character A is displayed on the training result notification screen 220a.

Note that in one turn, a plurality of support characters arranged for the same training item may satisfy the setting conditions for the friendship training occurrence possible state. For example, assume that four support characters of characters A, B, C, and D are arranged for the training item of stamina. Assume that at this time, all of the characters A, B, C, and D satisfy the setting conditions for the friendship training occurrence possible state. In this case, the friendship training-dedicated performance is performed in which the characters A, B, C, and D are displayed simultaneously or sequentially on the training result notification screen 220a.

Note that the friendship training-dedicated performance is content in which the character satisfying the setting conditions for the friendship training occurrence possible state and the nurture target character perform training together. Therefore, it can be said that the friendship training occurrence possible state is set for the support character in addition to the training item.

Although not illustrated, an effect is displayed to be superimposed on the arranged character icon 228 corresponding to the arranged character for which the friendship training occurrence possible state is set. This allows the player to distinguish which arranged character the friendship training occurs for. In addition, in a case where the friendship training occurrence possible state is set for any of the training items, the effect is also displayed to be superimposed on the training operation portion 216 on the top screen 210. Therefore, the player can also grasp that the friendship training occurrence possible state is set on the top screen 210.

The ability parameter in the stats display portion 213 is updated and displayed on the training result notification screen 220a. That is, the ability parameter for the nurture target character corresponding to the training item selected by the player is updated.

Here, the value of the ability parameter that increases when the training displayed in the stats display portion 213 in FIG. 19A or 19B is successful is added. In addition, the display of the energy display portion 211 is updated according to the performed training item. When any of the training of speed, stamina, power, or spirit is successful, the energy decreases. On the other hand, when the training of wisdom is successful, the energy is recovered.

When the training is failed, a predetermined penalty is given. Specifically, the content of the penalty may include a decrease in energy, a decrease in a numerical value of an ability parameter, a decrease in mood, and the like. Note that, for example, the penalty given when the failure rate is high may be more disadvantageous than the penalty given when the failure rate is low (for example, the numerical value of the decrease in energy is large, the numerical value of the decrease in the ability parameter is large, or the number of stages of the decrease in mood is large).

The content of the penalty may be determined in accordance with the training item. For example, the value of the ability parameter of speed may be decreased when the training of speed is failed, and the value of the ability parameter of power may be decreased when the training of power is failed. In addition, for some training items (for example, wisdom), even if training is failed, a penalty may not be given.

FIG. 19D is a diagram for describing an event screen 220b. When the display of the training result notification screen 220a ends, the event screen 220b may be displayed on the display 26. Various events are performed via the event screen 220b. Note that a plurality of events may occur during one turn.

For example, when a first hint event or a second hint event occurs, a skill hint may be obtained. When a skill hint is obtained, the player can acquire the skill by spending skill points. A plurality of types of skills are provided, and a predetermined ability may be activated for each skill. An activation condition and an effect are predefined for each skill, and when an activation condition is met, the predefined effect is activated. A skill may be activated while a race is being executed as described below.

The events include, in addition to the first hint event and the second hint event for obtaining a skill hint, an event for recovering energy, an event for decreasing energy, a first ability event and a second ability event for increasing or decreasing an ability parameter, an event for increasing mood, an event for decreasing mood, and the like. As will be described in detail below, examples of the event include an event in which a turn to occur is predefined and an event that occurs via a predetermined successful lottery. In addition, there are events that occur upon starting of a turn and events that occur before a turn is finished. When all the events that have occurred end, the top screen 210 related to the next turn is displayed.

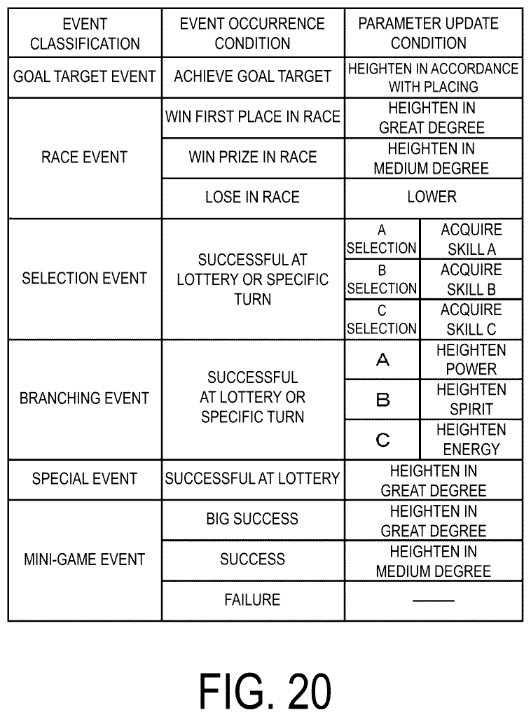

FIG. 20 is a diagram for describing an example of the events. As described above, various events occur during the nurture main game. As described above, the events include an exclusive event provided for each nurture target character, a support event provided for a support card, and a scenario event provided for each scenario. The nurture target character is provided with various events in addition to the exclusive event, such as an event associated with a selection item that can be selected in each turn and an event associated with a specific turn. FIG. 20 illustrates some of the events set for the nurture target character.

Event occurrence conditions are set for each event set for the nurture target character, and an event occurs when the event occurrence conditions are met. When the event occurs, an event screen provided for each event is displayed. As illustrated in FIG. 20, the events include, for example, a goal target event, a race event, a selection event, a branching event, a special event, and a mini-game event.

The goal target event is an event provided for each goal target race. The event occurrence conditions for the goal target event are to achieve the goal target in the goal target race. The goal target set for the goal target race is, for example, getting a predetermined or higher placing, or entering the goal target race.

When the nurture target character enters the goal target race and the goal target is achieved, the goal target event always occurs after the race ends. For the goal target event, a performance image in which the nurture target character appears is displayed. In addition, for the goal target event, a parameter update condition is set. The parameter update condition is a condition for updating the ability parameter associated with the nurture target character, such as an ability parameter.

The parameter update condition for the goal target event varies depending on the placing of the nurture target character. For example, when the nurture target character wins a prize (from second to fifth places), each of five ability parameters is increased by two points. On the other hand, when the nurture target character wins (first place), each of five ability parameters is increased by five points. In this manner, the goal target event is associated with the event occurrence condition, the performance image, and the parameter update condition.

Note that the goal target event is different for each nurture target character. A plurality of goal target races are set for one nurture target character. Therefore, a plurality of goal target events are set for one nurture target character. The parameter update conditions different are set for the plurality of goal target events. However, the same parameter update condition may be set for some or all of the goal target events. Further, for example, only one parameter update condition may be set for the goal target event. In this case, when the goal target is achieved, the parameters are commonly updated regardless of the placing.

Although not illustrated, a goal target unachieved event is provided in which the goal target being unachieved is set as the event occurrence condition. For example, when an entry is made into the goal target race and the goal target placing is not gotten, the goal target unachieved event always occurs. In this goal target unachieved event, a predetermined performance image is also displayed. When the goal target unachieved event occurs, the nurture game ends.

The race event is an event provided for each nurture target character. The race event is provided with a plurality of patterns (three patterns in this case), and event occurrence conditions are set for each pattern. Here, three event occurrence conditions are provided, namely, winning (first place), winning a prize (second to fifth places), and losing (sixth place or after) in a race other than the goal target race. Specifically, the race event is provided with three patterns, i.e., a winning first place pattern, a winning prize pattern, and a losing pattern. Then, a race event of a pattern corresponding to the event occurrence condition that has been met, that is, the placing the race, occurs.

When the race event occurs, a performance image provided for each pattern is displayed. In addition, for the race event of the losing pattern, a parameter update condition for lowering the ability parameter for the nurture target character is set. For the race event of the winning prize pattern, a parameter update condition for increasing the ability parameter for the nurture target character is set. For the race event of the winning first place pattern, a parameter update condition for greatly heightening the ability parameter for the nurture target character compared to the winning prize pattern is set. Therefore, when the race event occurs and the performance image is displayed, the ability parameter is updated according to the pattern of the occurring race event.

The selection event is an event in which options are presented to the player. A large number of selection events are provided. For each of the selection events, being successful at a lottery or being in a specific turn is set as the event occurrence condition. The selection event for which being in a specific turn is set as the event occurrence condition always occurs in the specific turn. When the selection event occurs, a performance image is displayed. This performance image includes an image for presenting a plurality of options to the player.

For example, in the selection event, three options of A, B, and C are presented. The player can select any one of the options in the performance image. For the selection event, a performance image and a parameter update condition are further set per option. When the player selects an option, a performance image corresponding to the selected option is displayed. Further, the parameter for the nurture target character is updated according to the parameter update condition corresponding to the option selected by the player.

For example, when an option A is selected, a hint for a skill A is obtained. When options B and C are selected, hints for skills B and C are obtained, respectively. Note that, although the case where the hint for the skill being obtained is set as the parameter update condition is described here, the parameter update condition set for the option of the selection event is not limited thereto. For example, in one selection event, an option for heightening the ability parameter and an option for lowering the ability parameter may be provided.

In addition, for example, in one selection event, a plurality of options for heightening the ability parameters different from each other may be provided. Alternatively, in one selection event, an option for obtaining a hint for a skill and an option for heightening or lowering the ability parameter may be provided. In any case, in the selection event, the performance image different for each option may be displayed, and the parameter may be updated according to the selected option.

Note that in the present embodiment, a selection event is provided in which a plurality of options are ranked in terms of superiority or inferiority. For example, in the present embodiment, a selection event is provided in which an option for heightening the ability parameter and an option for lowering the ability parameter are set. Further, for example, a selection event is provided in which an option for obtaining a hint of a strong skill and an option for obtaining a hint of a weak skill are set.

Furthermore, there is also a selection event in which an option for heightening the ability parameter and an option for not changing any ability parameter are set. As described above, in the present embodiment, a selection event including a first pattern and a second pattern occurs, the first pattern being associated with a first parameter update condition, the second pattern being associated with a second parameter update condition being more disadvantageous to the player than the first parameter update condition.

In this manner, when the selection event occurs, different performance images are displayed for each option selected by the player. Therefore, it can be said that the selection event is provided for each option.

The branching event is an event in which a performance branches in the middle. A large number of branching events are provided. For the branching event, being successful at a lottery or being in a specific turn is set as the event occurrence condition. When the branching event occurs, a performance image is displayed. This performance image is divided into a first half and a second half. The first half performance image is provided with one pattern and the second half performance image is provided with a plurality of patterns. Therefore, it can be said that the branching event is provided for each branching pattern.

When a branching event occurs, the patterns for the second half are determined. The patterns for the second half may be determined through a lottery or may be determined based on the parameter for the nurture target character at that time. That is, the branching event is provided with a branch point of the performance, and the performance is switched at the branch point. At this time, in the branching event, the player cannot select a branch destination, unlike the selection event.

For each of the patterns for the second half of the branching event, a parameter update condition is set. For example, as illustrated in FIG. 20, when a branch A is determined, the ability parameter of power is heightened. When branches B and C are determined, the ability parameter of spirit and the parameter of energy are heightened, respectively. In this manner, when the branching event occurs, the performance image randomly determined from among the plurality of performance images is displayed. Depending on the displayed performance image, the parameter to be updated may be different, or the update content of the parameter may be different.

The special event is, for example, an event that occurs in a case of a successful lottery in a specific turn. That is, for the special event, being successful at a lottery in a specific turn is set as the event occurrence condition. Further, for the special event, a parameter update condition for greatly heightening a predetermined parameter is set. For example, when the special event occurs, the parameter of mood, the parameter of energy, and five ability parameters are greatly heightened.

Note that being successful at a lottery and achieving all the goal targets may be set as an occurrence condition for the special event.

The mini-game event is an event that occurs at a predetermined probability when “going out” is selected in each turn. When the mini-game event occurs, a mini-game is started. The content of the mini-game is not particularly limited, but it is desirable that the game result is different depending on the operation by the player. Here, the result of the mini-game is classified into a big success, a success, and a failure.

The mini-game event is provided with a pattern corresponding to the result of the mini-game. Here, as the patterns of the mini-game events, a big success pattern, a success pattern, and a failure pattern are provided. The result of the mini-game being a big success is set as the event occurrence condition for the mini-game event of the big success pattern. Similarly, the result of the mini-game being a success and a failure are set as the event occurrence conditions for the mini-game events of the success pattern and the failure pattern, respectively.

Note that as described above, the mini-game event occurs by being successful at a lottery when “going out” is selected. Therefore, it can be said that “going out” being selected and being successful at a lottery are also included in the event occurrence condition for the mini-game event.

When the mini-game ends, a performance image corresponding to the result of the mini-game is displayed. In addition, for the mini-game event of the success pattern, heightening the parameter of mood is set as the parameter update condition. In addition, for the mini-game event of the big success pattern, heightening the parameters of mood and energy more than for the success pattern is set as the parameter update condition. Note that here, no parameter update condition is set for the mini-game event of the failure pattern. Therefore, when the result of the mini-game is a failure, the parameter for the nurture target character is not updated.

As described above, the events occurring during the nurture main game include an event in which a performance pattern to occur is determined from among a plurality of performance patterns associated with performance images and parameter update conditions that are different from each other. When these events occur, the performance image corresponding to the determined performance pattern is displayed. The parameter is updated according to the parameter update condition corresponding to the determined performance pattern.

Note that here, the event for which the parameter update condition is set is illustrated. However, the events include a large number of events for which no parameter update condition is set. The event includes an inheritance event.

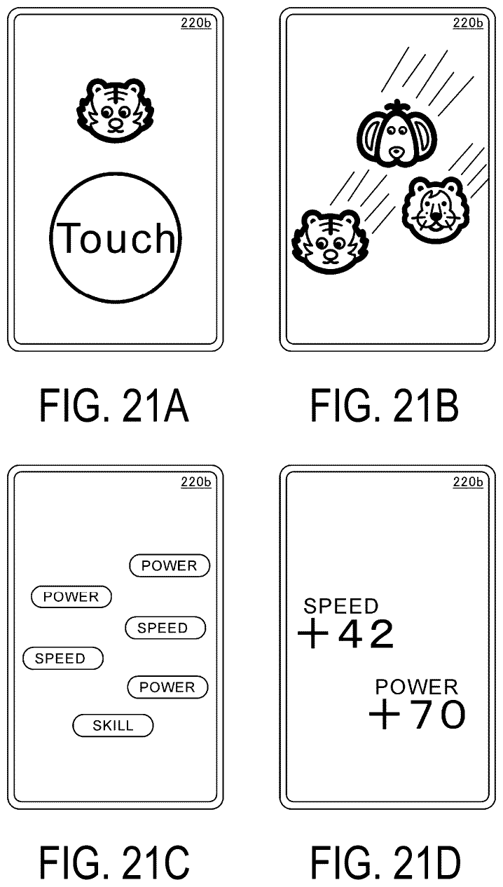

FIG. 21A is a first diagram for describing the inheritance event. FIG. 21B is a second diagram for describing the inheritance event. FIG. 21C is a third diagram for describing the inheritance event. FIG. 21D is a fourth diagram for describing the inheritance event. In the factor activation turn described above, an inheritance event occurs as the turn is started. Note that this inheritance event is a scenario-shared event described later, and always occurs in the same turn regardless of the scenario selected by the player. In the present embodiment, the first turn, the 31st turn, and the 55th turn are set as the factor activation turns, but here, a case where an inheritance event occurs in the 31st turn is described.

When the 31st turn is started, first, as illustrated in FIG. 21A, the nurture target character and the operation portion denoted by “Touch” are displayed on the event screen 220b. When the operation portion displayed on the event screen 220b is tapped, an animation image including the nurture target character and two inheritance characters is displayed as illustrated in the FIG. 21B. When the operation portion is tapped, a lottery is performed to determine whether to activate all the factors of the total of six nurtured characters of the first inheritance generation and the second inheritance generation.

Then, as illustrated in FIG. 21C, the factor is displayed which is determined to be activated via being successful at a lottery of whether to activate, and thereafter, as illustrated in FIG. 21D, the type of the ability parameter or aptitude parameter which increases by the activation of the factor and the increase value thereof are displayed, and the parameter is updated. When the inheritance event ends, the top screen 210 illustrated in FIG. 18A is displayed, and the player can select any item. At this time, in the stats display portion 213, the increase values of the ability parameter or aptitude parameter displayed in the inheritance event have been added.

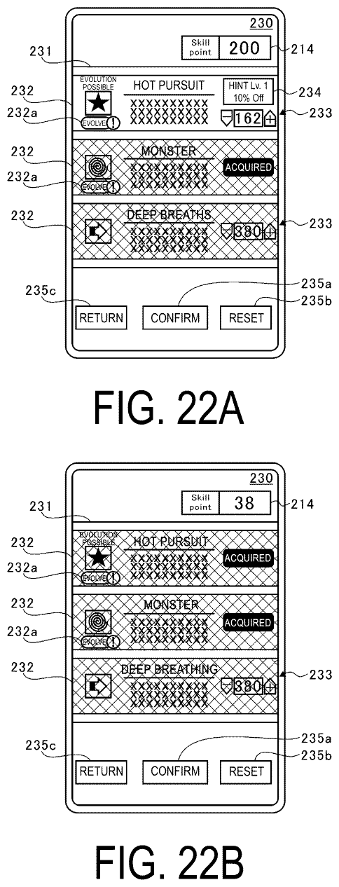

FIG. 22A is a first diagram for describing a skill screen 230. FIG. 22B is a second diagram for describing the skill screen 230. When the skill operation portion 217 on the top screen 210 is operated, the skill screen 230 illustrated in FIG. 22A is displayed on the display 26. The skill point display portion 214 is displayed in the skill screen 230. In the skill point display portion 214, the current skill point possessed by the nurture target character (player) is displayed similarly to the above-described way.

A skill display region 231 is provided below the skill point display portion 214. A plurality of skill display fields 232 are provided in the skill display region 231. In the skill display field 232, an acquired skill, a base skill set in advance for the nurture target character, a base skill possessed due to one of various types of events, and the like are displayed. Note that in FIG. 22A, three skill display fields 232 are displayed in the skill display region 231, but when a slide operation is input to the skill display region 231, another skill display field 232 is further displayed in the skill display region 231.

In the skill display region 231, names of the skills, the activation conditions for the skills, and the effects when the skills are activated are displayed. In a right portion of the skill display region 231, a required point display portion 233 is displayed. In the required point display portion 233, a value of the skill points required to acquire the skill is displayed. The required point display portion 233 is provided with an operation portion denoted by “+” or “−”. The player can put the skill displayed in the skill display field 232 in the selected state by operating the operation portion denoted by “+”. The player can cancel the selected state of the skill displayed in the skill display field 232 by operating the operation portion denoted by “−”.

Note that when the first hint event or the second hint event occurs for a base skill, the skill points spent for acquiring the base skill is subtracted. In addition, even when the hint level of the character is enhanced before starting of the nurture game, the skill points for acquiring the base skill are subtracted. Here, for the base skill for which the hint has been acquired, a value of the skill points after the subtraction is displayed in the required point display portion 233. At this time, a subtraction rate display icon 234 indicating a subtraction rate is displayed in the skill display field 232.

On the skill screen 230, the skill display field 232 corresponding to an acquirable skill and a skill display field 232 corresponding to an unacquirable skill are displayed to be distinguished. For example, the skill display field 232 corresponding to the acquired skill and the skill display field 232 corresponding to the base skill that cannot be acquired due to the shortage of the skill points are grayed out (indicated by cross-hatching in the figure). Note that in the skill display field 232 corresponding to the acquired skill, an icon denoted by “acquired” is displayed instead of the required point display portion 233.

Below the skill display region 231, a determination operation portion 235a, a reset operation portion 235b, and a return operation portion 235c are provided. When the determination operation portion 235a is operated in a state where any of the skills is selected, a confirmation screen (not illustrated) is displayed. Then, when a predetermined operation for acquiring a skill is input on the confirmation screen, the skill in the selected state is associated with acquisition information. That is, the base skill is updated to the acquired skill.

For example, assume that in the state illustrated in FIG. 22A, the skill corresponding to the skill display field 232 displayed in the uppermost tier of the skill display region 231 is acquired. In this case, the skill screen 230 is updated as illustrated in FIG. 22B as the skill is acquired. Here, the skill display field 232 displayed in the uppermost tier of the skill display region 231 is grayed out. In addition, the remaining skill points after the skill is acquired are displayed in the skill point display portion 214.

Note that when the reset operation portion 235b is operated, the selected states of all the skills are canceled. When the return operation portion 235c is operated, the skill screen 230 is closed and the top screen 210 is displayed.

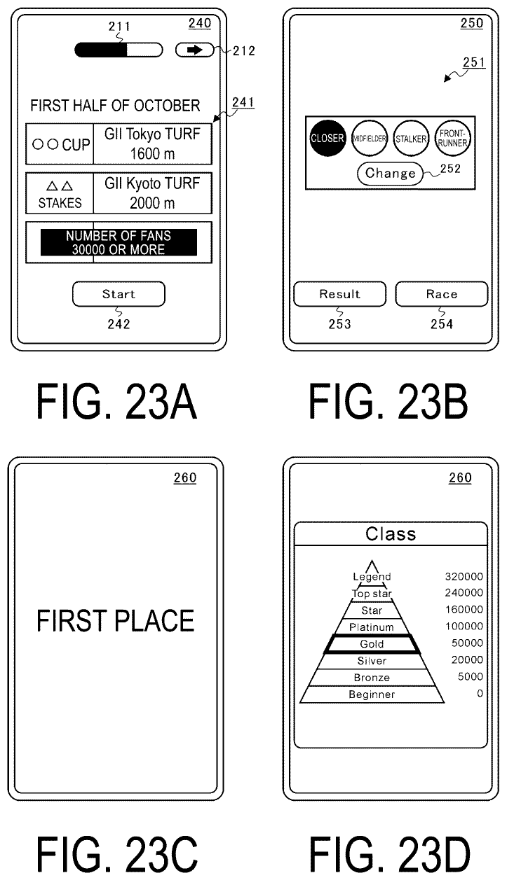

FIG. 23A is a first diagram for describing a race selection screen 240. When the race operation portion 219 on the top screen 210 is operated, the race selection screen 240 illustrated in FIG. 23A is displayed. Races have a game property in which the nurture target character races with a non-player character (hereinafter, referred to as NPC).

In an upper portion on the race selection screen 240, an energy display portion 211 and a mood display portion 212 are displayed. In addition, in a central portion on the race selection screen 240, a race selection operation portion 241 is displayed for selecting a race event which the nurture target character is made to enter. In addition, in a lower portion on the race selection screen 240, a start operation portion 242 is displayed. A race that can be selected via the race selection operation portion 241 on the race selection screen 240 is set in advance for each turn.

In addition, the race entry condition is set in advance for each race, and the player can only make the nurture target character enter a race with race entry conditions being satisfied. As described above, a race may have the number of fans defined as a race entry condition. For a race short of the defined number of fans, as illustrated in FIG. 23A, the race selection operation portion 241 displays the race entry condition and notifies that the race cannot be selected. In addition, in a turn in which a goal target race is set, only the goal target race is displayed to be selectable on the race selection screen 240.

FIG. 23B is a diagram for describing a race start screen 250. When the start operation portion 242 is operated in a state where the race event of the race to participate in is selected by the race selection operation portion 241, the race start screen 250 illustrated in FIG. 23B is displayed. In a center portion on the race start screen 250, a strategy display portion 251 is displayed. In the strategy display portion 251, a strategy currently selected (closer, midfielder, stalker, or front-runner) is highlighted. A change operation portion 252 is also displayed in the strategy display portion 251. When the change operation portion 252 is operated, a strategy change screen (not illustrated) is displayed on the display 26. The player can change the strategy in the race to any strategy by an operation on the strategy change screen.

Further, in a lower portion on the race start screen 250, a result operation portion 253 and a race operation portion 254 are displayed. When the race operation portion 254 is operated, a race screen (not illustrated) is displayed on the display 26. On the race screen, a moving image of developments in the race (hereinafter also referred to as a race moving image) is displayed.

FIG. 23C is a first diagram for describing a race result screen 260. FIG. 23D is a second diagram for describing the race result screen 260. When playback of the race moving image described above ends and when the result operation portion 253 is operated, the race result screen 260 is displayed on the display 26. On the race result screen 260, as illustrated in FIG. 23C, the placing of the nurture target character in the race is displayed. Further, on the race result screen 260, as illustrated in FIG. 23D, the current class of the nurture target character is displayed.

In the present embodiment, the nurture target character is classified according to the obtained number of fans. A range of the number of fans is set for each class. Here, the nurture target character is classified into one of eight stages of classes according to the number of fans. Further, on the race result screen 260, the cumulative number of fans obtained by adding the number of fans newly obtained in the latest race to the number of fans obtained before is displayed. In addition, the current class corresponding to the cumulated number of fans is displayed to be distinguished.

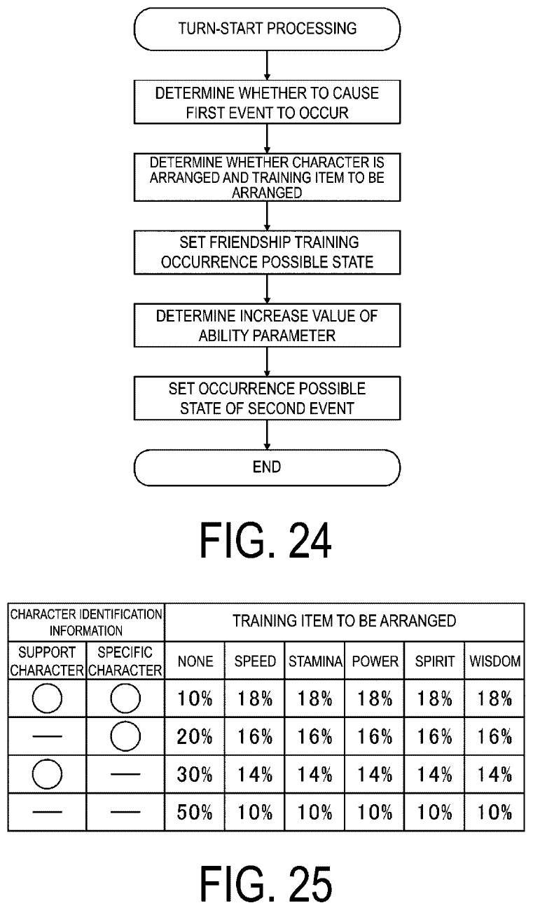

FIG. 24 is a diagram for describing a rough flow of turn-start processing. The nurture stage processing includes the turn-start processing executed upon starting of each turn of the nurture game. The rough flow of the turn-start processing is described here, and the details of the turn-start processing is described below.

During the nurture main game, processing to determine whether to cause various events to appear is executed in each turn. Events are roughly classified into three types: a scenario event, the above-described exclusive event provided for each nurture target character, and a support event. In each scenario, a scenario event, an exclusive event, and a support event that may appear during the nurture main game are predefined.

A scenario event is an event set for each scenario of the nurture main game. In the present embodiment, a plurality of scenarios are provided, and the player can select a scenario. A scenario event appears for each scenario selected by the player. In other words, the scenario event that appears in the nurture main game is determined based on the scenario selected by the player.

The scenario event may include a scenario-specific event and a scenario-shared event. A scenario-specific event is an event associated with only one scenario. For example, a scenario-specific event associated with a first scenario appears only when the first scenario is selected and does not appear when another scenario is selected.

A scenario-shared event is an event that appears shared across a plurality of scenarios. Thus, the scenario-shared event appears in both cases when the first scenario is selected and when the second scenario is selected.

In this example, scenario-specific events and scenario-shared events are provided as scenario events. However, only one of the scenario-specific events and the scenario-shared events may be provided.

As described above, an exclusive event is an event set in advance for each character. In the nurture main game, an exclusive event for a character registered as a nurture target character by the player in the setting game, that is, the preparation stage processing, appears.

As described above, the support event is an event set in advance for each support card. In the nurture main game, a support event associated with the support card registered by the player in the setting game appears. The support event includes a first event that may occur upon starting of a turn and a second event that may occur after training is performed. Upon starting of a turn, whether to cause the first event to occur is determined based on a random number obtained at random and a first event table.

Whether to cause the second event to occur is determined based on a randomly obtained random number and a second event table after the determination processing for each support character arranged in the training is executed. Note that whether to cause the second event to occur is determined for the arranged support character only in a case where a support character is arranged in training.

Note that in the present embodiment, the support event that may be selected for the first event is associated with the support card, which is not limited to that support card registered in the deck by the player in the preparation stage processing, but is selected through a lottery from among all support cards implemented in the game. However, a selection probability of the support event associated with the support card registered in the deck is higher than a selection probability of the support card event associated with the support card not registered in the deck.

As described above, whether a scenario event appears is determined based on the scenario. Also, whether an exclusive event and a support event appear is determined based on the nurture target character and the support card, respectively. These event types are classified by information that is referenced when determining whether an event appears.

On the other hand, in the present embodiment, each event is classified into one of six event classifications according to the content brought about by the appearance of the event. Here, each event is classified into one of the event classifications including a first hint event, a second hint event, a first ability event, a second ability event, an aptitude event, and a story event.

As described above, the first hint event and the second hint event are events that make it possible to possess or obtain a skill. The first ability event and the second ability event are events for increasing or decreasing the ability parameter for the nurture target character. The aptitude event is an event for increasing or decreasing the aptitude parameter for the nurture target character. The story event is an event for displaying a story related to a character appearing in the nurture game. Note that story events may change an ability parameter or an aptitude parameter in addition to a story being displayed.

Here, the scenario event includes a first hint event, a second hint event, a first ability event, a second ability event, an aptitude event, and a story event. The exclusive event and the support event include a first hint event, a second hint event, a first ability event, and a second ability event. Note that the exclusive event may include a story event.

In the present embodiment, the turn-start processing includes processing of determining a scenario event and processing of determining an exclusive event. Note that, here, the illustration and description of the processing of determining the scenario event and the processing of determining the exclusive event are omitted. The turn-start processing includes “processing of determining whether to cause the first event to occur”, “processing of determining whether the character is arranged and the training item to be arranged”, “processing of setting the friendship training occurrence possible state”, “processing of determining the increase value of the ability parameter”, and “processing of setting the occurrence possible state of the second event” illustrated in FIG. 24. Note that although various other processing is executed in the turn-start processing, the processing illustrated in FIG. 24 is sequentially described here.

### Processing of Determining Whether to Cause First Event to Occur

In the processing of determining whether to cause the first event to occur, the first event to occur is determined through a lottery from among the support events associated with all the support cards provided by the operator. At this time, the success probability of the support event associated with the support card registered in the deck by the player in the preparation stage processing is set to be higher.

### Processing of Determining Whether Character is Arranged and Training Item to be Arranged

FIG. 25 is a diagram for describing an arrangement ratio to a training item. The player terminal 1 and the server 1000 store an arrangement determination table, and a training item in which a character is arranged is determined based on the arrangement determination table. In the present embodiment, the training items are determined for all support characters and story characters based on character identification information.

Here, the arrangement determination table is provided for each piece of character identification information, and the arrangement ratio to each training item is different for each arrangement determination table. Specifically, according to the arrangement determination table for the support character and the specific character, the determination of not arranging the character and the specific character in any training (“none” in the figure) is set to 10%, and the determination of arranging the character and the specific character in the training items of speed, stamina, power, spirit, and wisdom (“speed”, “stamina”, “power”, “spirit”, and “wisdom” in the figure) all is set to 18%. The arrangement determination table for the support character and the specific character is used when the character determined to be arranged is set as the support character and the specific character.

In addition, according to the arrangement determination table for the specific character, the determination of not arranging the specific character in any training is set to 20%, and the determination of arranging the specific character in the training items of speed, stamina, power, spirit, and wisdom all is set to 16%. The arrangement determination table for the specific character is used when the character determined to be arranged is not set as the support character but set as the specific character.

In addition, according to the arrangement determination table for the support character, the determination of not arranging the support character in any training is set to 30%, and the determination of arranging the support character in the training items of speed, stamina, power, spirit, and wisdom all is set to 14%. The arrangement determination table for the support character is used when the character determined to be arranged is set as the support character but is not set as the specific character.

In addition, according to the arrangement determination table for other characters, the determination of not arranging other characters in any training is set to 50%, and the determination of arranging other characters in the training items of speed, stamina, power, spirit, and wisdom all is set to 10%. The arrangement determination table for other characters is used when the character determined to be arranged is not set as any of the support character and the specific character. Note that the arrangement determination table for other characters may be used, for example, when the character to be arranged is set as a story character.

Note that as described above, the favored training is set for the support card (support character). When the character to be arranged is a support character, change may be made such that the selection probability of the favored training set in the support card may be higher based on the arrangement determination table illustrated in FIG. 25. In addition, for example, some or all of the support cards (support characters) may be associated with an effect of increasing a probability of arrangement to a predetermined training item. The probability of arrangement of the support character associated with such an effect to a predetermined training item is changed to be higher.

Note that each training item is provided with an arrangement upper limit number of characters. Here, the arrangement upper limit number of characters is set to “5” for all the training items. Therefore, the number of arranged characters to be arranged in one training item 1 is up to “5”.

Note that as described above, the training item associated with the character is determined for each character. At this time, the order of characters for determining the training items is arbitrary. Then, for example, in a case where the arrangement upper limit number of arranged characters have already been determined to be arranged in the training item in which a character is determined to be arranged, those characters may be determined to be not arranged in any training item. Alternatively, the training item in which the number of arranged characters has already reached the arrangement upper limit number may be excluded from the lottery, and the probability of arrangement to the other training items may be changed.

However, the arrangement upper limit number is not essential, and the arranged characters may be arranged in the training item as the lottery result. The method of determining the training item in which the character is arranged is not particularly limited.

When the arranged characters are determined as described above, the arranged characters are associated with each training item. Then, arrangement information in which the training item is associated with the arranged character is stored in the player terminal 1 and the server 1000.

### Processing of Setting Friendship Training Occurrence Possible State

Referring back to FIG. 24, when the arrangement information is determined as described above, the friendship training occurrence possible state is set. Specifically, a support character is extracted from the characters arranged in the training item. Then, whether the setting condition for the friendship training occurrence possible state is met is determined for the extracted support character. As described above, here, the training item in which the support character is arranged being the favored training and the bond parameter associated with the support character being equal to or greater than a predetermined value are set as the setting conditions for the friendship training occurrence possible state.

Then, the support character that satisfies the setting conditions for the friendship training occurrence possible state is associated with friendship training occurrence possible information. In addition, the training item in which the support character that satisfies the setting conditions for the friendship training occurrence possible state is arranged is also associated with friendship training occurrence possible information. Thus, the friendship training occurrence possible state is set.

### Processing of Determining Increase Value of Ability Parameter

In a turn in which training can be performed, the increase value of the ability parameter when the training is successful is determined for each training item.

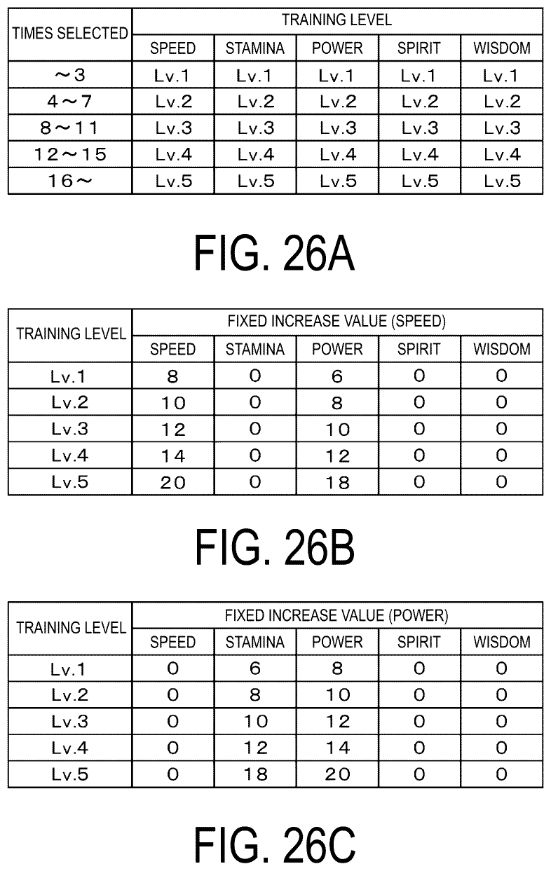

FIG. 26A is a diagram for describing a training level table. As illustrated in FIG. 26A, the training level is configured to increase in accordance with the number of times that each training is selected. Specifically, when the number of times that each training is selected is 3 or less, each of the training levels related to speed, stamina, power, spirit, and wisdom is set to “level 1”; when the number of times that each training is selected is in a range from 4 to 7, each training level is set to “level 2”; when the number of times that each training is selected is in a range from 8 to 11, each training level is set to “level 3”; when the number of times that each training is selected is in a range from 12 to 15, each training level is set to “level 4”; and when the number of times that each training is selected is 16 or more, each training level is set to “level 5”.

Note that, here, the case where the training level is increased according to the number of times that the training is selected is described. However, the condition for increasing the training level is not limited to this. For example, the training level may be increased or decreased through a lottery. Alternatively, the training level may be changed according to the number of turns. Note that the training level is not essential.

In the present embodiment, when the training selected by the player has been performed and has been successful, the value of a predetermined ability parameter is increased by the performed training item.

Specifically, in the present embodiment, if training of speed is performed and the training is successful, the values of the ability parameters for speed and power are increased.

In addition, if training of stamina is performed and the training is successful, the values of the ability parameters for stamina and spirit are increased.

In addition, if training of power is performed and the training is successful, the values of the ability parameters for stamina and power are increased.

In addition, if training of spirit is performed and the training is successful, the values of the ability parameters for speed, power, and spirit are increased.

In addition, if training of wisdom is performed and the training is successful, the values of the ability parameters of speed and wisdom are increased.

In the present embodiment, the value of the ability parameter to be increased when the training is successful is calculated by adding a value obtained by adding a bonus additional value described below to a fixed increase value determined corresponding to the performed training item and the training level to the fixed increase value.

FIG. 26B is a diagram for describing a fixed increase value (speed) table. FIG. 26C is a diagram for describing a fixed increase value table (power). That is, FIG. 26B indicates the fixed increase value when the training item is speed. Also, FIG. 26C indicates the fixed increase value when the training item is power.

As illustrated in FIGS. 26B and 26C, the fixed increase value table stores fixed increase values determined corresponding to the performed training item and the training level. Further, in the present embodiment, as illustrated in FIGS. 26B and 26C, the ability parameter is configured to increase more as the training level is higher.

It should be noted that although description is omitted here, fixed increase value tables in a case where stamina, spirit, and wisdom are selected as the training item are also provided.

In the present embodiment, a large number of addition conditions for the ability parameters are provided. The addition conditions include, for example, the specific character or the support character being arranged in the training item. In this case, a predetermined additional value is added to the fixed increase value. Further, for example, a growth rate may be set in advance for each training item for each nurture target character. In this case, the fixed increase value is multiplied by the growth rate for each training item.

In this way, when the addition condition is met, the additional value is added to the fixed increase value, or the fixed increase value is multiplied by a predetermined addition rate. Then, the calculated value is finally multiplied by a friendship bonus addition rate. The friendship bonus addition rate is used when a friendship bonus occurrence possible state is set for the training item. Moreover, the friendship bonus addition rate is calculated for each of the arranged characters arranged in the training item.

For example, assume that the friendship bonus addition rate is 20% and three arranged characters for each of which the friendship bonus occurrence possible state is set are arranged in the same training item. In this case, the friendship bonus addition rate is 60%. In this manner, the increase value of the ability parameter is increased by multiplying the friendship bonus addition rate.

### Processing of Setting Occurrence Possible State of Second Event

Referring back to FIG. 24, for a support character arranged in any of the training items, an occurrence possible state of the second event is set. The second event is selected through a lottery from among the support events (second events) associated with the support character (support card) arranged in each training item.

In the present embodiment, processing is executed to determine whether to set the occurrence possible state of the second event for all support characters arranged in the training item. When the player selects the training in which the support character for which the occurrence possible state of the second event is set is arranged, the second event occurs after the training is performed.

Note that the occurrence possible state of the second event may be set for each of a plurality of support characters arranged in one training item. In this case, when the training is performed, only one of the second events for which the occurrence possible states are set may be performed. All the second events for which the occurrence possible states are set may be performed.

As described above, in the nurture main game, the player can increase the ability parameter for the nurture target character as the turn progresses. The ability parameter is increased due to the success of training or the appearance of various events. Then, in the nurture main game, when all the turns are finished, the nurture game ends. If the goal set for each character was not achieved during the nurture main game, the nurture game ends at this point.

Here, when the nurture game ends, the nurture target character nurtured in the nurture game is stored as a nurtured character. More strictly, the information related to the nurtured character nurtured in the nurture game (hereinafter referred to as nurtured character information) is stored in association with the player ID. The nurtured character information is stored in both the player terminal 1 and the server 1000. The nurtured character information stored in association with the player ID includes the ability parameter, the aptitude parameter, the acquired skill, inheritance information, and the like.

When the nurture game ends, the evaluation score of the nurtured character is calculated. Here, the evaluation score is calculated based on the ability parameter, the aptitude parameter, the acquired skill, race results, team race results, and the like at the end of the nurture game. Note that the method for calculating the evaluation score, in other words, a calculation formula for calculating the evaluation score, is prepared in advance, and the evaluation score is calculated based on a predetermined calculation formula. The calculation method and the calculation formula for the evaluation score are not particularly limited. For example, the evaluation score may be calculated based on only the parameter that affects the race result when the nurtured character enters a race in a team competition game or another racing game, such as the ability parameter, the aptitude parameter, the acquired skill, or the like at the end of the nurture game.

A nurture rank is set for the nurtured character based on the evaluation score. The nurture rank is an indicator of the strength of the nurtured character, and a range of evaluation score is associated with each nurture rank. For example, a nurture rank of “A+” is given to a nurtured character having an evaluation score ranging from 13000 to 14499, and a nurture rank of “S” is given to a nurtured character having an evaluation score ranging from 14500 to 15499. In this manner, by giving the nurture rank based on the evaluation score, the approximate strength of the nurtured character is made easy to understand. The nurtured character information includes the evaluation score and the nurture rank.

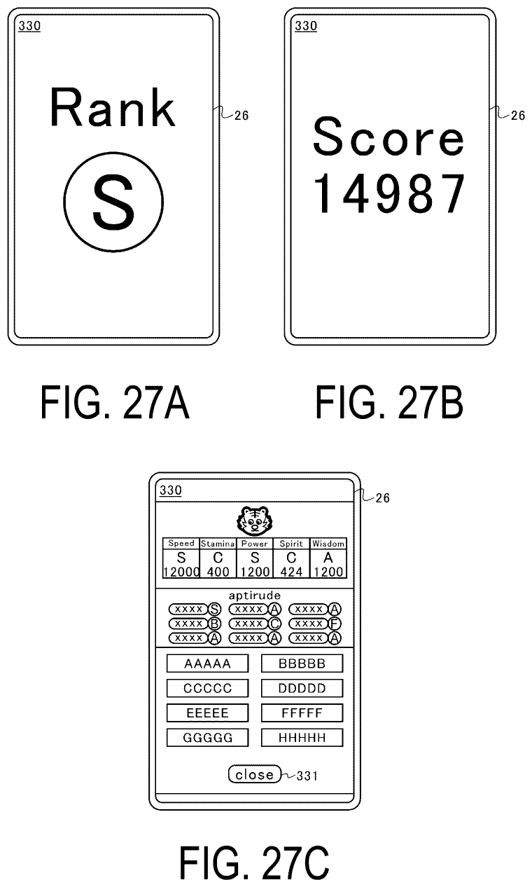

FIG. 27A is a first diagram for describing a nurture completion screen 330. FIG. 27B is a second diagram for describing the nurture completion screen 330. FIG. 27C is a third diagram for describing the nurture completion screen 330. When the nurture game ends, the nurture completion screen 330 is displayed on the display 26 as illustrated in FIG. 27A. On the nurture completion screen 330, the nurture rank of the nurtured character is first displayed, and thereafter, the evaluation score is displayed as illustrated in FIG. 27B.

When a predetermined period of time elapses after the evaluation score is displayed, the ability parameter, the aptitude parameter, and the acquired skill of the nurtured character are displayed on the nurture completion screen 330 as illustrated in FIG. 27C. At this time, a close operation portion 331 is provided on the nurture completion screen 330. When the close operation portion 331 is tapped, the nurture completion screen 330 is hidden, and the home screen 100 is displayed on the display 26.

Note that when the nurture game ends, a lottery for a factor to be obtained by the nurtured character is performed, and factor information is stored in association with the nurtured character. Although not illustrated, the player can display the factor information obtained by the nurtured character on the nurture completion screen 330. The lottery for the factor is performed according to a condition set in advance for each factor type. An acquisition probability of the factor and the like are set based on the result of the nurture game.

Next, the functional configuration of the player terminal 1 and the server 1000 for executing the above-described nurture game will be described.

### Functional Configuration of Player Terminal 1

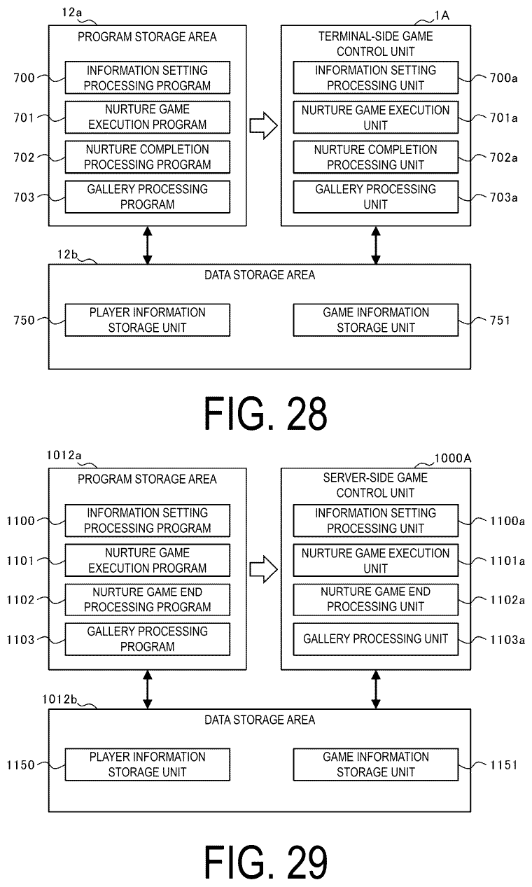

FIG. 28 is a diagram for describing a configuration of the memory 12 in the player terminal 1 and the function as a computer. The memory 12 is provided with a program storage area 12a and a data storage area 12b. When the game is started, the CPU 10 stores a terminal-side game control program (module) in the program storage area 12a.

The terminal-side game control program includes an information setting processing program 700, a nurture game execution program 701, a nurture completion time processing program 702, and a gallery processing program 703. Note that the programs listed in FIG. 28 are examples, and many other programs are provided in the terminal-side game control program.

In the data storage area 12b, a player information storage unit 750 and a game information storage unit 751 are provided as storage units that store data. It should be noted that the data storage area 12b is provided with a large number of other storage units. Here, information directly related to a game such as a nurture game (hereinafter referred to as game information) is stored in the game information storage unit 751. Note that various types of information during the progress of each game such as the nurture game are also temporarily stored in the game information storage unit 751. Thus, all information related to the nurtured character nurtured in the nurture game is stored in the game information storage unit 751. In addition, for example, all information other than the game information, such as information related to the player or another player and setting information of the player terminal 1, is set as player information. The player information is stored in the player information storage unit 750.

The CPU 10 operates each program stored in the program storage area 12a and updates the data in each storage unit of the data storage area 12b. Then, the CPU 10 causes the player terminal 1 (computer) to function as a terminal-side game control unit 1A by run each program stored in the program storage area 12a. The terminal-side game control unit 1A includes an information setting processing unit 700a, a nurture game execution unit 701a, a nurture completion time processing unit 702a, and a gallery processing unit 703a.

To be specific, the CPU 10 runs the information setting processing program 700 to cause the computer to function as the information setting processing unit 700a. Similarly, the CPU 10 runs the nurture game execution program 701, the nurture completion time processing program 702, and the gallery processing program 703 to cause the computer to function as the nurture game execution unit 701a, the nurture completion time processing unit 702a, and the gallery processing unit 703a.

When various types of information are set in the player terminal 1, the information setting processing unit 700a stores information related to the setting in the player information storage unit 750 as player information. When the information in the player information storage unit 750 is updated, the information setting processing unit 700a transmits the updated information to the server 1000.

The nurture game execution unit 701a executes all processing related to the nurture game. To be specific, the nurture game execution unit 701a executes the preparation stage processing and the nurture stage processing.

The nurture completion time processing unit 702a stores the nurtured character information including the ability parameter, the aptitude parameter, the acquired skill, the inheritance information, the factor information, the type of the character used for nurturing, and the like of the nurtured character at the time of completion of the nurture game.

The gallery processing unit 703a enables the performance image displayed during the nurture game to be viewed outside the nurture game.

### Functional Configuration of Server 1000

FIG. 29 is a diagram for describing a configuration of the memory 1012 in the server 1000 and the function as a computer. The memory 1012 is provided with a program storage area 1012a and a data storage area 1012b. When the game is started, the CPU 1010 stores a server-side game control program (module) in the program storage area 1012a.

The server-side game control program includes an information setting processing program 1100, a nurture game execution program 1101, a nurture game end processing program 1102, and a gallery processing program 1103. Note that the programs listed in FIG. 29 are examples, and many other programs are provided in the server-side game control program.

In the data storage area 1012b, a player information storage unit 1150 and a game information storage unit 1151 are provided as storage units that store data. It should be noted that the data storage area 1012b is provided with a large number of other storage units. Here, the game information of all the players is stored in the game information storage unit 1151 in association with the player ID. The player information of all the players is stored in the player information storage unit 1150 in association with the player ID.

The CPU 1010 operates each program stored in the program storage area 1012a and updates the data in each storage unit of the data storage area 1012b. Then, the CPU 1010 causes the server 1000 (computer) to function as a server-side game control unit 1000A by run each program stored in the program storage area 1012a. The server-side game control unit 1000A includes an information setting processing unit 1100a, a nurture game execution unit 1101a, a nurture game end processing unit 1102a, and a gallery processing unit 1103a.

To be specific, the CPU 1010 runs the information setting processing program 1100 to cause the computer to function as the information setting processing unit 1100a. Similarly, the CPU 1010 runs the nurture game execution program 1101 and the nurture game end processing program 1102 to cause the computer to function as the nurture game execution unit 1101a, the nurture game end processing unit 1102a, and the gallery processing unit 1103a.

When various types of information are set in the player terminal 1, the information setting processing unit 1100a updates the player information in the player information storage unit 1150 based on the update information received from the player terminal 1. In addition, the information setting processing unit 1100a measures time and updates the game points of each player.

The nurture game execution unit 1101a executes all processing related to the nurture game.

When the nurture game ends, the nurture game end processing unit 1102a derives the evaluation score, nurture rank, and the like for the nurtured character. In addition, the nurture game end processing unit 1102a determines the factor to be obtained by the nurtured character through a lottery. The game information storage unit 1151 stores nurtured character information including the ability parameter, the aptitude parameter, the acquired skill, the inheritance information, the factor information, the type of the character used for nurturing, and the like of the nurtured character associated with the player ID.

The gallery processing unit 1103a manages various kinds of information for enabling the performance image displayed during the nurture game to be viewed outside the nurture game.

Note that the information setting processing unit 700a in the player terminal 1 and the information setting processing unit 1100a in the server 1000 are the same in that both store player information, but are different from each other in the specific content of processing and the range of stored player information. In addition, the nurture game execution unit 701a in the player terminal 1 and the nurture game execution unit 1101a in the server 1000 are the same in that they execute processing related to the nurture game, but they have different roles, that is, different ranges of responsibility.

Processing performed by each functional unit in the player terminal 1 and the server 1000 will be described below with reference to a flowchart.

### Processing of Player Terminal 1 and Server 1000 Processing Related to Nurture Game

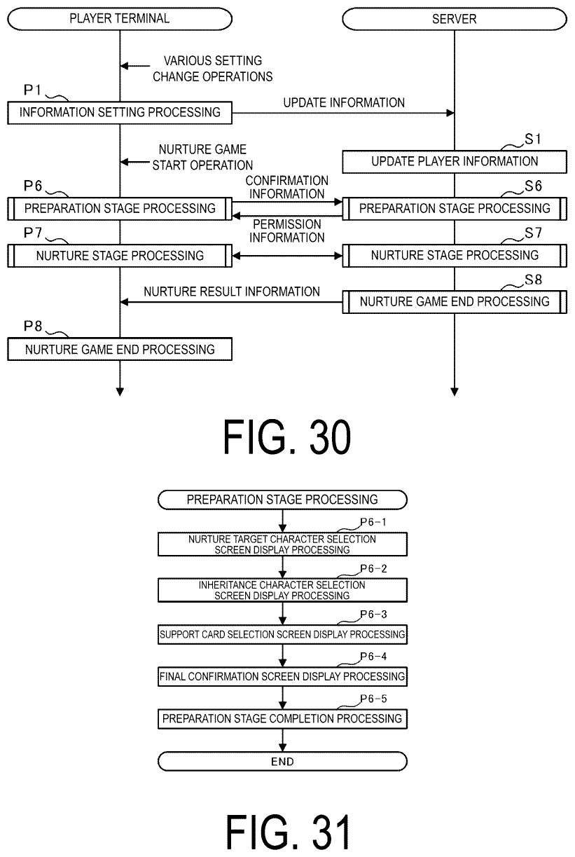

FIG. 30 is a sequence diagram for describing processing of the player terminal 1 and the server 1000 related to the nurture game. In the following description, the processing in the player terminal 1 is denoted by Pn (n is an arbitrary integer). Processing in the server 1000 is denoted by Sn (n is an arbitrary integer).

When the player performs various setting change operations on the player terminal 1, the information setting processing unit 700a of the player terminal 1 performs information setting processing of updating the player information storage unit 750 based on the operation input of the player (P1). In this information setting processing, the update information is transmitted to the server 1000. In the server 1000, when the update information is received, the information setting processing unit 1100a updates the player information of the player information storage unit 1150 (S1).

The player information updated in P1 and S1 includes, for example, profile information that can be set by the player. In addition, for example, when an operation of adding another player as a friend or an operation of removing a friend is input as a setting change operation, friend information, information related to friends, is updated. In P1 and S1, each of the information setting processing unit 700a and the information setting processing unit 1100a manages the game points spent to execute the nurture game. When the game points are less than the upper limit value, the information setting processing units 700a and 1100a measure time and give a predetermined value of game points to the player at predetermined time intervals.

When a nurture game start operation for starting the nurture game is input to the player terminal 1, the nurture game execution unit 701a executes the preparation stage processing (P6). Further, during the preparation stage processing, communication processing is executed between the player terminal 1 and the server 1000. In the server 1000, the nurture game execution unit 1101a executes the preparation stage processing based on the information received from the player terminal 1 (S6).

FIG. 31 is a flowchart for describing the preparation stage processing (P6) in the player terminal 1. The nurture game execution unit 701a in the player terminal 1 executes a nurture target character selection screen display processing (P6-1). Here, the nurture game execution unit 701a displays the nurture target character selection screen 150, and provisionally registers the nurture target character based on the operation input of the player.

To be more specific, the nurture game execution unit 701a switches the display screen of the display 26 when the player inputs a display switching operation for switching the display of the screen. When a tapping and holding operation on the character icon 151 on the nurture target character selection screen 150 is input, the nurture game execution unit 701a displays the character detail screen 160. When the strengthening operation portion 163b is operated on the character detail screen 160, the character strengthening screen 165 is displayed. Further, when a selection operation (operation on the character icon 151) is input on the nurture target character selection screen 150, the nurture game execution unit 701a temporarily stores the character corresponding to the character icon 151 to which the selection operation has been input, and switches the display screen.

When a determination operation (operation on the next operation portion 154) is input on the nurture target character selection screen 150, the nurture game execution unit 701a provisionally registers the temporarily stored character as a nurture target character. The nurture game execution unit 701a acquires information related to the representative characters extracted according to a predetermined extraction condition, such as the representative characters of the friends, from the server 1000, and displays the inheritance character selection screen 170.

Next, the nurture game execution unit 701a executes inheritance character selection screen display processing (P6-2). Here, the nurture game execution unit 701a switches the display screen on the display 26 when the display switching operation is input. Further, when a selection operation (operation on the nurtured character icon 182) is input on the nurtured character list screen 180, the nurture game execution unit 701a temporarily stores the character corresponding to the nurtured character icon 182 on which the selection operation input has been performed as an inheritance character, and switches the display screen.

When a determination operation (operation on the next operation portion 154) is input on the inheritance character selection screen 170, the nurture game execution unit 701a displays the support card organization screen 190 on the display 26.

Next, the nurture game execution unit 701a executes support card selection screen display processing (P6-3). Here, when a selection operation (operation on the card icon 201 of the support card) is input, the nurture game execution unit 701a temporarily stores the support card corresponding to the card icon 201 on which the selection operation has been performed, and switches the display screen.

In addition, when a display switching operation for switching the display of the screen is input while the support card organization screen 190 is displayed, the nurture game execution unit 701a switches the display screen of the display 26. When a determination operation (operation on the start operation portion 193) is input, the nurture game execution unit 701a displays the final confirmation screen 205 on the display 26.

Next, the nurture game execution unit 701a executes final confirmation screen display processing (P6-4). Here, when a display switching operation for switching the display of the screen is input, the nurture game execution unit 701a switches the display screen on the display 26.

In addition, when a selection operation (operation on the select operation portion 206c) is input on the preset selection screen 205A, the nurture game execution unit 701a temporarily stores reservation selection information corresponding to the preset on which the selection operation input has been performed, and switches the display screen.

When a determination operation (operation on the start operation portion 205b) is input on the final confirmation screen 205, the nurture game execution unit 701a executes preparation stage completion processing (P6-5). Here, the nurture game execution unit 701a determines whether the game point is equal to or greater than a predetermined value (such as 30), and if the game point is equal to or greater than the predetermined value, transmits confirmation information to the server 1000.

Note that the confirmation information includes information for identifying the provisionally registered nurture target character, inheritance character, and support card. When the confirmation information is received, the preparation stage processing (S6) is executed in the server 1000. Although details will be described later, in the server 1000, a determination is made on whether to permit the nurture main game to be performed using the provisionally registered nurture target character, inheritance character, and support card.

The nurture game execution unit 701a after transmitting the confirmation information, when receiving permission information from the server 1000, registers the provisionally registered nurture target character. Additionally, the nurture game execution unit 701a registers the nurtured character temporarily stored as the inheritance character and the temporarily stored support card in the deck.

The nurture game execution unit 701a registers the character ID of the character set as the specific character based on specific character information. The nurture game execution unit 701a sets initial character identification information. The nurture game execution unit 701a registers the reservation selection information of the temporarily stored preset. Thus, the preparation stage completion processing ends, and the nurture main game is started.

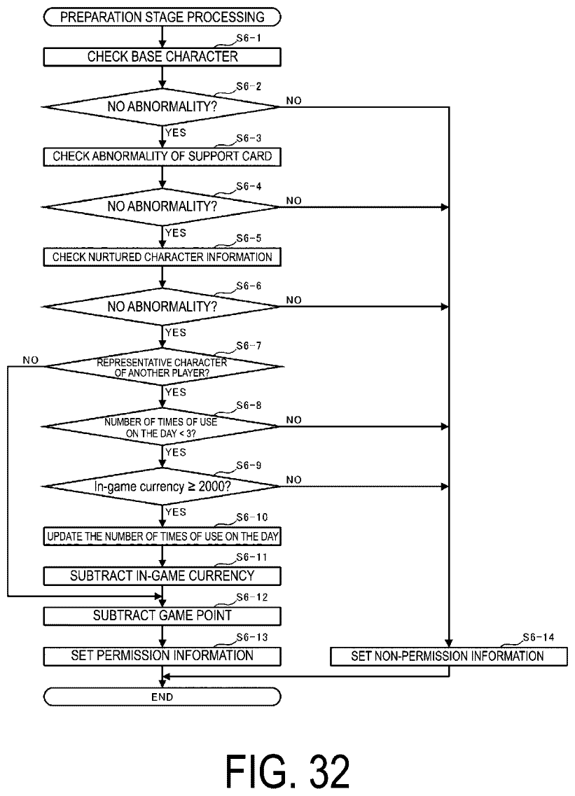

FIG. 32 is a flowchart for describing the preparation stage processing (S6) in the server 1000. The nurture game execution unit 1101a, when receiving the confirmation information, checks the base character of the player stored in the player information storage unit 1150 (S6-1). The nurture game execution unit 1101a determines that there is no abnormality when the nurture target character selected by the player is included in the base character (S6-2).

If there is no abnormality in the nurture target character selected by the player (YES in S6-2), the nurture game execution unit 1101a checks whether there is no abnormality in the support card selected by the player (S6-3). Note that in S6-3, it is determined that there is an abnormality when a support card that is not possessed by the player is selected, when a rental card selected by the player is not associated with the player ID of the player, when the support character duplicates the nurture target character, or the like.

If there is no abnormality in the support card selected by the player (YES in S6-4), the nurture game execution unit 1101a checks the nurtured character information stored in the game information storage unit 1151 (S6-5). Then, when the nurtured character selected as the inheritance character by the player is associated with the player ID of the player, that is, when the nurtured character nurtured by the player is selected as the inheritance character, the nurture game execution unit 1101a determines that there is no abnormality in the inheritance character (YES in S6-6).

When it is determined that there is no abnormality in the inheritance character, the nurture game execution unit 1101a determines whether a representative character of another player is included in the nurtured character selected as the inheritance character by the player includes (S6-7). When the representative character of another player is included (YES in S6-7), the nurture game execution unit 1101a determines whether the number of times of use on the day is less than three (S6-8).

When the number of times of use on the day is less than three (YES in S6-8), the nurture game execution unit 1101a determines whether a value of a predetermined in-game currency possessed by the player is 2000 or more (S6-9). That is, in the S6-8 and the S6-9, whether an organization condition is satisfied is determined. When the player possesses the value of the in-game currency of 2000 or more (YES in S6-9), the nurture game execution unit 1101a adds “1” to the number of times of use on the day (S6-10). The nurture game execution unit 1101a subtracts 2000 from the value of predetermined in-game currency possessed, which is stored in the player information storage unit 1150 (S6-11).

Further, the nurture game execution unit 1101a subtracts a predetermined value (for example, 30) from the game point of the player (S6-12). Then, when there is no abnormality in the nurture target character, the inheritance character, and the support card, and the organization condition for using the representative character of another player is satisfied, the nurture game execution unit 1101a sets the permission information (S6-13), and causes the player terminal 1 to receive the permission information. On the other hand, when there is an abnormality in any of the nurture target character, the inheritance character, and the support card, or when the organization condition for using the representative character of another player is not satisfied, the nurture game execution unit 1101a sets non-permission information (S6-14), and causes the player terminal 1 to receive the non-permission information. The player terminal 1, when receiving the non-permission information, displays the final confirmation screen 205 and presents a predetermined error notification.

Referring back to TIG. 30, when the preparation stage processing (P6, S6) ends, the nurture game execution unit 701a in the player terminal 1 executes the nurture stage processing (P7). Further, during the nurture stage processing, communication processing is executed between the player terminal 1 and the server 1000. In the server 1000, the nurture game execution unit 1101a executes the nurture stage processing based on the information received from the player terminal 1 (S7).

Hereinafter, the nurture stage processing (P7) executed in the player terminal 1 and the nurture stage processing (S7) executed in the server 1000 are described. However, here, for ease of understanding, the processing in the player terminal 1 and the processing in the server 1000 are described with the order thereof changed as appropriate.

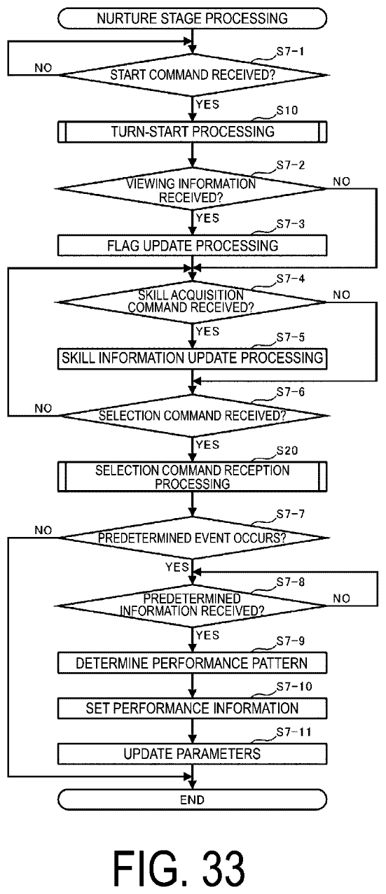

FIG. 33 is a flowchart for describing the nurture stage processing in the server 1000. The nurture game execution unit 1101a in the server 1000 waits for receiving a start command from the player terminal 1 (S7-1). Then, the nurture game execution unit 1101a, when receiving the start command (YES in S7-1), executes the turn-start processing (S10). Note that the start command is transmitted from the player terminal 1 to the server 1000, for example, when the process or performance related to the current turn is completed.

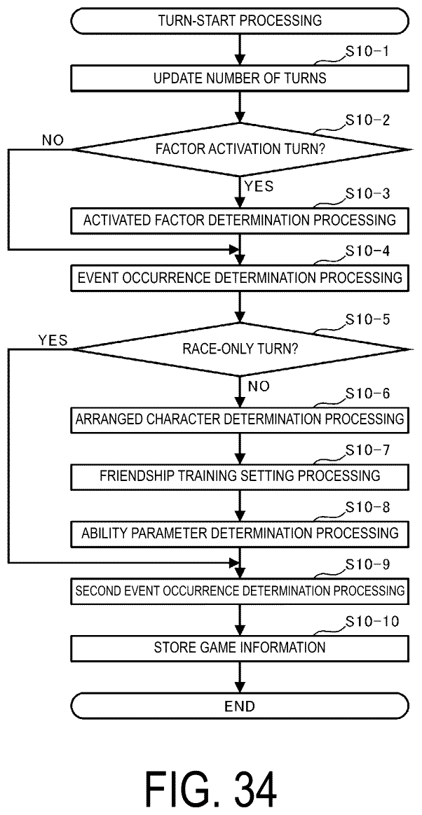

FIG. 34 is a flowchart for describing the turn-start processing in the server 1000. The nurture game execution unit 1101a in the server 1000 updates the current number of turns (S10-1). When the current turn is a factor activation turn (YES in S10-2), the nurture game execution unit 1101a executes activated factor determination processing (S10-3). Here, whether to activate the factor is determined for each registered inheritance character.

Next, the nurture game execution unit 1101a executes event occurrence determination processing (S10-4). Here, the nurture game execution unit 1101a determines an event to occur in the current turn, for the scenario event, the exclusive event, the first event, or the like. Note that the event determined here includes the above-described branching event. When a branching event in which a branch destination is determined through a lottery is determined to be performed, the branch destination, that is, a pattern of the branching event is also determined.

When the current turn is not a race-only turn (NO in S10-5), the nurture game execution unit 1101a executes arranged character determination processing (S10-6). Here, the nurture game execution unit 1101a determines whether to arrange and the training items to be arranged for each of the support character and the specific characters such as the story character based on the arrangement table (FIG. 25) through a lottery. At this time, when the training item to be arranged is determined, the nurture game execution unit 1101a stores the determined training item in association with the character.

Next, the nurture game execution unit 1101a executes friendship training setting processing (S10-7). Here, the “processing of setting the friendship training occurrence possible state” described with reference to FIG. 24 is executed. That is, the nurture game execution unit 1101a extracts a support character arranged in any one of the training items. Then, whether the setting conditions for the friendship training occurrence possible state are satisfied is determined for each of the extracted support characters. The nurture game execution unit 1101a associates the support character that satisfies the setting conditions for the friendship training occurrence possible state with friendship training occurrence information. In addition, the training item in which the support character that satisfies the setting conditions for the friendship training occurrence possible state is arranged is also associated with friendship training occurrence possible information.

Next, the nurture game execution unit 1101a executes ability parameter determination processing (S10-8). Here, the “processing of determining the increase value of the ability parameter” described with reference to FIG. 24 is executed. That is, the nurture game execution unit 1101a selects any one of five training items as a processing target. The nurture game execution unit 1101a obtains the training level of the ability parameter for the processing target and determines the fixed increase value.

The nurture game execution unit 1101a obtains the arrangement information of the arranged characters and determines the additional value. The nurture game execution unit 1101a determines whether other addition conditions are met, and determines the final increase value of the training item as the processing target based on the met addition conditions. The determination on the final increase value of the ability parameter is performed for each training item.

Note that an energy decrease amount or an energy recovery amount when each training item is performed is determined in the ability parameter determination processing although a detailed description is omitted. The nurture game execution unit 1101a calculates a failure rate of training for each training item based on the energy of the nurture target character.

Next, the nurture game execution unit 1101a executes the second event occurrence determination processing (S10-9). Here, the “processing of setting the occurrence possible state of the second event” described with reference to FIG. 24 is executed. That is, the nurture game execution unit 1101a determines whether to execute a support event set in advance for the support card associated with the training item through a lottery. Note that the support event also includes the above-described branching event. Therefore, as in S10-4, when a branching event in which a branch destination is determined through a lottery is determined to be performed, a pattern of the branching event is also determined.

Then, the nurture game execution unit 1101a saves the information determined in the above processing as the game information received by the player terminal 1 (S10-10).

Referring back to FIG. 33, the nurture game execution unit 1101a, when receiving the viewing information (YES in S7-2), executes flag update processing (S7-3). As will be described in detail below, in the player terminal 1, when the display of all the performance images ends, the turn is finished. In each turn, various events occur, and a performance image corresponding to the occurring event is displayed. When the occurring event is a not-yet-occurring event that has not occurred before, the player terminal 1 transmits the viewing information to the server 1000.

Here, the viewing information includes an event ID assigned to each event. The viewing information is transmitted together with the start command. However, a timing of transmitting the viewing information is not particularly limited. For example, the viewing information may be transmitted when various events occur. Alternatively, the viewing information may be collectively transmitted at the end of the nurture game.

The nurture game execution unit 1101a, when receiving the viewing information, executes processing of enabling the performance image corresponding to the event to be viewed outside the nurture game. In the server 1000, a viewing permission flag is managed for each event occurring during the nurture game. In the flag update processing, when the viewing information is received, the viewing permission flag for the occurring event is turned on. The viewing permission flag being turned on enables the player to view the performance image corresponding to the event outside the nurture game.

Note that here, the player terminal 1 determines whether the occurring event is a not-yet-occurring event, and transmits the viewing information to the server 1000. However, the server 1000 may determine whether the event is a not-yet-occurring event. In this case, the viewing information corresponding to all the occurring events is transmitted to the server 1000. Then, in the server 1000, the viewing permission flag for the not-yet-occurring event may be turned on based on the received viewing information.

When a skill acquisition command indicating that any base skill acquisition is received from the player terminal 1 (YES in S7-4), the skill information such as the acquisition information of the skill is updated (S7-5). Here, the acquired skill is associated with the acquisition information. Here, the nurture game execution unit 1101a subtracts the skill points required to acquire the skill from the skill points currently possessed. Here, the player terminal 1 is caused to receive the updated skill information. The server 1000 waits until receiving a selection command from the player terminal 1 (S7-6).

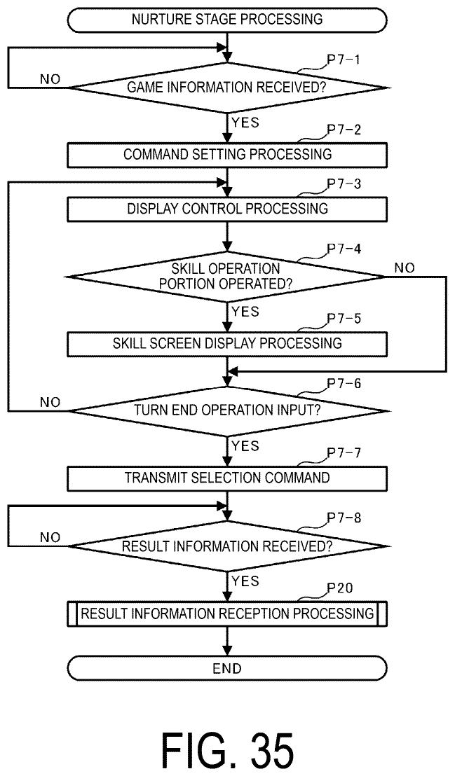

FIG. 35 is a flowchart for describing the nurture stage processing in the player terminal 1. The nurture game execution unit 701a in the player terminal 1 waits for receiving the game information from the server 1000 (P7-1). Then, the nurture game execution unit 701a, when receiving the game information (YES in P7-1), executes a command setting processing (P7-2). Here, the processing of setting a command that can be selected by the player is executed based on the current number of turns.

The nurture game execution unit 701a executes display control processing of displaying a game screen based on the received game information (P7-3). Here, the nurture game execution unit 701a displays the top screen 210, the training screen 220, and the like based on the received game information. To be specific, the nurture game execution unit 701a displays the arranged character icon 228 for each training item on the training screen 220. The nurture game execution unit 701a controls the display of the stats display portion 213. Further, the nurture game execution unit 701a displays effects on the operation portions corresponding to the training items set to the friendship training occurrence possible state and the training operation portion 216 on the top screen 210.

When the skill operation portion 217 is operated (YES in P7-4), the nurture game execution unit 701a executes skill screen display processing (P7-5). Here, the nurture game execution unit 701a obtains base skill information, hint information, and acquired skill information. Then, the nurture game execution unit 701a generates the skill screen 230 based on the obtained information. When a skill acquisition operation (tapping the determination operation portion 235a) for acquiring any base skill is input, the nurture game execution unit 701a transmits a skill acquisition command to the server 1000. Thereafter, the nurture game execution unit 701a, when receiving the skill information from the server 1000, updates skill-related information related to the skill.

The nurture game execution unit 701a switches the display screen of the display 26 based on the operation input of the player until a turn end operation is input (NO in P7-6). Here, the turn end operation is an operation of ending the current turn, and includes operations of the rest operation portion 215, the going out operation portion 218, the speed operation portion 221, the stamina operation portion 222, the power operation portion 223, the spirit operation portion 224, and the wisdom operation portion 225, an operation of determining a race event of a race, and the like.

When the turn end operation is input (YES in P7-6), the nurture game execution unit 701a transmits a selection command corresponding to the turn end operation input by the player to the server 1000 (P7-7). Thereafter, the player terminal 1 waits until receiving the result information from the server 1000 (NO in P7-8).

Referring back to FIG. 33, the nurture game execution unit 1101a, when receiving the selection command from the player terminal 1 (YES in S7-6), executes selection command reception processing (S20).

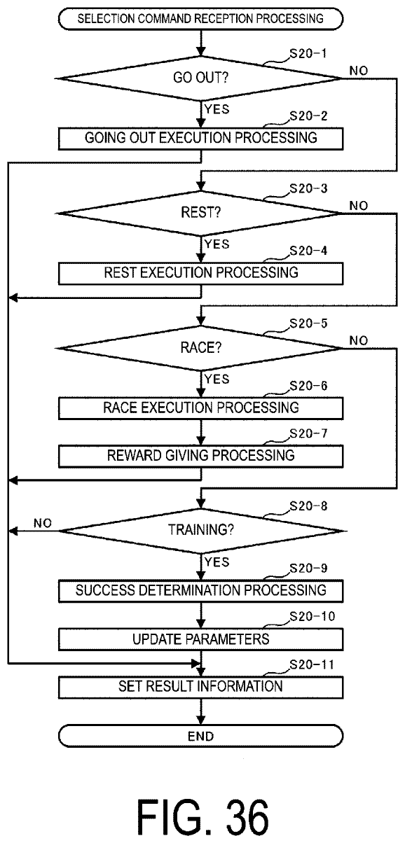

FIG. 36 is a flowchart for describing the selection command reception processing in the server 1000. The nurture game execution unit 1101a, when receiving a selection command indicating an operation input of the going out operation portion 218 (YES in S20-1), executes going out execution processing (S20-2). Here, a going out event is determined that increases the parameters of energy and mood. Further, the parameters of energy and mood are updated based on the determined going out event.

The nurture game execution unit 1101a, when receiving a selection command indicating an operation input of the rest operation portion 215 (YES in S20-3), executes rest execution processing (S20-4). Here, a rest event is determined that increases the parameter of energy. Further, the parameter of energy is updated based on the determined rest event.

The nurture game execution unit 1101a, when receiving a selection command indicating an operation input to start a race (YES in S20-5), executes race execution processing (S20-6). Here, a race simulation is performed based on the parameters for the nurture target character and the NPCs that enter the race. Further, the nurture game execution unit 1101a executes reward giving processing of giving a reward to the player (S20-7). Here, a reward is determined based on the result of the simulation, that is, the placing, the race development, and the like of the nurture target character, and the determined reward is given to the player.

The nurture game execution unit 1101a, when receiving a selection command indicating that any training is to be performed (YES in S20-8), executes success determination processing (S20-9). Here, the success or failure of the training is determined based on the failure rate calculated in advance. Then, the nurture game execution unit 1101a updates various parameters based on the determination result of S20-9 (S20-10).

Here, the ability parameters and the like are updated as determined in S10-8 upon starting of the training. Here, the value of the bond parameter for the arranged character is updated. Then, the nurture game execution unit 1101a sets the result information including the results of the outing execution processing, the rest execution processing, the race execution processing, the reward giving processing, and the success determination processing, and the various updated information, and causes the player terminal 1 to receive the result information (S20-11).

Referring back to FIG. 35, when the player terminal 1 receives the result information from the server 1000 (YES in P7-8), the nurture game execution unit 701a executes result information reception processing (P20).

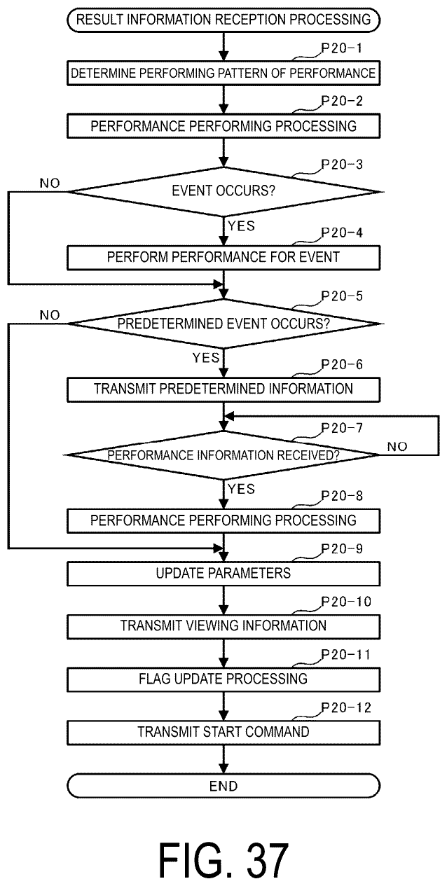

FIG. 37 is a flowchart for describing the result information reception processing in the player terminal 1. The nurture game execution unit 701a determines a performing pattern of the performance based on the received result information (P20-1). Then, the nurture game execution unit 701a performs the performance in the performing pattern determined in P20-1 (P20-2). Here, when the training for which the friendship training occurrence possible state is set is successful, the friendship training-dedicated performance is performed.

To be specific, in P20-1, the nurture game execution unit 701a identifies a character that is associated with the successful training item and is associated with the friendship training occurrence possible information. Then, the nurture game execution unit 701a determines a performing pattern of the friendship training-dedicated performance corresponding to the specified character and the performed training item. In the friendship training-dedicated performance determined at this time, the character associated with the friendship training occurrence possible information is displayed.

In addition, in a case where an event such as the second event occurs after the selection item is selected (YES in P20-3), the nurture game execution unit 701a performs a performance for the event to occur (P20-4). Note that when the selection event occurs, the nurture game execution unit 701a performs a performance to cause the player to select an option.

Here, the events to occur include the selection event, the branching event, and the mini-game event described above. These events are common in that the pattern to be executed changes depending on the operation by the player, the parameter at the time of the event occurrence, and the like. In this way, when the predetermined event in which the pattern changes occur (YES in P20-5), the nurture game execution unit 701a transmits predetermined information to the server 1000 (P20-6).

Here, for example, when the selection event occurs, information indicating the option selected by the player is transmitted as the predetermined information. Further, for example, when the branching event in which the pattern is determined based on the parameter occurs, information corresponding to the pattern to be executed is transmitted as the predetermined information. When the mini-game event occurs, processing of causing the player to play the mini-game is executed. Then, information indicating the result of the mini-game is transmitted as the predetermined information.

Referring back to FIG. 33, when a predetermined event occurs (YES in S7-7), the server 1000 waits for receiving the predetermined information from the player terminal 1 (S7-8). The nurture game execution unit 1101a, when receiving the predetermined information, determines a performance pattern based on the received predetermined information (S7-9). The nurture game execution unit 1101a sets the performance information indicating the performance pattern determined in S7-9, and causes the player terminal 1 to receive the performance information (S7-10). The nurture game execution unit 1101a updates the parameter according to the parameter update condition for the determined performance pattern (S7-11).

Referring back to FIG. 37, the nurture game execution unit 701a, when receiving the performance information from the server 1000 (YES in P20-7), executes performance performing processing (P20-8). Here, the performance image is displayed based on the received performance information.

The nurture game execution unit 701a updates the parameters based on the received result information and performance information (P20-9). The nurture game execution unit 701a determines whether the events occurring in the turn includes a not-yet-occurring event. Then, when the occurring events include a not-yet-occurring event, the nurture game execution unit 701a transmits the viewing information described above to the server 1000. This turns on the viewing permission flag in the server 1000 in the flag update processing in S7-3.

Further, the nurture game execution unit 701a executes the flag update processing (P20-11). Here, when a not-yet-occurring event occurs, the viewing permission flag for the occurring event is turned on. Note that when the not-yet-occurring event is a support event, the viewing information may not be transmitted in P20-10 and the viewing permission flag may not be turned on in P20-11 although details will be described later.

In the present embodiment, the viewing permission flag is updated in both the player terminal 1 and the server 1000. However, the viewing permission flag may be updated only in one of the player terminal 1 and the server 1000.

Then, when all the performances to be performed in the current turn ends, the nurture game execution unit 701a transmits a start command to the server 1000 (P20-12). As a result, the current turn is finished in the player terminal 1. Then, when the server 1000 receives the start command, the processing related to the next turn is executed by the same processing as described above.

Referring back to FIG. 30, in the server 1000, when the nurture stage processing (S7) ends, the nurture game end processing unit 1102a executes nurture game end processing (S8).

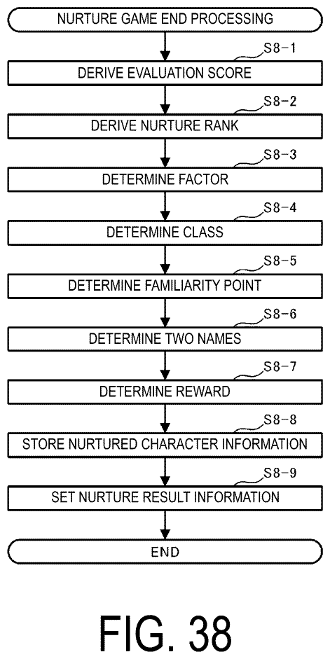

FIG. 38 is a flowchart for describing the nurture game end processing in the server 1000. The nurture game end processing unit 1102a derives the evaluation score based on various parameters for the nurture target character (S8-1). The nurture game end processing unit 1102a derives the nurture rank based on the derived evaluation score (S8-2).

In addition, the nurture game end processing unit 1102a determines the factor to be obtained by the nurtured character (S8-3). The nurture game end processing unit 1102a determines the class based on the number of obtained fans (S8-4). The nurture game end processing unit 1102a determines a familiarity point based on a predetermined parameter such as the nurture rank or the number of fans (S8-5). Note that the familiarity point is a point given not to the nurtured character but to a character that is a source of the nurtured character although a detailed description is omitted.

A plurality of story screens are provided for each character, and an unlock condition is set for some of the story screens. Some story screens have the familiarity point set as the unlock condition, and the player can watch the story screen when the friendliness point is equal to or greater than a threshold value.

The nurture game end processing unit 1102a determines two names (S8-6). Here, the condition achieved in the nurture main game is confirmed, and two names to be obtained by the nurtured character are determined. Further, the nurture game end processing unit 1102a determines a reward to be given to the player (S8-7). The nurture game end processing unit 1102a stores, in the game information storage unit 1151, the nurtured character information including the evaluation score, the nurture rank, the ability parameter, the aptitude parameter, the acquired skill, the inheritance information, the factor information, the class, the two names, and the like in association with the player ID of the player (S8-8). The nurture game end processing unit 1102a sets nurture result information and causes the player terminal 1 to receive the nurture result information (S8-9).

Referring back to FIG. 30, when the player terminal 1 receives the nurture result information, the nurture completion time processing unit 702a executes the nurture game end processing (P8). Here, the nurture completion time processing unit 702a stores the received nurture result information in the game information storage unit 751. The nurture completion time processing unit 702a displays the nurture completion screen 330 (see FIG. 27A, FIG. 27B, and FIG. 27C) on the display 26 based on the nurture result information.

The above-described nurture game is achieved in the above-described processing. In addition, the nurtured character information relating to the nurtured character nurtured (created) in the nurture game is stored in association with the player ID. The above-described processing in the player terminal 1 and the server 1000 is merely an example. Further, each of the processes described above may be executed only by the player terminal 1 or only by the server 1000.

In the nurture game, the parameters for the nurture target character are updated as described above. During the nurture game, various events occur, and the performance images corresponding to the events area displayed. Since the player can see various performance images during the nurture game, the interest in the game is improved. However, in the present embodiment, an event for which a parameter update condition is set, particularly an event disadvantageous to the player, is provided.

Due to the characteristics of the nurture game, it is extremely difficult for the player to intentionally cause a disadvantageous event to appear only in order to see the performance image. For example, as described above, it is difficult to intentionally fail the mini-game or to intentionally select an option for which a disadvantageous parameter update condition is set when a selection event occurs.

In addition, for example, a plurality of events may be different in the types of parameters to be updated. In the nurture game, the player proceeds with the game according to a nurture policy of the player. Therefore, depending on the nurture policy of the player, the selected event may be fixed among the plurality of events. As a result, the same performance image is always displayed for some events, which may reduce the interest in the game.

Therefore, in the present embodiment, a gallery function is provided that enables the player to view, outside the nurture game, the performance image of the event that has appeared during the nurture game. This gallery function enables the player to repeatedly view the performance image corresponding to the performance pattern having occurred during the nurture game any time and any number of times. In addition, the gallery function enables the player to view a performance image corresponding to a performance pattern having not occurred during the nurture game by spending a predetermined item. Hereinafter, the gallery function is described in detail.

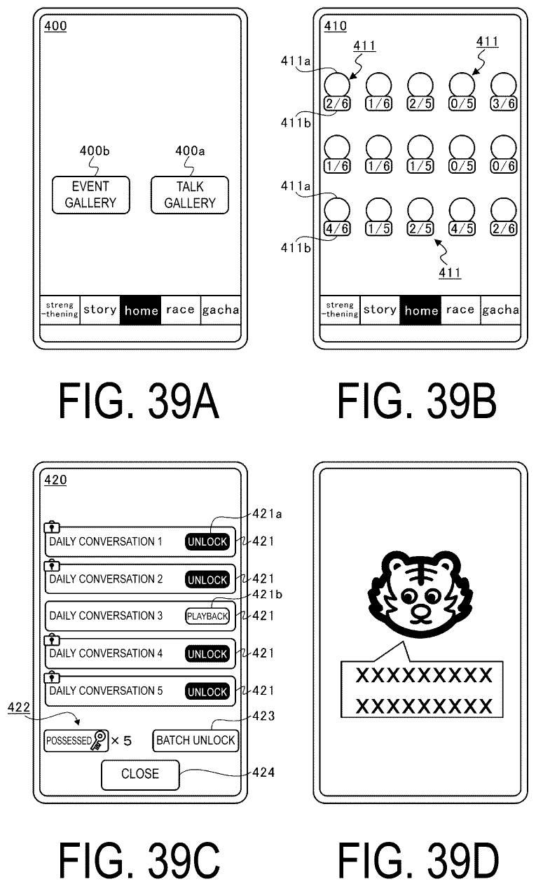

FIG. 39A is a diagram for describing an example of the gallery screen 400. When the gallery operation portion 110b on the option setting screen 110 illustrated in FIG. 3B is tapped, the gallery screen 400 illustrated in FIG. 39A is displayed. On the gallery screen 400, a talk gallery operation portion 400a and an event gallery operation portion 400b are displayed. When the event gallery operation portion 400b is tapped, a character selection screen 410 is displayed.

FIG. 39B is a diagram for describing the character selection screen 410 for the talk gallery. A plurality of selection images 411 are displayed on the character selection screen 410. The selection image 411 is provided for each character. The selection image 411 includes a character icon 411a and an unlock number display portion 411b. Various characters are randomly displayed on the home screen 100 although detailed description is omitted.

For example, when the home screen 100 is displayed for the first time after login, a plurality of characters are arranged and displayed at random on the home screen 100. In addition, when the screen transitions from a predetermined game screen to the home screen 100, for example, after the nurture game ends, the characters are randomly arranged and displayed. The home screen 100 is a screen displayed outside the nurture game. When the character displayed on the home screen 100 is tapped, a talk image provided for each character is displayed. The content of the talk image is various, and for example, the talk image includes an image in which the character talks to the player.

The character icon 411a is configured to be able to distinguish a face of the character displayed on the home screen 100. On the character selection screen 410, the selection images 411 corresponding to all the characters displayed on the home screen 100 are displayed. Note that in the present embodiment, the player can possess the character card as described above. The character associated with the character card is a character that can be set as a nurture target character.

The characters displayed on the home screen 100 include the character associated with character card. Therefore, the selection image 411 corresponding to the character that can be set as the nurture target character is displayed on the character selection screen 410. However, the home screen 100 may include the selection image 411 corresponding to a character that cannot be set as a nurture target character.

The player can also possess a character card obtained via a successful lottery (gacha) that can be executed by spending the in-game currency. Therefore, the player does not necessarily possess all the character cards provided by the operator. The characters arranged on the home screen 100 are determined regardless of whether the player possesses a character card. In other words, the home screen 100 also displays a character associated with a character card that is not possessed by the player. Therefore, the selection images 411 corresponding to the character that can be displayed on the home screen 100 is displayed on the character selection screen 410 regardless of whether the player possesses or does not possess a character card.

A plurality of talk images are provided for the character displayed on the home screen 100. When a character image displayed on the home screen 100 is tapped, any of the plurality of talk images provided for the character is displayed at random. Each talk image is unlocked by being displayed on the home screen 100. The talk image can be viewed via the gallery function for the first time after unlocked.

Therefore, the talk image that has not been displayed on the home screen 100 is maintained in a not-yet-unlocked state and cannot be viewed via the gallery function. In the unlock number display portion 411b, the number of talk images provided for each character is displayed in a denominator, and the number of unlocked talk images is displayed in a numerator.

The selection image 411 functions as an operation portion that receives a selection operation on a character by the player. That is, the player can select a character by tapping the selection image 411. When the selection image 411 is tapped, a talk image selection screen 420 is displayed.

FIG. 39C is a diagram for describing the talk image selection screen 420. FIG. 39D is a diagram for describing the talk image. A plurality of selection operation portions 421 may be displayed on the talk image selection screen 420. The plurality of selection operation portions 421 are associated with the talk images of the characters selected on the character selection screen 410. The selection operation portion 421 displays a name set for each talk image. The selection operation portion 421 is provided with either an unlock button 421a or a playback button 421b.

The selection operation portion 421 associated with the talk image in the not-yet-unlocked state is provided with the unlock button 421a. In addition, a key mark is displayed to be superimposed on an upper left of the selection operation portion 421 associated with the talk image in the not-yet-unlocked state. On the other hand, the selection operation portion 421 associated with the unlocked talk image is provided with the playback button 421b.

When the playback button 421b is tapped, a talk image is displayed as illustrated in FIG. 39D. The talk image displayed by tapping the playback button 421b is the same as the talk image displayed by tapping the character displayed on the home screen 100. In this manner, the player can view the talk image by tapping the playback button 421b of the selection operation portion 421 on the talk image selection screen 420.

On the other hand, the selection operation portion 421 corresponding to the talk image in the not-yet-unlocked state is not provided with the playback button 421b. Therefore, the player cannot view the talk image in the not-yet-unlocked state. However, the player can unlock the talk image in the not-yet-unlocked state by spending an unlock item.

To be more specific, when the unlock button 421a is tapped, an unlock confirmation dialog (not illustrated) is displayed. The unlock confirmation dialog displays a message indicating that an unlock item is spent and a talk image can be viewed by the unlock. Then, when an execution button provided in the unlock confirmation dialog is tapped, a status of the talk image is updated to “unlocked”. At this time, the number of unlock items possessed is decreased. Accordingly, the unlock button 421a of the selection operation portion 421 is changed to the playback button 421b, and the player can view the unlocked talk image thereafter.

Note that the unlock item for unlocking the talk image may be given to the player as a reward of the nurture game, for example. In addition, for example, the unlock item may be purchasable using the in-game currency. Furthermore, the unlock item may be distributed free of charge from the operator, or may be possessed by being exchanged with another item.

As illustrated in FIG. 39C, the talk image selection screen 420 is provided with a possession number display portion 422. The possession number display portion 422 displays the number of unlock items currently possessed by the player. In addition, the talk image selection screen 420 is provided with a batch unlock button 423. When the batch unlock button 423 is tapped, a batch unlock screen (not illustrated) is displayed. On the batch unlock screen, the player can select a plurality of talk images in the not-yet-unlocked state. Then, when the execution button is tapped in a state where the plurality of talk images in the not-yet-unlocked state are selected, the statuses of all the selected talk images are updated to “unlocked”. At this time, the number of unlock items possessed is decreased by the same number as the number of unlocked talk images. Note that when a close button 424 provided on the talk image selection screen 420 is tapped, the talk image selection screen 420 is hidden.

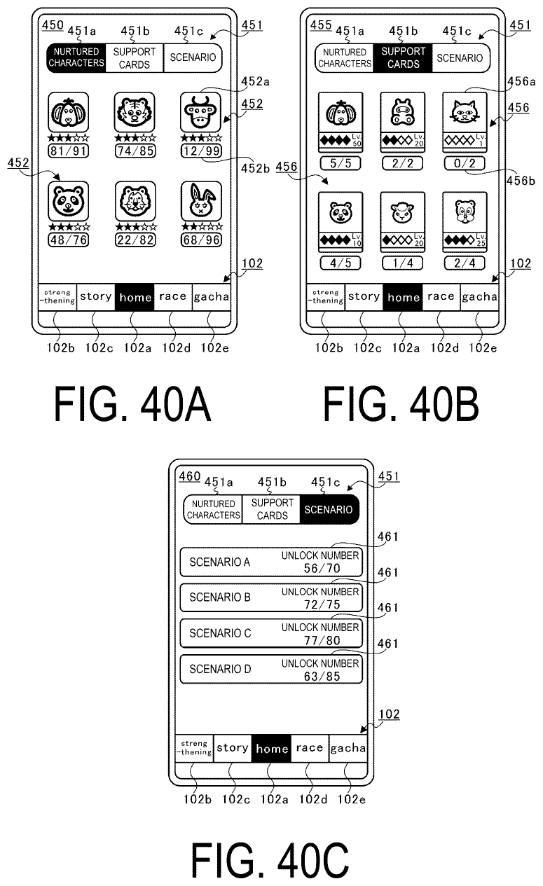

FIG. 40A is a diagram for describing a character selection screen 450 for event gallery. FIG. 40B is a diagram for describing a support card selection screen 455 for event gallery. FIG. 40C is a diagram for describing a scenario selection screen 460 for event gallery. When the event gallery operation portion 400b is tapped on the gallery screen 400, the character selection screen 450 illustrated in FIG. 40A is displayed. The character selection screen 450 is provided with a switching tab 451. The switching tab 451 is provided with a character selection portion 451a, a support card selection portion 451b, and a scenario selection portion 451c.

When the support card selection portion 451b of the switching tab 451 is tapped, the support card selection screen 455 is displayed. When the scenario selection portion 451c of the switching tab 451 is tapped, the scenario selection screen 460 is displayed. The character selection screen 450 displays a plurality of selection images 452. The selection image 452 is provided for each character card possessed by the player.

The selection image 452 includes a character icon 452a and an unlock number display portion 452b. Note that although six selection images 452 are displayed in FIG. 40A, other selection images 452 are further displayed on the character selection screen 450 by scrolling the character selection screen 450 upward.

The character icon 452a is configured to be able to distinguish a face of the character associated with the character card. The character selection screen 450 displays the selection images 452 corresponding to all the character cards possessed by the player. Therefore, the character selection screen 450 does not display the selection image 452 corresponding to the character card not possessed by the player.

However, the selection image 452 corresponding to the character card not possessed by the player may be displayed. In this case, the selection image 452 may be displayed so that the character card possessed by the player can be distinguished from the character cards not possessed by the player.

Note that the character cards include a plurality of character cards that are associated with different character card IDs and are associated with the same character ID. The plurality of character cards associated with the same character ID are, for example, character cards different in costumes. The character cards different in costumes are associated with different character card IDs. For these character cards different in costumes, the costumes of the nurture target character when displayed during the nurture game or the like are different, for example.

As described above, various parameters upon the registration as the nurture target character are set in each character card. For the character cards different in costumes, the parameters set for the nurture target character are different from each other. Further, an event that may occur during the nurture game is set in each character card although details will be described later. Events that are partially different from each other are set for the character cards different in costumes. However, the character itself that wears the costumes, that is, a body (face, body shape) of the character is common to the character cards different in costumes.

The selection image 452 is provided for each of the plurality of character cards that are different in costumes and associated with the same character ID.

In the unlock number display portion 452b, the number of events provided for each character card is displayed in a denominator, and the number of unlocked events is displayed in a numerator. In the unlock number display portion 452b, the number of events corresponding to the gallery function among the events set for the character card is displayed. Note that the events provided for each character card may include an event that does not correspond to the gallery function.

The selection image 452 functions as an operation portion that receives a selection operation on a character card by the player. That is, the player can select a character card, in other words, a character associated with the character card by tapping the selection image 452. When the selection image 452 is tapped, an event selection dialog 470 is displayed.

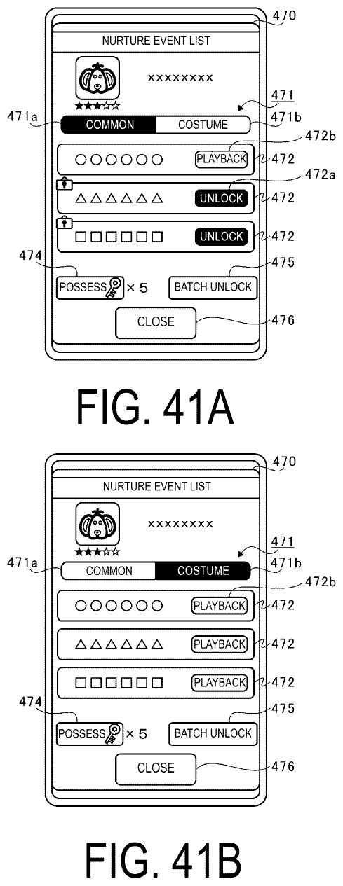

FIG. 41A is a first diagram for describing the event selection dialog 470. FIG. 41B is a second diagram for describing the event selection dialog 470. In an upper portion of the event selection dialog 470, an icon corresponding to the character card and a character card name are displayed. The event selection dialog 470 is also provided with a switching tab 471. The switching tab 471 is provided with a common operation portion 471a and a costume operation portion 471b.

Here, the events set for the character cards, in other words, the events set for the characters associated with the character cards, are classified into common events and costume-specific events. For example, the same common event is set for a plurality of character cards different in costumes. On the other hand, different costume-specific events are set for a plurality of character cards different in costumes.

The event selection dialog 470 displays a plurality of selection operation portions 472. Each of the plurality of selection operation portions 472 is associated with any event that may occur during the nurture game. The selection operation portion 472 displays a name set for each event. The selection operation portion 472 is provided with either an unlock button 472a or a playback button 472b.

Here, as illustrated in FIG. 41A, in a state where the common operation portion 471a is selected, the selection operation portion 472 is associated with a common event. On the other hand, as illustrated in FIG. 41B, in a state where the costume operation portion 471b is selected, the selection operation portion 472 is associated with a costume-specific event.

As described above, in the nurture game, when an event occurs and a performance image is displayed, the viewing permission flag is turned on. The viewing permission flag being turned on unlocks a right to view the performance image via the gallery function. On the other hand, in a state where the viewing permission flag is off, the performance image cannot be viewed via the gallery function. That is, an event of which the viewing permission flag is off can be said to be in the not-yet-unlocked state.

The selection operation portion 472 associated with the event in the not-yet-unlocked state is provided with the unlock button 472a. In addition, a key mark is displayed to be superimposed on an upper left of the selection operation portion 472 associated with the event in the not-yet-unlocked state. On the other hand, the selection operation portion 472 associated with the unlocked event is provided with the playback button 472b.

When the playback button 472b is tapped, a performance image is displayed. The performance image displayed when the playback button 472b is tapped is the same as the performance image displayed when an event occurs during the nurture game. In this manner, the player can view the performance image for the event by tapping the playback button 472b of the selection operation portion 472 in the event selection dialog 470.

On the other hand, the selection operation portion 472 corresponding to the event in the not-yet-unlocked state is not provided with the playback button 472b. Therefore, the player cannot view the performance image of the event in the not-yet-unlocked state. However, the player can unlock the performance image of the event in the not-yet-unlocked state by spending an unlock item.

To be more specific, when the unlock button 472a is tapped, an unlock confirmation dialog (not illustrated) is displayed. The unlock confirmation dialog displays a message indicating that an unlock item is spent and a performance image of an event can be viewed by the unlock. Then, when the execution button provided in the unlock confirmation dialog is tapped, the viewing permission flag for the event is updated from off to on. At this time, the number of unlock items possessed is decreased. Accordingly, the unlock button 472a of the selection operation portion 472 is changed to the playback button 472b, and the player can view the performance image of the unlocked event thereafter.

Note that here, the unlock item for unlocking the event is the same as the item for unlocking the talk image. However, the unlock item for unlocking the event and the unlock item for unlocking the talk image may be different from each other.

As illustrated in FIGS. 41A and 41B, the event selection dialog 470 is provided with a possession number display portion 474. The possession number display portion 474 displays the number of unlock items currently possessed by the player. The event selection dialog 470 is also provided with a batch unlock button 475. When the batch unlock button 475 is tapped, a batch unlock screen (not illustrated) is displayed. On the batch unlock screen, the player can select a plurality of events in the not-yet-unlocked state. Then, when the execution button is tapped in a state where the plurality of events in the not-yet-unlocked state are selected, the viewing permission flags for all the selected events are turned and the statuses of the events are updated to “unlocked”. At this time, the number of unlock items possessed is decreased by the same number as the number of unlocked events. Note that when a close button 476 provided on the event selection dialog 470 is tapped, the event selection dialog 470 is hidden.

As illustrated in FIG. 40B, the support card selection screen 455 displays a plurality of support card selection images 456. The support card selection image 456 is provided for each support card possessed by the player. The support card selection image 456 includes a card icon 456a and an unlock number display portion 456b.

The card icon 456a is configured to be able to distinguish the support card. The support card selection screen 455 displays the support card selection images 456 corresponding to all the support cards possessed by the player. Therefore, the support card selection screen 455 does not display the support card selection image 456 corresponding to the support card not possessed by the player. In the unlock number display portion 456b, the number of support events set for the support card is displayed in a denominator, and the number of unlocked support events is displayed in a numerator.

The support card selection image 456 receives a selection operation of selecting a support card by the player. When a support card is selected on the support card selection screen 455, a support event selection dialog (not illustrated) is displayed. A basic screen configuration and a function of the support event selection dialog are the same as those of the event selection dialog 470. Therefore, the player can view and unlock the support event in the support event selection dialog. Note that the unlock item necessary for unlocking the support event may be the same as or different from the unlock item necessary for unlocking the event set for the character card.

As illustrated in FIG. 40C, the scenario selection screen 460 displays a plurality of scenario selection images 461. The scenario selection image 461 is provided for each scenario of the nurture game provided by the operator. The scenario selection image 461 displays a scenario name. In the scenario selection image 461, the number of scenario events set for the scenario is displayed in a denominator, and the number of unlocked scenario events is displayed in a numerator.

The scenario selection image 461 receives a selection operation of selecting a scenario by the player. When a scenario is selected in the scenario selection image 461, a scenario event selection dialog (not illustrated) is displayed. A basic screen configuration and a function of the scenario event selection dialog are the same as those of the event selection dialog 470. Therefore, the player can view and unlock the scenario event in the scenario event selection dialog. Note that the unlock item necessary for unlocking the scenario event may be the same as or different from the unlock item necessary for unlocking the event set for the character card.

As described above, the gallery function makes it possible to view and unlock the event set for the character card (nurture target character), the support event set for the support card, and the scenario event set for the scenario. The viewing and unlocking of each event are managed by use of the viewing permission flag in the player terminal 1 and the server 1000. Hereinafter, the viewing permission flag is described in detail.

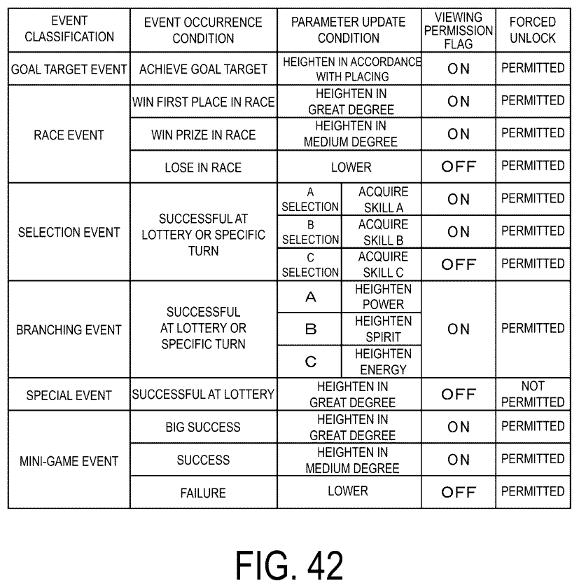

FIG. 42 is a diagram for describing the viewing permission flag for the event set for the character card. As illustrated in FIG. 42, the player terminal 1 and the server 1000 are provided with view data that is associated with the viewing permission flag for each type of event. In the view data, the viewing permission flags for all events are initially set to be off. Then, when an event occurs during the nurture game, the viewing permission flag for the occurring event is updated to be on.

Further, the player terminal 1 and the server 1000 are provided with forced unlock data indicating whether to perform forced unlock for each type of event. The forced unlock data includes information indicating whether an event can be unlocked by use of an unlock item. In FIG. 42, the viewing permission flag for an event for which the forced unlock is set to “permitted” can be updated to be on by use of the unlock item. On the other hand, for an event for which the forced unlock is set to “not permitted”, the unlock item cannot be used.

In the example illustrated in FIG. 42, the use of the unlock item is restricted in the special event. Therefore, in order to view the performance image of the special event via the gallery function, the special event is required to occur during the nurture game.

Note that the selection event is provided with the viewing permission flag for each option. Therefore, for example, the event selection dialog 470 illustrated in FIG. 41A is provided with the selection operation portion 472 for each option. To be more specific, when the playback button 472b of the selection event is tapped in the case where an option A is selected, a performance image displayed when the option A is selected is displayed. Additionally, when the playback button 472b of the selection event is tapped in the case where an option B is selected, a performance image displayed when the option B is selected is displayed.

However, one viewing permission flag may be provided for one selection event. In this case, the event selection dialog 470 is provided with one selection operation portion 472 corresponding to the selection event. Then, when the selection operation portion 472 is tapped, the player may be allowed to select an option, and a performance image corresponding to the selected option may be displayed, as during the nurture game. Alternatively, when the selection operation portion 472 is tapped, an option may be randomly determined, and a performance image corresponding to the determined option may be displayed.

The mini-game event is also provided with the viewing permission flag for each result of a mini-game. However, as in the case of the selection event described above, one viewing permission flag may be provided for one mini-game event. Then, when the selection operation portion 472 is tapped, the player may be allowed to select any one of three patterns, and a performance image corresponding to the selected pattern may be displayed. Alternatively, when the selection operation portion 472 is tapped, any one of the patterns may be randomly determined, and a performance image corresponding to the determined pattern may be displayed.

Note that in the gallery function, only the performance image of the mini-game event is displayed, and the mini-game is not played. However, the mini-game may be playable also in the gallery function.

As described above, for the branching event, a common performance image is displayed until the branch point, and a plurality of patterns of performance images are provided after the branch point. When a branching event occurs during the nurture game, the pattern after the branching point is determined based on the result of the lottery or the stats of the nurture target character. However, the branching event is provided with one viewing permission flag. Therefore, for example, the event selection dialog 470 illustrated in FIG. 41A is provided with only one selection operation portion 472 corresponding to the branching event.

Then, when the playback button 472b of the selection operation portion 472 is tapped, the pattern after the branch point is determined at random, and a performance image corresponding to the determined pattern is displayed. However, the branching event may be provided with the viewing permission flag for each pattern after the branch point, as in the selection event described above. In this case, the player can select a pattern after the branch point and then view the performance image.

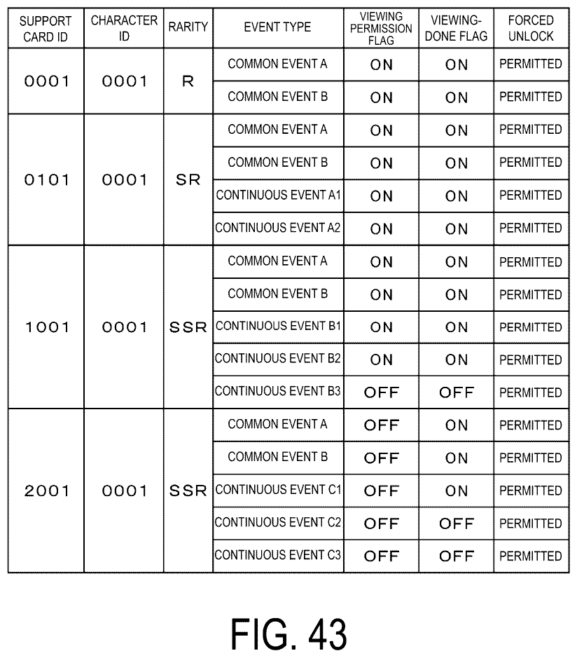

FIG. 43 is a diagram for describing the viewing permission flag for the support event. As illustrated in FIG. 43, the player terminal 1 and the server 1000 are provided with view data that is associated with the viewing permission flag and a viewing-done flag for each type of support event. In the view data, the viewing permission flags and the viewing-done flags for all the support events are initially set to be off. Then, when a support event occurs during the nurture game, the viewing-done flag for the occurring event is updated to be on. That is, the viewing-done flag is information for identifying whether a support event has occurred or a performance image has been viewed during the nurture game.

Here, as described above, in the setting game of the nurture game, the player can organize six support cards into the deck. One of the support cards is a rental card rented from another player such as a friend. In the nurture game, a support event set for a support card not organized into the deck may occur. Specifically, in the nurture game, in the case of a successful lottery, a support event set for a support card not possessed by the player.

In other words, in the nurture game, the support event set for the support card not organized into the deck occurs at a predetermined probability. Note that the occurrence probability of the support event set for the support card not organized into the deck is lower than an occurrence probability of the support event set for the support card organized into the deck. However, the occurrence probabilities of the support events set for the respective support cards may be the same regardless of whether the support cards are organized into the deck.

As described above, in the present embodiment, the support event set for the support card not possessed by the player may occur during the nurture game. In the gallery function, the player can view only the support event set for the support card possessed by the player. Therefore, in the nurture game, when a support event set for a support card not possessed by the player occurs, the viewing permission flag is not updated to be on.

On the other hand, after a support event set for a support card that is not possessed by the player occurs, the player may possess the support card afterward. In this case, the player has already caused the support event to occur that is set for the support card the player newly possesses. In such a case, the viewing permission flag is turned on based on the player possessing the support card.

Therefore, when a support event having not occurred occurs, the viewing-done flag is turned on in the flag update processing in P20-11 and S7-3 in the player terminal 1 and the server 1000, respectively. At this time, if the player possesses the support card associated with the occurring support event, the viewing permission flag is also turned on. This allows the player to view the performance image of the occurring support event.

On the other hand, when the player does not possess the support card associated with the occurring support event, the viewing-done flag is turned on, but the viewing permission flag is maintained to be off. Thus, even if a support event set for a support card not possessed by the player occurs, the right to view the performance image via the gallery function is not unlocked.

Then, when the player possesses the support card afterward, the viewing-done flag for the newly possessed support card is referred to. At this time, the viewing permission flag for the support event for which the viewing-done flag is on is turned on. Accordingly, at the time when the support card is possessed, the right to view the support event that has been caused to occur is unlocked.

Note that the player can unlock the right to view also for the support event having not occurred by use of the unlock item. However, the unlock item can be used only for the support event set for the support card possessed by the player. When the unlock item is used, the viewing permission flag for the support event selected by the player is turned on.

Here, the support card is associated with the character ID. The support card includes a plurality of support cards associated with the same character ID. For example, FIG. 43 illustrates four support cards associated with the character ID “0001”. The rarity is set for each support card. Here, three stages of rarities, R, SR, and SSR, are provided.

Two support events are set for the support card of rarity=R. The support events are roughly classified into common events and continuous events. All the support events set for the support card of rarity=R are the common events. Four support events are set for the support card of rarity=SR. Two common events and two continuous events are set for the support card of rarity=SR.

In addition, five support events are set for the support card of rarity=SSR. Two common events and three continuous events are set for the support card of rarity=SSR.

As illustrated in FIG. 43, the same common event is set for all of the plurality of support cards associated with the same character ID. In addition, different continuous events are set for the support cards of the rarity is SR or SSR. The continuous events are support events of which the order of occurrence is defined. For example, continuous events B1, B2, and B3 are set for the support card having the support card ID “1001”.

In the nurture game, in the case of a successful lottery, the continuous event B1 appears. After the continuous event B1 appears, the continuous event B2 can appear only in the case of a successful lottery. Further, after the continuous event B2 appears, the continuous event B3 can appear only in the case of a successful lottery. As described above, the continuous events include a plurality of events, and the appearance order of the events is defined. In this manner, in the continuous events, the event of which the appearance order is later appears in the nurture game with the lower possibility. In contrast, the common event is an event of which the order of appearance is not defined.

In the present embodiment, the right to view the continuous events can be unlocked by use of the unlock item. Therefore, even for the continuous events that are less likely to appear in the nurture game, the performance images can be viewed via the gallery function. This improves the interest in the game.

Note that the content of the event described above is merely an example. For example, assume that neither of the continuous events A1 and A2 illustrated in FIG. 43 has occurred. In this case, only the continuous event A2 can be unlocked without unlocking the continuous event A1 by use of the unlock item. However, for the continuous events, the unlock item may be usable under a condition that the event of which the order of appearance is earlier is unlocked.

Hereinafter, processing relating to the gallery function of the player terminal 1 and the server 1000 is described. Note that, here, among the processing relating to the gallery function, processing relating to the event gallery is described, and a description of processing relating to the talk gallery is omitted.

### Processing of Player Terminal 1 and Server 1000 Processing Related to Gallery Function

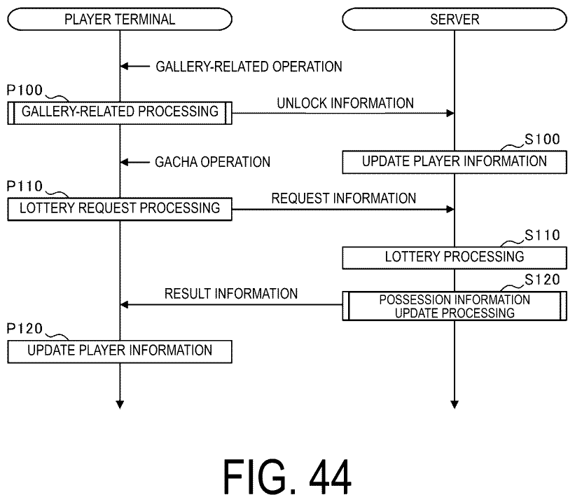

FIG. 44 is a sequence diagram for describing processing related to the gallery function of the player terminal 1 and the server 1000. When the player performs a gallery-related operation in the player terminal 1, the gallery processing unit 703a of the player terminal 1 performs gallery-related processing (P100). The gallery-related operation is an operation input on, for example, the gallery screen 400, the character selection screen 450, the support card selection screen 455, the scenario selection screen 460, the event selection dialog 470, or the like.

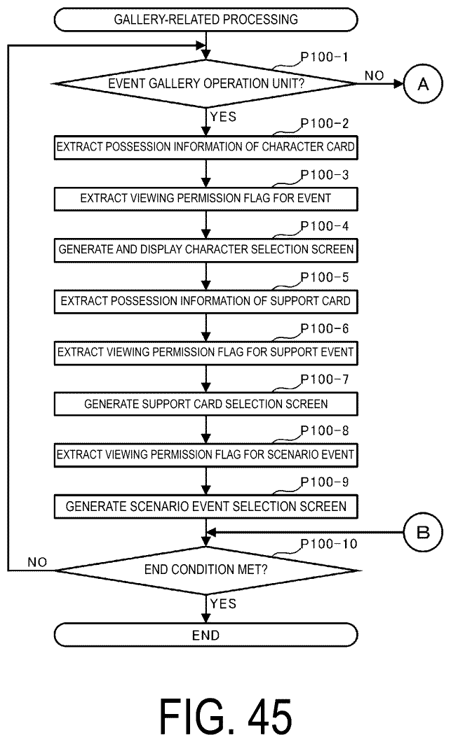

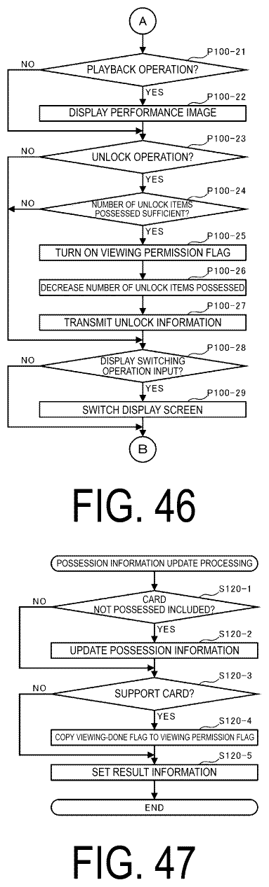

FIG. 45 is a first flowchart for describing the gallery-related processing in the player terminal 1. FIG. 46 is a second flowchart for describing the gallery-related processing in the player terminal 1. When the event gallery operation portion 400b is operated on the gallery screen 400 (YES in P100-1), the gallery processing unit 703a extracts possession information of the character card (P100-2). The gallery processing unit 703a extracts the viewing permission flag for the event set for the character card (P100-3). Then, the gallery processing unit 703a generates and displays the character selection screen 450 based on the extracted viewing permission flag (P100-4).

The gallery processing unit 703a extracts possession information of the support card (P100-5). The gallery processing unit 703a extracts the viewing permission flag for the support event set for the support card (P100-6). Then, the gallery processing unit 703a generates the support card selection screen 455 based on the extracted viewing permission flag (P100-7). The gallery processing unit 703a extracts the viewing permission flag for the scenario event (P100-8). Then, the gallery processing unit 703a generates the scenario selection screen 460 based on the extracted viewing permission flag (P100-9).

As illustrated in FIG. 46, when a playback operation (operation on the playback button 472b) is input (YES in P100-21), the gallery processing unit 703a displays a performance image. When an unlock operation (operation on the unlock button 472a or the batch unlock button 475) is input (YES in P100-23), the gallery processing unit 703a determines whether the number of unlock items possessed is sufficient (P100-24). When the number of unlock items possessed is sufficient (YES in P100-24), the gallery processing unit 703a turns on the viewing permission flag for the selected event (P100-25).

The gallery processing unit 703a decreases the number of unlock items possessed (P100-26), and transmits unlock information to the server 1000 (P100-27). Note that the unlock information includes information indicating the event ID of the unlocked event and information on the number of unlock items possessed. When a display switching operation of switching the display is input (YES in P100-28), the gallery processing unit 703a switches the display screen (P100-29). Then, as illustrated in FIG. 45, when an end condition for the gallery function is met (P100-10), the gallery processing unit 703a ends the gallery-related processing.

Referring back to FIG. 44, when receiving the unlock information from the player terminal 1, the gallery processing unit 1103a in the server 1000 updates the player information (S100). Here, the viewing permission flag and the number of unlock items possessed are updated as in the player terminal 1.

When a gacha operation is input by the player, the terminal-side game control unit 1A executes lottery request processing (P110). Here, request information is transmitted to the server 1000 to requesting execution of a lottery of the gacha type (character card or support card) designated by the player the number of times designated by the player. When receiving the request information, the server-side game control unit 1000A in the server 1000 executes lottery processing (S110). Here, the lottery of the designated gacha type is performed the designated number of times. In the server 1000, when the lottery processing ends, possession information update processing (S120) is executed.

FIG. 47 is a flowchart for describing the possession information update processing in the server 1000. The gallery processing unit 1103a determines whether a card not possessed is included in the card (character cards, support cards) obtained via successful lottery processing (S120-1). When the card not possessed is included (YES in S120-1), the gallery processing unit 1103a updates the possession information of the card not possessed (S120-2).

Then, when the card not possessed is a support card (YES in S120-3), the gallery processing unit 1103a copies the viewing-done flag for the support card to the viewing permission flag (S120-4). Accordingly, when the support event set for the newly possessed support card has already been viewed, the right to view via the gallery function is unlocked at the same time as the support card is possessed. Then, the gallery processing unit 1103a sets result information indicating the result of the lottery processing, and causes the player terminal 1 to receive the result information (S120-5).

Referring back to FIG. 44, when the player terminal 1 receives the result information from the server 1000, the player information is updated (P120). Here, the possession information of the card and the viewing permission flag are updated based on the received result information.

Here, an aspect of the embodiment has been described with reference to the accompanying drawings. However, it goes without saying that the present invention is not limited to the above-described embodiment. It is apparent to those skilled in the art that various modifications and corrections can be made within the scope of the claims, and it should be understood that such modifications and corrections also obviously fall within the technical scope of the present disclosure.

The game properties and the processing in the player terminal 1 and the server 1000 described in the above embodiment are merely examples. In the above-described embodiment, the nurture game is described as an example of the game genre. However, the game genre is not particularly limited. The gallery function described above is widely applicable to games in which parameters associated with characters are updated, such as a roll playing game (RPG), a card game, a simulation game, and an action game.

For example, in the RPG or the action game, the parameter for the character to be operated by a player changes differently between when the character defeats an enemy and when the character is defeated by the enemy. Then, performances are performed which are different between when the character defeats the enemy and when the character is defeated by the enemy. These performances may be performed by the gallery function described above. In addition, for example, in the RPG, the player may alternatively select a plurality of enemies or areas to progress the game. In this case, performance is performed in accordance with the progress of the game, but these performances may be performed by the gallery function.

In the above embodiment, the case where the gallery function is used outside the nurture game is described. However, the gallery function may be usable during the nurture game. In this case, even if the performance image is displayed during the nurture game, the parameter of the nurture target character is not updated. That is, the performance may be performed at a timing desired by the player by the above-described gallery function, regardless of whether the nurture game is being executed.

In the above embodiment, the case where the performance image is displayed by the gallery function is described. However, the performance reproducible by the gallery function does not necessarily include the display of the performance image. For example, only the output of the sound such as a BGM and a speech and the display of a text image may be executable by the gallery function. The performance performed by the gallery function may include both the display of the performance image and the output of the predetermined sound.

In the above embodiment, the selection event, the branching event, and the mini-game event are provided. However, these events are merely examples, and the content of the events are not particularly limited. That is, the selection event, the branching event, and the mini-game event are not essential.

In the above embodiment, the game points are required to play the nurture game. However, the game points are not essential, and the nurture game may be played without requiring the consideration.

Specifically, the information processing program causes a computer (in the embodiment, the player terminal 1 and the server 1000) to execute the following processing.

### Processing Executed by Computer

Processing of progressing a predetermined game (a nurture game as an example in the embodiment) in which a parameter associated with a character is updated (P7, S7, as an example in the embodiment).

Processing of determining a performance pattern to occur during the predetermined game from among a plurality of performance patterns (events as an example in the embodiment) associated with performance images different from each other and update conditions for the parameter different from each other (S7-9, S10-4, S10-9 as an example in the embodiment).

Processing of displaying a performance image corresponding to the determined performance pattern (P7-3, P20-4, and P20-8 as an example in the embodiment).

Processing of updating the parameter in accordance with the update condition (a parameter update condition as an example in the embodiment) corresponding to the determined performance pattern (S7-11 and P20-9 as an example in the embodiment).

Processing of enabling the performance image to be viewed that corresponds to the performance pattern having occurred during the predetermined game (S7-3 and P20-11 as an example in the embodiment).

Processing of enabling the performance image to be viewed that corresponds to a performance pattern having not occurred during the predetermined game by spending a predetermined item (an unlock item as an example in the embodiment) (P100-25 as an example in the embodiment).

In addition, processing of causing the player to select any one option among a plurality of options during the predetermined game, the plurality of options being associated with any of the plurality of performance patterns (P20-4 as an example in the embodiment) may be executed.

Further, a performance pattern corresponding to the option selected by the player may be determined (S7-9 and P20-8 as an example in the embodiment).

The plurality of performance patterns may include a first performance pattern (wining first place in the race in the race event as an example in the embodiment) and a second performance pattern (losing in the race in the race event as an example in the embodiment), the first performance pattern being associated with a first update condition, the second performance pattern being associated with a second update condition being more disadvantageous to the player than the first update condition.

The performance image enabled to be viewed by spending the predetermined item may include a performance corresponding to the second performance pattern.

In addition, processing of spending in-game currency (the game point as an example in the embodiment) possessed by the player as the predetermined game is started may be executed (S6-12 as an example in the embodiment).

Note that some of the functions of the nurture game described in the above embodiment may not be provided. Further, a part or all of the processing in the player terminal 1 described above may be executed in the server 1000. Similarly, a part or all of the processing in the server 1000 described above may be executed in the player terminal 1. Therefore, communication between the player terminal 1 and the server 1000 is not essential, and, for example, all the programs for executing the game may be stored in the player terminal 1.

An information processing program for executing the processing in the above-described embodiment and various modified examples may be stored in a non-transitory computer-readable storage medium and provided as a storage medium. Furthermore, a game terminal apparatus including the storage medium may be provided. In addition, the above-described embodiment and various modified examples may correspond to an information processing method for implementing each function and the steps illustrated in the flowcharts.

What is claimed is:

1. A non-transitory computer readable medium storing a program causing a computer to execute:
processing of progressing a predetermined game in which a parameter associated with a character is updated;
processing of determining a performance pattern to occur during the predetermined game from among a plurality of performance patterns, the plurality of performance patterns being associated with pieces of performance content different from each other and update conditions for the parameter different from each other;
processing of performing a performance based on the determined performance pattern;
processing of updating the parameter in accordance with the update condition corresponding to the determined performance pattern;
processing of enabling a performance corresponding to the performance pattern having occurred during the predetermined game to be performed at a timing desired by a player; and
processing of enabling a performance corresponding to the performance pattern having not occurred during the predetermined game to be performed at the desired timing by spending a predetermined item.

2. The non-transitory computer readable medium according to claim 1, wherein the program further causes the computer to execute:
processing of causing the player to select any one option among a plurality of options during the predetermined game, the plurality of options being associated with any of the plurality of performance patterns,
the processing of determining the performance pattern to occur includes determining the performance pattern corresponding to the option selected by the player.

3. The non-transitory computer readable medium according to claim 2, wherein
the plurality of performance patterns include a first performance pattern and a second performance pattern, the first performance pattern being associated with a first update condition, the second performance pattern being associated with a second update condition being more disadvantageous to the player than the first update condition, and
the performance enabled to be performed by spending the predetermined item includes a performance corresponding to the second performance pattern.

4. The non-transitory computer readable medium according to claim 1, wherein the program further causes the computer to execute:
processing of spending in-game currency possessed by the player as the predetermined game is started.

5. An information processing method executed by one or more computers, the information processing method comprising:
processing of progressing a predetermined game in which a parameter associated with a character is updated;
processing of determining a performance pattern to occur during the predetermined game from among a plurality of performance patterns, the plurality of performance patterns being associated with pieces of performance content different from each other and update conditions for the parameter different from each other;
processing of performing a performance based on the determined performance pattern;
processing of updating the parameter in accordance with the update condition corresponding to the determined performance pattern;
processing of enabling a performance corresponding to the performance pattern having occurred during the predetermined game to be performed at a timing desired by a player; and
processing of enabling a performance corresponding to the performance pattern having not occurred during the predetermined game to be performed at the desired timing by spending a predetermined item.

6. An information processing system comprising:
one or more computers,
wherein the one or more computers execute:
processing of progressing a predetermined game in which a parameter associated with a character is updated;
processing of determining a performance pattern to occur during the predetermined game from among a plurality of performance patterns, the plurality of performance patterns being associated with pieces of performance content different from each other and update conditions for the parameter different from each other;
processing of performing a performance based on the determined performance pattern;
processing of updating the parameter in accordance with the update condition corresponding to the determined performance pattern;
processing of enabling a performance corresponding to the performance pattern having occurred during the predetermined game to be performed at a timing desired by a player; and
processing of enabling a performance corresponding to the performance pattern having not occurred during the predetermined game to be performed at the desired timing by spending a predetermined item.
